(19) United States
(12) Patent Application Publication
(10) Pub. No.: US 2014/0129455 A1
(43) Pub. Date: May 8, 2014

(54) SYSTEMS AND METHODS FOR CALCULATING STATUTORY SENTENCES

(71) Applicant: Sentence Calculator, Inc., New York, NY (US)

(72) Inventor: Terence S. Davidson, New York, NY (US)

(21) Appl. No.: 14/072,552

(22) Filed: Nov. 5, 2013

Related U.S. Application Data
(60) Provisional application No. 61/723,107, filed on Nov. 6, 2012.

(51) Int. Cl. G06Q 50/18; G06Q 10/00

(52) U.S. Cl. CPC G06Q 50/18; G06Q 10/00
USPC 705/311

(57) ABSTRACT

Systems and methods are provided to assist users with calculating data related to a proposed or actual prison sentence. A sentence calculation platform provides a plurality of sentences calculators. Each sentence calculator is associated with a particular algorithm and a set of instructions for determining sentence output data based on the applicable legal framework. A sentence calculation module corresponding to a selected sentence calculator is transmitted for display on a client device of a user. User input is entered in an input portion of the module. Sentence output data is generated by applying the selected sentence calculator to the received user input. The sentence output data is transmitted for display in an output portion of the sentence calculation module displayed on the client device.

### CROSS-REFERENCE TO RELATED APPLICATIONS

The present application claims priority to U.S. Provisional Patent Application No. 61/723,107 filed on Nov. 6, 2012, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to systems, methods and non-transitory computer readable media including mobile, web-based and desktop applications for the calculation of sentence durations, good time credits, release dates, predicate offender status and jail time credits for individuals subject to incarceration in a specified or selected jurisdiction. The systems, methods and non-transitory computer readable media are suitable for current or upcoming portable devices, such as smart phones, PDAs, tablets, laptops, netbooks and notebooks as well as traditional non-portable devices such as desktop computers. The functionality of the software is applicable to the fields of law enforcement, criminal justice, criminal law and corrections (e.g., institutionalization/parole/probation).

### BACKGROUND OF THE INVENTION

Currently, there are no easily accessible, automated, interactive systems to aid attorneys, judges, prison officials and others that need an easy, fast and accurate way to calculate the impact of sentences (imposed or proposed) and jail time credits on the release dates of those persons subjected to them.

In the field of corrections, ascertaining release dates with precision is a primary concern. As the number of inmates continues to rise, the burden and cost (both to the prisoner for loss of liberty during the period of over-incarceration and to the state for the expense and possible liability for the period of over-incarceration) of performing such calculations continue to escalate. The likelihood of committing errors in performing these calculations also significantly increases. For example, the lead plaintiff in Billups v. Horn, a federal class action lawsuit, was incarcerated for five years longer than mandated by the imposed sentence. As an example of the high administrative costs of sentence calculation, the New York State Department of Corrections and Community Services employs at least two people in each of 67 prisons to calculate by hand the release dates for inmates sentenced pursuant to the New York State Penal Law.

Generally, persons interested in sentence calculation may need to resort to scouring and parsing statutory texts for the appropriate guidelines needed to handle the sentencing situation at issue. Moreover, defense attorneys, prosecutors and judges are unlikely to have the time to consult these texts during their real-time discussion of the case at issue. Additionally, defense attorneys may desire the ability to quickly and accurately advise their clients of the expected duration of possible prison terms so that the client may make an informed decision as to whether to accept a plea bargain or to proceed to trial.

The ability to quickly and accurately perform calculations related to prison sentences may also be desirable for educational purposes. For example, this ability may be useful to criminal law professors who provide instruction regarding how to determine potential sentences, release dates, predicate status and other factors related to prison sentences in order to prepare the students for their future careers.

The New York City Department of Corrections uses a Monroe Machine to assist with performing sentence calculations. However, these machines suffer from a number of deficiencies. The limited number of Monroe Machines that are in service are kept up-to-date with statutory changes by means of cartridges, and access to the machines is restricted. While these “adding machines” are able to perform simple mathematical operations, the majority of the work associated with the sentence computations is performed manually by New York City Custody Management staff. Consequently, the sentence computations may not be accurate and may result in prisoners overstaying their sentences by days, weeks or even months. This can impose heavy costs on tax payers, given that the cost imposed on the tax payers for housing a single inmate in a New York City jail as of 2012 is approximately $168,000 per year. In addition to the costs associated with housing inmates, additional costs may be imposed on tax payers and governments stemming from costly law suits that may be brought as a result of prisoners overstaying their prison sentences (e.g., in the case that a prisoner is injured or dies in custody while overstaying their sentence).

Legal professionals and corrections personnel may find themselves performing sentence calculations between several times a week and several times a day. More complex calculations involving complicated rap sheets may require three-quarters of an hour per calculation. The most complex calculations almost invariably require consulting an expert in the field. In short, too much time and resources are wasted on calculating sentences by hand and the existing methods still fail to provide quick, intuitive solutions that take advantage of modern developments in Internet, computer and smartphone technology.

Therefore, a need exists for a simple, easy-to-access platform that will accurately perform complex sentencing calculations within the framework of the applicable laws for a chosen jurisdiction without the need to resort to printed statutes. In addition, there is a need for such a platform to deliver these calculations quickly and on-demand through an intuitive and easy-to-use application or system. There is also a need for such a platform to be locally accessible or otherwise native to the device. Furthermore, there is a need for such a platform to be accessible to devices connected to the Internet, a private local area network or to a virtual private network.

### SUMMARY OF THE INVENTION

According to certain embodiments of the present invention, a sentence calculation platform allows users to calculate sentence output data including sentence duration (including minimum/maximum ranges), release dates, good time credits and other related values associated with an actual or proposed prison sentence in response to receiving inputs from a user such as the sentence duration (e.g., which may be a specific amount of time or a range of time) and jail time credits. The sentence calculation platform may utilize the inputs provided by the user in conjunction with a sentence calculation application that is tailored to the statutes of a particular jurisdiction in order to compute these values. The sentence calculation application may be configured to handle multiple sentence types (e.g., determinate, indeterminate and definite sentences) for concurrent and consecutive sentencing situations. In certain embodiments, a plurality of different sentence calculators are provided to calculate the sentence output data for different sentencing scenarios, each being associated with a particular algorithm and a set of instructions for accurately and quickly determining the sentence output data based on the applicable legal framework.

According to certain embodiments of the present invention, the sentence calculation application may be customized for particular operating systems and platforms, may be web-based and/or may be platform/device independent, may be interoperable with other applications and may be accessible through the portable devices, traditional desktop computers, tablets, or other types of computing devices. The sentence calculation application may be interactive and dynamic (e.g., allowing users to navigate through and between content categories, edit, save, and retrieve information).

In certain embodiments, a system is provided for performing calculations related to a proposed or actual prison sentence. The system comprises a processor that may be configured to provide a sentence calculation platform adapted to assist a user with generating sentence output data related to a proposed or actual prison sentence. The sentence calculation platform may include a plurality of sentence calculators that are configured to compute sentence output data for a variety of different sentencing scenarios. Each sentence calculator may comprise a set of instructions pertaining to a unique sentencing scenario which, when applied to one or more numerical values, calculates specific sentence output data based on a set of rules that are adapted from a jurisdiction's legal framework corresponding to that sentencing scenario. The processor may also be configured to provide a hierarchy of navigable menus to assist the user in selecting an appropriate sentence calculator from the plurality of sentence calculators based on a particular sentencing scenario. The hierarchy of navigable menus may include selectable interface elements that are each associated with a subset of the sentence calculators. The processor may be further configured to select a sentence calculator based on the user's interaction with the selectable interface elements and transmit data for rendering a sentence calculator module on a client device associated with the user based on the selected sentence calculator. The sentence calculator module may include an input portion configured to receive user input and an output portion configured to display the sentence output data. User input may be entered in the input portion of the sentence calculator module. The user input may include sentencing information comprising numerical values pertinent to the sentencing scenario associated with the selected sentence calculator. The processor may be configured to determine sentence output data for the proposed or actual prison sentence by applying the selected sentence calculator to the received user input. The sentence output data may be transmitted for display on the client device associated with the user.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1 is a block diagram of a system for providing a sentence calculation platform in accordance with certain embodiments of the present invention;

FIG. 2 is an illustration that demonstrates how a client device and calculation server interact with a sentence calculator and corresponding module to provide sentence output data to a user in accordance with certain embodiments of the present invention;

FIGS. 3-59 are screenshots of exemplary sentence calculator modules in accordance with certain embodiments of the present invention; and

FIG. 60 is a flow chart of a method for providing a sentence calculation platform in accordance with certain embodiments of the present invention.

### DETAILED DESCRIPTION OF EMBODIMENTS OF THE INVENTION

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

The present invention relates to a sentence calculation platform that may be utilized by users to determine values related to actual or proposed prison sentences. More specifically, in response to receiving input data from a user, the sentence calculation platform may utilize the input data in conjunction with sentence calculation algorithms to compute data values associated with a prison sentence including, but not limited to, actual or predicted values that indicate a prisoner's release date, the duration of a prison sentence, or the amount of good time credit that has been awarded to a prisoner. The sentence calculation platform may also be configured to compute actual or predicted values for pre-sentencing credits (e.g., credits that may be applied to reduce a prisoner's jail time in the case that the prisoner was incarcerated before sentencing), aggregated jail time for consecutive sentences, parole eligibility dates, conditional release dates, the amount of time a prisoner has spent in jail as of a particular date, the remaining time on a prison sentence, re-sentencing eligibility, the amount of time owed on a previous prison sentence, data that indicates a status of an offender (e.g., whether the offender can be charged as a predicate, persistent or mandatory felony offender), data that indicates whether someone is entitled to judicial diversion, and any other data related to a prison sentence or prisoner. The data which is output by the sentence calculation platform is referred to herein as “sentence output data.”

In order to compute the above values, the sentence calculation platform may include one or more sentence calculators that comprise procedures and program instructions which are tailored to the penal laws, or other related statutes, of one or more jurisdictions. Amongst other things, the statutory information that is embodied in the sentence calculators may provide sentencing information relevant for calculating data related to prison sentences, including information which is relevant to different types of sentences (e.g., definite, determinate and indeterminate sentences) and sentencing factors that affect the calculation of the sentence output data (e.g., factors relevant to parole, escapees/absconders/AWOL, concurrent sentences, consecutive sentences, out-of-state sentences or post-release supervision).

In certain embodiments, each sentence calculator may be associated with a corresponding module that is displayed to users. Each module may include an input portion for receiving user input from a user and an output portion for displaying the sentence output data computed by a sentence calculator. The input portion may include an input form that includes text fields, check boxes, radio buttons and other input elements which permit a user to enter information related to a prisoner or prisoner sentence. The output portion may include text or form elements that display the values of the sentence output data.

A user accessing the platform may provide input data (e.g., numerical or textual data associated with a prison sentence or prisoner) to the input portion of a sentence calculator module that is displayed on a client device associated with the user. The input data provided to the module may be utilized by a corresponding sentence calculator to compute the sentencing data that is output by the sentence calculation platform. The input data provided by users may include, inter alia, values that indicate a sentencing date, the length of prisoner's sentence (e.g., which may be a definitive length of time or a range of time), pre-sentence time (i.e., the amount of time the prisoner spent in jail before being sentenced), data related to parole, the jurisdiction(s) associated with the prison sentence, data related to an absconder or escapee, data that indicates whether the prisoner is eligible for merit time, dates and other data associated with concurrent or consecutive sentences that are being served by the prisoner, or any other data that is related to a prison sentence. The user may also input data related to a prisoner such as the prisoner's name, state identification number, department identification number, social security number or any other data that identifies, or is otherwise related to, the prisoner.

In certain embodiments, the sentence calculation platform may be accessible via a web-based platform which can be accessed by users over a network (e.g., the Internet). More specifically, users may utilize client devices to communicate with one or more servers that provide the sentence calculation platform. In other embodiments, the sentence calculation platform may be provided as an application, or other component, which is provided locally on the client devices operated by the users. In even further embodiments, the sentence calculation platform may be implemented in a distributed manner in which the functionality of the sentence calculation platform is divided between a server and a client device.

Each sentence calculator may be configured to generate sentence output data relevant to a specific sentencing scenario. For example, separate sentence calculators may be provided for calculating sentence output data for basic definite sentences, basic determinate sentences and basic indeterminate sentences (e.g., basic in the sense that a sentence calculator need not account for factors such as parole or post-release supervision which may complicate the calculations). Numerous additional sentence calculators may also be provided for other specified sentencing scenarios. For example, a first sentence calculator may be configured to generate sentence output data in the case that a prisoner was sentenced to an indeterminate prison sentence and subsequently violated parole, a second sentence calculator may be configured to generate sentence output data in the case that a prisoner received a determinate sentence and indeterminate sentence which run concurrent to each other, and a third calculator that may be configured to generate sentence output data in the case that a prisoner has received two or more definite sentences which are consecutive to each other. A sentence calculator may include instructions for computing sentence output data for any sentencing scenario.

Given that the sentence calculation platform may include a relatively large number of sentence calculators (e.g., perhaps fifty per jurisdiction), the sentence calculation platform may advantageously provide the user with user-friendly interfaces that permit the user to easily identify or navigate to an appropriate sentence calculator. The manner in which this is accomplished may vary.

In certain embodiments, the interfaces displayed to the users may include a hierarchy of navigable menus to assist users in identifying an appropriate calculator. By organizing the sentence calculators into logical subsets of related calculators, a user can quickly identify an appropriate sentence calculator by selecting a relatively small number of menu options. Each menu option provided by the navigable menus may represent a hyperlink or other selectable interface element that directs a user to a subset of sentence calculators or directly to the appropriate sentence calculator.

In certain embodiments, the sentence calculation platform may include an interactive wizard that assists users in identifying an appropriate calculator by asking the users one or more questions and requesting feedback from the user. The input or feedback received from a user may be utilized by the wizard to narrow a subset of applicable sentence calculators and to guide the user to the appropriate sentence calculator.

It should be noted that the term “prisoner,” as used herein, is not meant to refer exclusively to a person that is incarcerated in a correctional facility. Rather, the term is used in a broader sense and is generally meant to encompass anyone who may be subject to an actual or proposed prison sentence and may include individuals who have been convicted or sentenced, individuals who have been released on parole, individuals awaiting sentencing or trial, individuals who have been arrested, individuals released under a post-release supervision program, escapees, absconders, and persons who have entered a judicial diversion program.

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code to reduce the number of times code is retrieved from bulk storage during execution. Input/output or I/O devices (including, but not limited to, keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

### I. Exemplary System Architecture

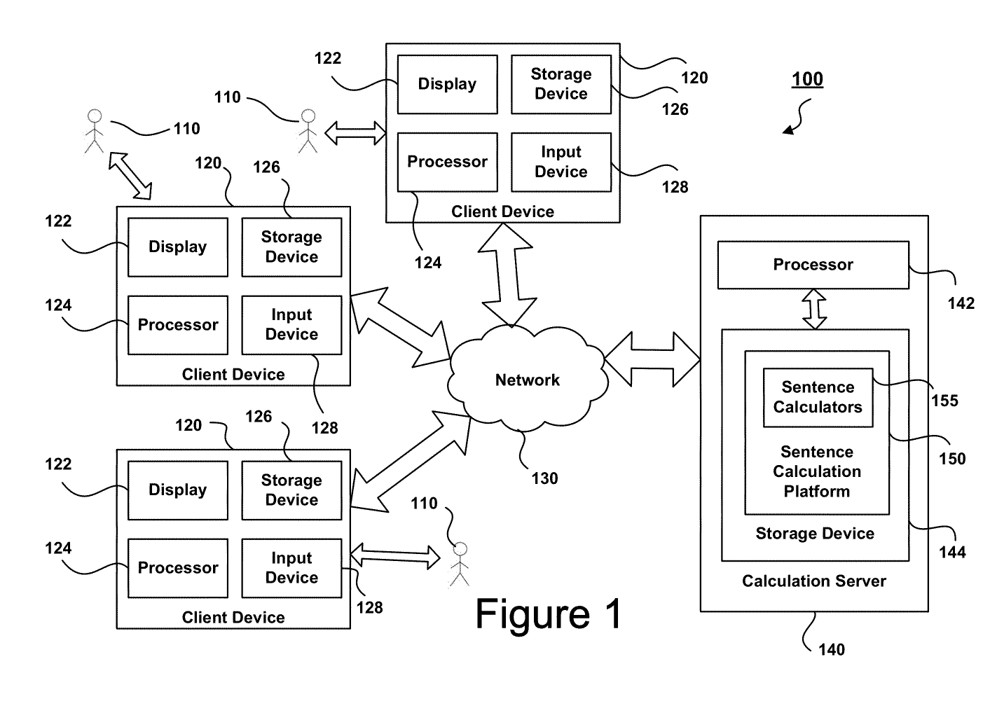

FIG. 1 illustrates a system 100 for providing a sentence calculation platform 150 that is configured to perform functions and services related to calculating or determining data related to prison sentences. The sentence calculation platform 150 may include one or more sentence calculators 155 that may be used to calculate or determine data related to specific sentencing scenarios. Each sentence calculator 155 may include a particular algorithm and a set of instructions for determining sentence output data for a particular sentencing scenario or a set of sentencing scenarios. As explained in further detail below, each sentence calculator 155 may be associated with a corresponding module that is configured to receive input from users 110 accessing the platform 140 and display sentence output data related to a particular sentencing scenario. The input received from a user may be applied to the algorithm and instructions associated with a sentence calculator 155 to generate the sentence output data.

As shown in FIG. 1, a plurality of client devices 120 are in communication with one or more calculation servers 140 over a network 130. The network 130 may be any type of network such as one that includes the Internet, a local area network, a wide area network, an intranet, etc. Users 110 may utilize the client devices 120 to communicate with the server 140 in order obtain information associated with prison sentences. The users 110 may represent attorneys, judges, law students, personnel associated with correctional facilities, or any other person. In certain embodiments, users may utilize a web browser on the client device 120 to interact with web pages and interfaces provided by the sentence calculation platform 150 on the server 140 in order to obtain prison sentence information and other related data.

The client devices 120, as well as the server 140, may be configured to communicate via wired or wireless links, or a combination of the two. The client devices 120 may represent a desktop computer, laptop computer, cell phone, tablet device, mobile device, personal digital assistant or other type of computing device. Each of the client devices 120 may be equipped with one or more computer storage devices 126 (e.g., RAM, ROM, PROM, SRAM, etc.) and one or more processing devices 124 (e.g., a central processing unit) that are capable of executing computer program instructions. Computer storage device 126 is preferably a physical, non-transitory medium. Any of the client devices 120 may further include a display 122 that is capable of rendering a user interface and one or more input devices 128 (e.g., keyboard, microphone, camera, video camera, scanner, joystick, remote control device, touch screen, etc.). Users 110 may manipulate interfaces rendered on the display 122 using the input devices 128 to communicate with the server 140.

The server 140 may also include one or more processors 142 and one or more computer storage devices 144. Computer storage device 144 is preferably a physical, non-transitory medium. The server 140 may generally represent any type of computing device that is capable of communicating with a client device 120. In some embodiments, the server 140 comprises one or more mainframe computing devices that execute a web server for communicating with client devices 120 over the Internet. The storage medium on the server 140 may store data, instructions, applications and/or software code for providing assistance to users 110 in performing tasks related to calculating prison sentences and related data.

Specifically, the server 140 may be configured to provide sentence calculation services to users 110 via interfaces displayed on the client devices 120. For example, the interfaces rendered on the client devices 120 may permit a user 110 to provide input related to a prisoner and/or prison sentence and to view output data generated by the server 140 that is related to the prison sentence and prisoner. Exemplary data which may be input by the user 110 may include data that indicates the prisoner's sentencing date, the length of prisoner's sentence (e.g., which may be a definitive length of time or a range of time), the prisoner's pre-sentence time (i.e., the amount of time the prisoner spent in jail before being sentenced), data related to parole (e.g., parole eligibility date, the date the prisoner was released on parole or the date the prisoner violated parole), the jurisdiction associated with the prison sentence, data related to a prisoner that was deemed to be an absconder or escapee (e.g., the date the prisoner failed to return from a temporary release program or the date the prisoner was returned to jail), data that indicates whether the prisoner is eligible for merit time, dates and other data associated with concurrent or consecutive sentences that are being served by the inmate, or any other type of data that is related to the prisoner's sentence. In addition to inputting data related to the prisoner's term, the user 110 may also input data related to the actual prisoner, such as the prisoner's name, state identification number, department identification number (or DIN number), social security number or any other data that identifies (or is otherwise related to) the prisoner.

The input data entered by the user 110 may be transmitted from the client device 120 to the calculation server 140 over the network 130. After receiving the data, a sentence calculator 155 located on the sentence calculation platform 150 may analyze the input data and utilize the input data to compute various outputs associated with a prisoner's sentence. As explained above, the output(s) computed by the sentence calculation platform 150 associated with a prison sentence are referred to herein as “sentence output data.” Amongst other things, the sentence output data generated by the sentence calculation platform 150 may include actual or predicted values for any of the following: a prisoner's release date, the duration of a prison sentence, the amount of “good time” that has been awarded to a prisoner (e.g., for good behavior during the prisoner's incarceration), credits that may be applied to reduce a prisoner's jail time (e.g., in the case that the prisoner was incarcerated before sentencing), aggregated jail time for consecutive sentences, parole eligibility dates, conditional release dates, the amount of time a prisoner has spent in jail as of a particular date, the remaining time on a prison sentence, the amount of time owed on a previous prison sentence, eligibility for re-sentencing, and any other data related to a prison sentence. The sentence output data computed by the sentence calculation platform 150 may be transmitted from the calculation server 140 to the client device 120 (or client devices 120) over the network 130 and rendered on the display 122 of the client device 120 for viewing by the user 110.

In order to compute the sentence output data, the sentence calculation platform 150 may execute a sentence calculator 155 (or sentence calculation application that includes the sentence calculator 155) that embodies information specified by the statutes of the jurisdiction(s) in which the prisoner is incarcerated or in the jurisdiction(s) in which a prisoner may be subject to an actual or proposed prison sentence. For example, the statutes may include information that is useful for computing the sentence output data and this information may be integrated into the program instructions that are executed by the sentence calculation platform 150 to generate the outputs that are transmitted to the client device 120. More specifically, the sentence calculation platform 150 may utilize the inputs provided by the user 110 in conjunction with the instructions to generate the sentence output data. The sentence output data may then be transmitted to one or more client devices 120 for display to the users 110.

In certain embodiments, the calculation server may interact with a database (not shown) that includes data related to a prisoner and prison sentences. The database may be located locally (e.g., residing on the calculation server) or remotely (e.g., a database provided by a correctional facility or court system). In response to a user entering some minimal input (e.g., a prisoner's DIN number or name), the sentence calculation platform 150 may query the database to retrieve information related to the prisoner and prisoner sentence and utilize this information to calculate the sentence output data.

It should be noted that the system in FIG. 1 is merely meant to demonstrate an embodiment of an operating environment that can be utilized in conjunction with the present invention, and should not be construed as limiting in any manner whatsoever. The particular configuration in FIG. 1 can be altered in numerous ways without departing from the principles herein. For example, it should be noted that the functionality of the server 140 in FIG. 1 may be carried out by a plurality of servers 140. Likewise, although FIG. 1 depicts a single server 140 connected to three client devices 120, any number of servers 140 and client devices 120 may be utilized with the system 100 and the system 100 may be configured in a variety of different ways (e.g., in a distributed computing environment, cloud-based environment, client-server environment, etc.).

Furthermore, while FIG. 1 illustrates a plurality of client devices 120 in communication with a server 140 over a network 130, it should be recognized that the functionality performed by the server 140 may be performed by, or in cooperation with, the client devices 120. For example, in certain embodiments, all or part of the sentence calculation platform 150 may be located on a client device 120 and the client device 120 may be configured to perform the functions of the server 140 or to cooperate with the server 140 in a distributed manner. Thus, it should be recognized that any functionality of the server 140 which is described herein can alternatively be implemented by a client device 120, and vice versa.

### II. Sentence Calculators and Modules

Accurately computing the sentence output data is a difficult task given the complexities and nuances associated with determining certain parameters such as a prisoner's release date or prison sentence duration. For example, the manner of computing a prisoner's release date or sentence duration can vary depending upon whether prisoner sentence is a definite sentence (e.g., which may be of a known length of time such as 5 years), determinate sentence (e.g., which may have a defined length, but which may be changed by a parole board or other agency), or indeterminate sentence (e.g., which may fall within a range of time such as 20 years to life). Further complexities may arise in calculating these values in situations where these values are adjusted to account for “good time” credit, consecutive or concurrent sentences that have been imposed on a prisoner, parole, absconder or escapee status, or one or more additional sentences that have been imposed on the prisoner in jurisdictions which are located outside of the jurisdiction where the prisoner is incarcerated.

In certain embodiments, the sentence calculation platform 150 may provide a plurality of different sentence calculators 155 that can be utilized by a user 110 to determine or predict the release date (and other related data) for different scenarios. For example, separate sentence calculators 155 may be provided for calculating basic definite, determinate or indeterminate prison sentences. Separate sentence calculators 155 may also be provided to account for consecutive or concurrent sentences that have been imposed, parole eligibility, parole violations, absconders or escapees, pending Federal or out-of-state sentences, and other types of factors that may affect the release date or duration of a prisoner's sentence. In the case that a particular jurisdiction includes a body of law that imposes irregular or atypical sentencing procedures for a particular offense (e.g., in New York, offenses associated with the Rockefeller Drug Laws), separate sentence calculators 155 tailored to these bodies of law may also be provided. Each sentence calculator 155 may be associated with a module that is provided on an interface being displayed to users 110 accessing the platform 150.

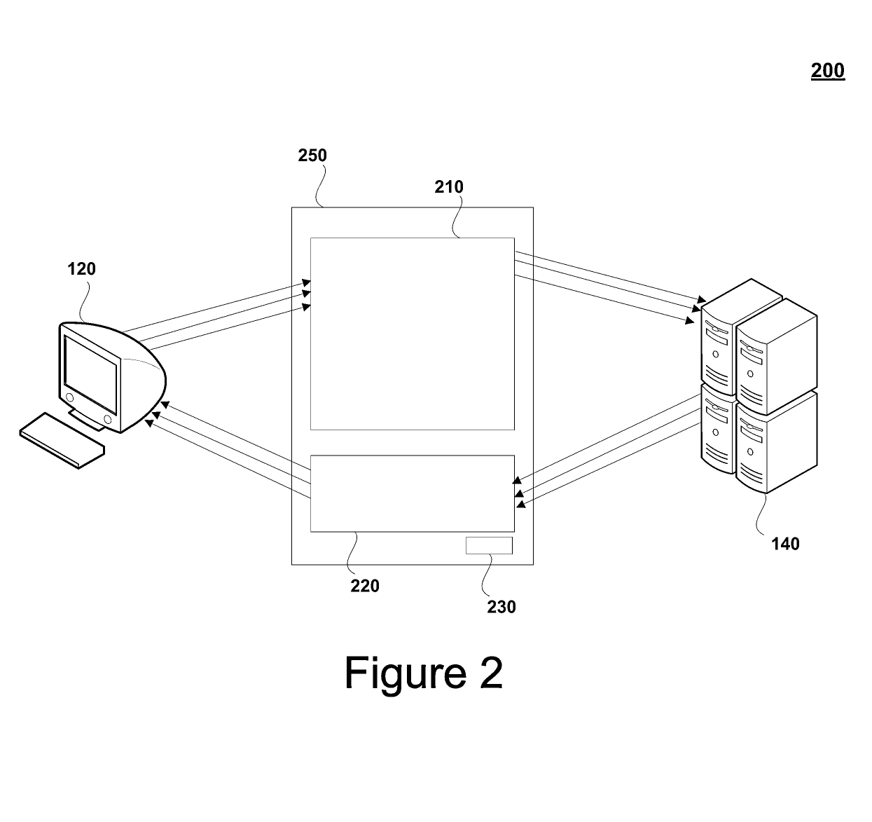

FIG. 2 is an illustration that demonstrates how a client device 120 and calculation server 140 interact with a sentence calculator module 250 to provide sentence output data to a user 110. The sentence calculator module 250 illustrated therein may initially be rendered on the client device 120. The module 250 includes an input portion 210 for receiving user input from a user and an output portion 220 that may display the sentence output data (e.g., which may include release dates, duration of sentence, good time credits and other data related to an actual or proposed prison sentence) computed by a sentence calculator 155. The input portion 210 may include an input form that includes text fields, check boxes, radio buttons, calendars for selecting dates, and other input elements which permit a user 110 to enter information related to a prisoner or a prison sentence. Some of the inputs may be optional, while others may be required in certain circumstances. The output portion 220 may include text and/or forms that display the values of the sentence output data generated by one of the sentence calculators 155 provided by the sentence calculation platform 150.

In certain embodiments, after the user 110 populates the input portion of the sentence calculator module 250, the user 110 may select a submit button 230 (e.g., by clicking with a mouse, performing a gesture or by providing other input in other ways) on the sentence calculator module 250. Upon selecting the submit button 230, the information entered in the input portion 210 of the sentence calculator module 250 may be transmitted to a calculation server 140 over a network 130. A sentence calculator 155 provided by sentence calculation platform 150 may utilize the input data to generate sentence output data. The sentence output data may then be transmitted to the client device 120 and displayed in the output portion 220 of the sentence calculator module 250.

The sentence calculator module 250 may include additional elements that are not illustrated in FIG. 2. In certain embodiments, the module 250 may provide the user 110 with the ability to view the statutory basis underlying the calculation associated with the specific sentence calculator 155. For example, in certain embodiments, each sentence calculator module 250 may provide a hyperlink or other interface element that is selectable to display the statutes that are applicable to the calculation that is being performed by the sentence calculator. The sentence calculator module 250 may also include a button or other interface element for clearing, saving or printing the data in the input portion 210 and the output portion 220.

Additionally, after a calculation is performed, the sentence calculator module 250 may display information that indicates the steps of the calculation and/or any intermediate or final values computed as part of the calculation. In certain embodiments, this information may be displayed in response to selecting a button or interface element. The sentence calculator module 250 may also output warnings and error messages. For example, in the case that unexpected or non-conforming input is entered by the user 110, the sentence calculator module 250 may present the user with a warning or error message. The sentence calculator module 250 may also provide suggestions to the user regarding how the unexpected/nonconforming input may be corrected. Alternatively, the sentence calculator module 250 may display a warning and offer the user the opportunity to continue with performing the calculation using the unexpected or non-conforming input. A warning or error may be generated in any instance where the data entered by a user is out of bounds or is otherwise in an error state (e.g., when the dates entered are in an improper format or when the sentence duration entered by the user 110 is greater than the maximum threshold for a given sentencing situation).

In certain embodiments, the data input by the user 110 and the data generated by the sentence calculator 155 may be saved and associated with a user account for later use by returning users 110. Users 110 may save such data by selecting a button or interface element (e.g., save button or check box). Alternatively, data may be saved automatically (e.g., during a browser session). In addition, data from the prior calculations may be imported into other sentence calculator modules 250 by means of a user interface element. Thus, data previously input by the user 110 may be automatically transferred to a different module 250, rather than requiring the user to re-enter the data. Previously entered data may be restored from a prior browser session stored on a remote or local server or from a remote or local database.

In certain embodiments, each sentence calculator 155 and/or associated module 250 may be implemented as a dynamically generated web page (e.g., using PHP, JSP or other language) embedded in a markup language (e.g., HTML, XML, or similar). Using a browser (e.g., Internet Explorer™, Chrome™, Firefox™ or other web browser), users 110 can enter the input into the dynamically generated webpage. Upon completion of data entry, the user may choose to submit the data for calculation, for example, by clicking a button labeled “Calculate” or “Submit” or by performing a gesture on an interface displayed on a client device 110. The sentence calculation platform 150 (which may be running locally or remotely) may then parse the data entered by the user and check the data for errors. If the user input is properly formatted, a sentence calculator 155 may then perform the appropriate calculations. Upon completion of the calculations, the output data and the input data may be formatted and provided as another dynamically generated web page and presented to the user.

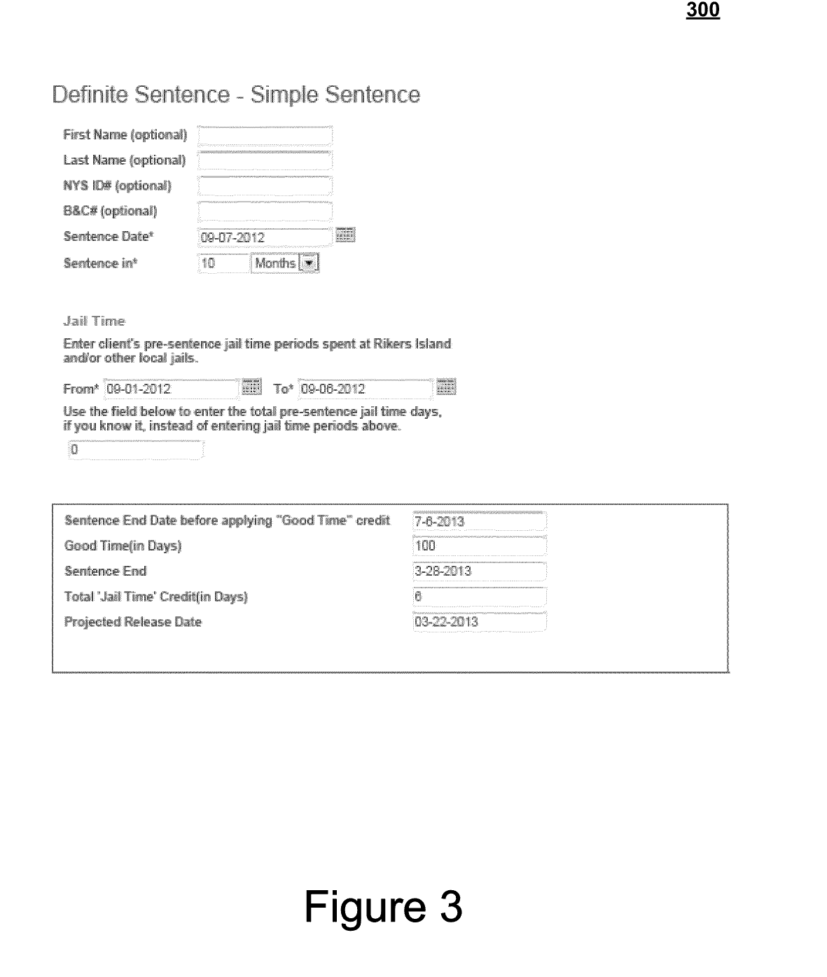

FIGS. 3-59 are screenshots of exemplary sentence calculator modules 250 that may be configured to provide sentence output data for actual or proposed prison sentences in the State of New York. Each of the exemplary sentence calculator modules 250 may be associated with a corresponding sentence calculator 155 that performs the underlying calculations related to generating the sentence output data.

FIG. 3 illustrates a screenshot 300 of a sentence calculator module 250 that may be utilized to calculate sentence output data for a definite prison sentence for a prisoner that was sentenced to a local city sentence of one year or less (usually misdemeanors).

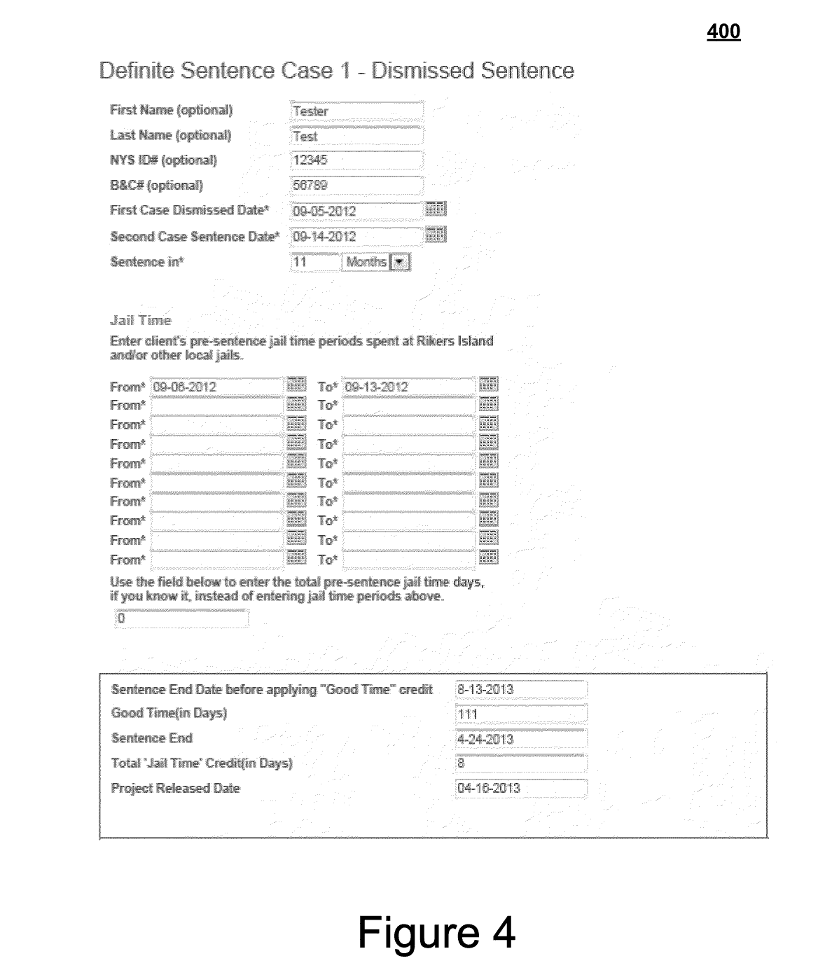

FIG. 4 illustrates a screenshot 400 of a sentence calculator module 250 that may be utilized to calculate sentence output data for a definite prison sentence for a prisoner that had a second case that was subsequently dismissed. Amongst other things, this sentence calculator module 250 can apply any credit owed from the dismissed case to the first prison sentence.

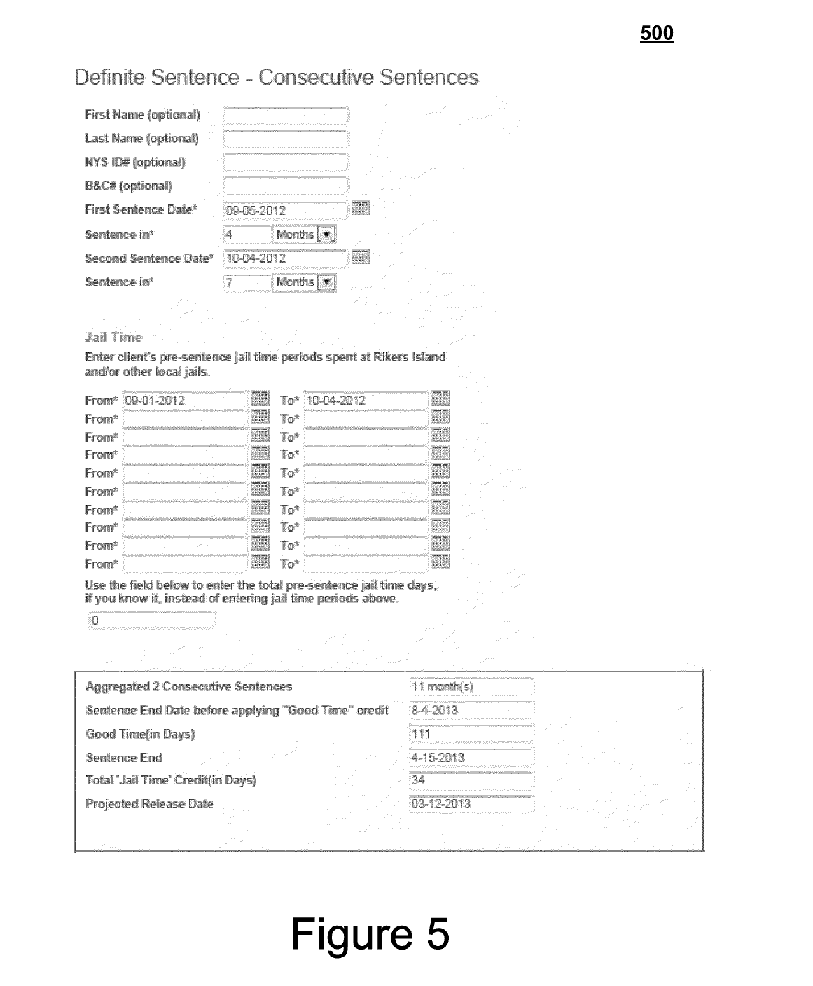

FIG. 5 illustrates a screenshot 500 of a sentence calculator module 250 that may be utilized to calculate sentence output data for a prisoner that has two sentences of one year or less that are consecutive to each other.

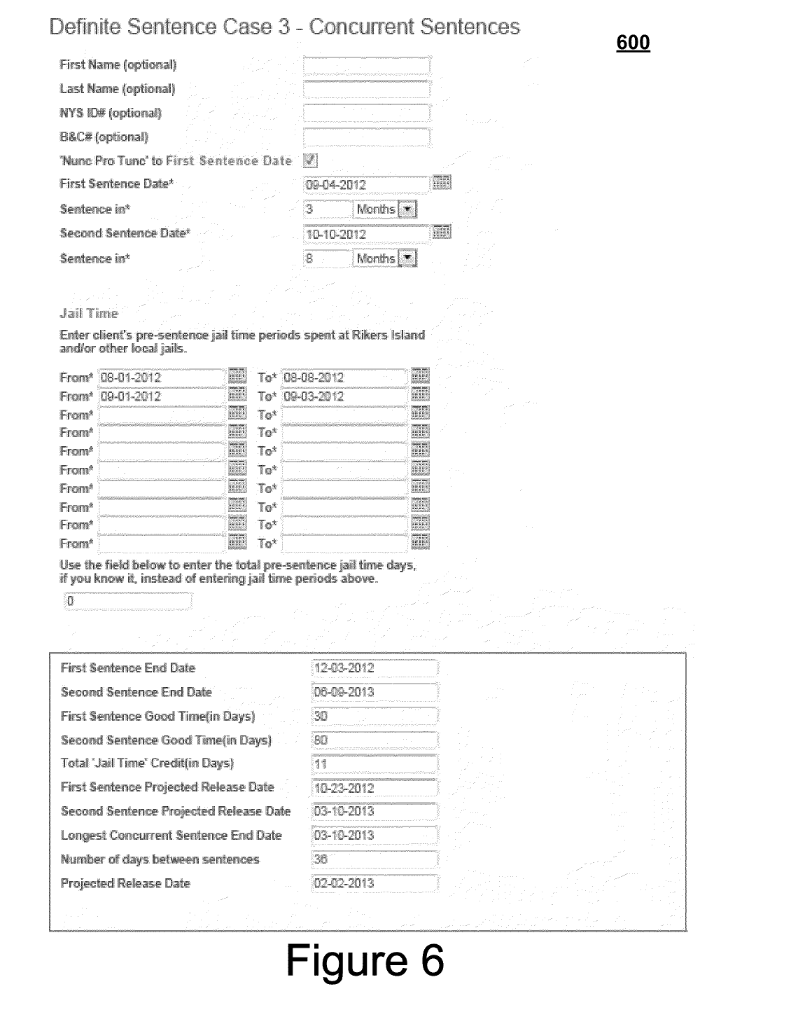

FIG. 6 illustrates a screenshot 600 of a sentence calculator module 250 that may be utilized to calculate sentence output data for a prisoner that has two sentences of one year or less that are concurrent to each other. Amongst other things, this sentence calculator module 250 may account for whether the prison sentences are “nunc pro tunc.”

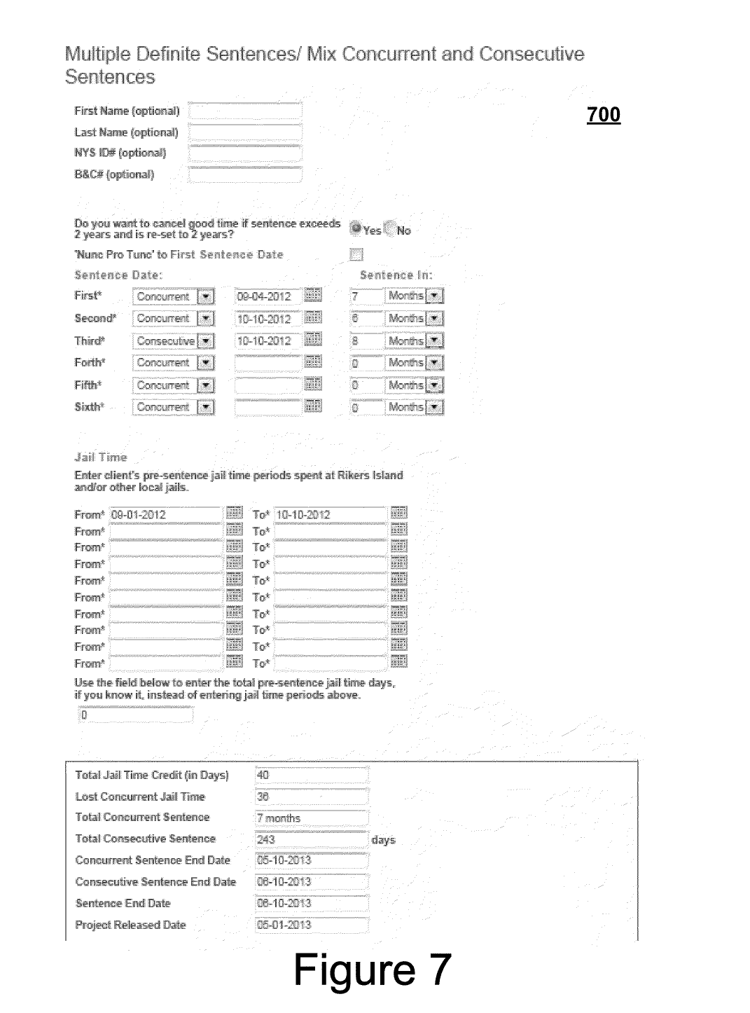

FIG. 7 illustrates a screenshot 700 of a sentence calculator module 250 that may be utilized to calculate sentence output data for a prisoner in instances when there is a mix of more than two sentences that are running concurrent and consecutive to each other.

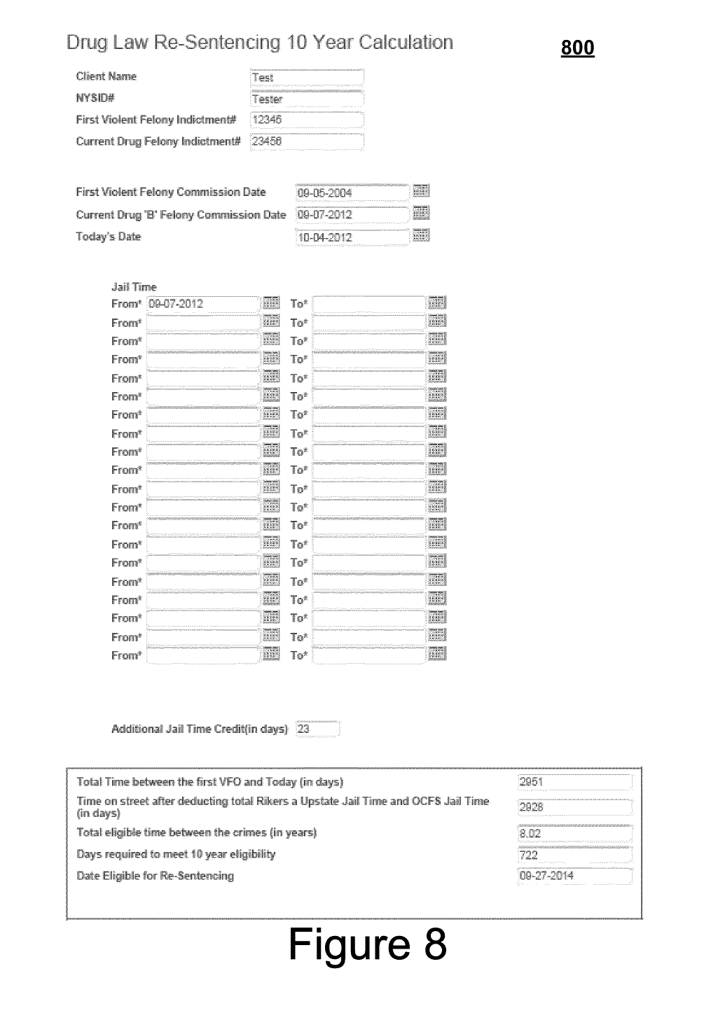

FIG. 8 illustrates a screenshot 800 of a sentence calculator module 250 that may be utilized to calculate sentence output data for determining re-sentencing eligibility under Rockefeller Drug Laws dealing with the sale and possession of narcotic drugs within the New York State Penal Law.

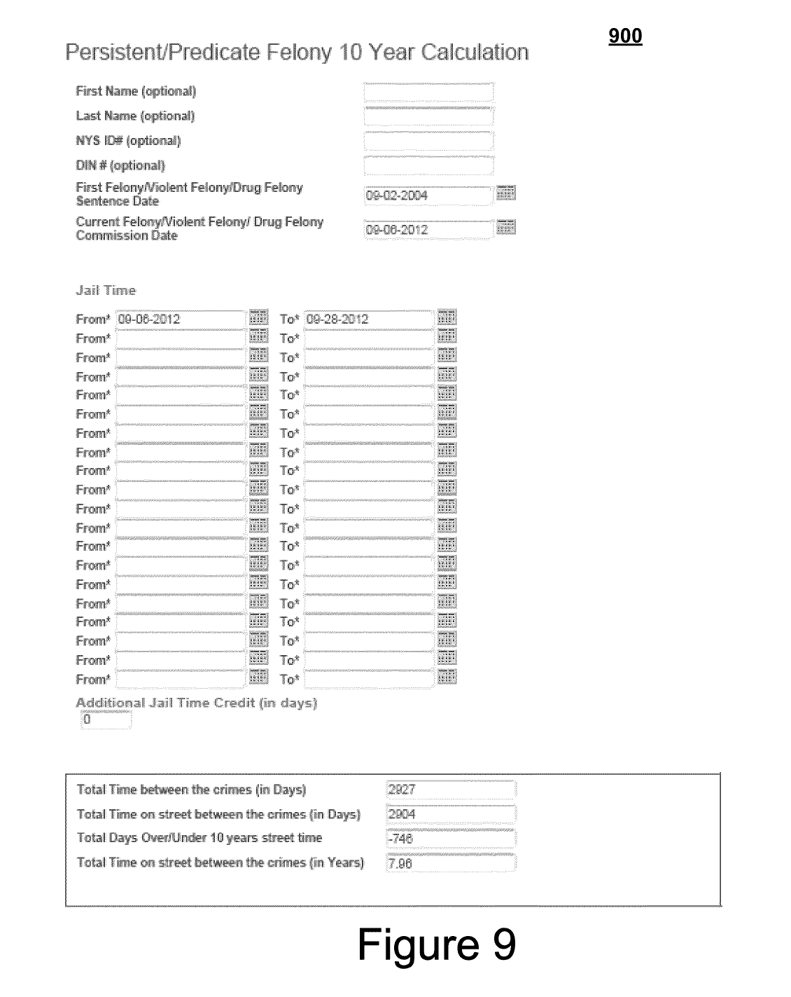

FIG. 9 illustrates a screenshot 900 of a sentence calculator module 250 that may be utilized to calculate sentence output data for determining whether a prisoner can or cannot be sentenced as a predicate, persistent or mandatory felony offender.

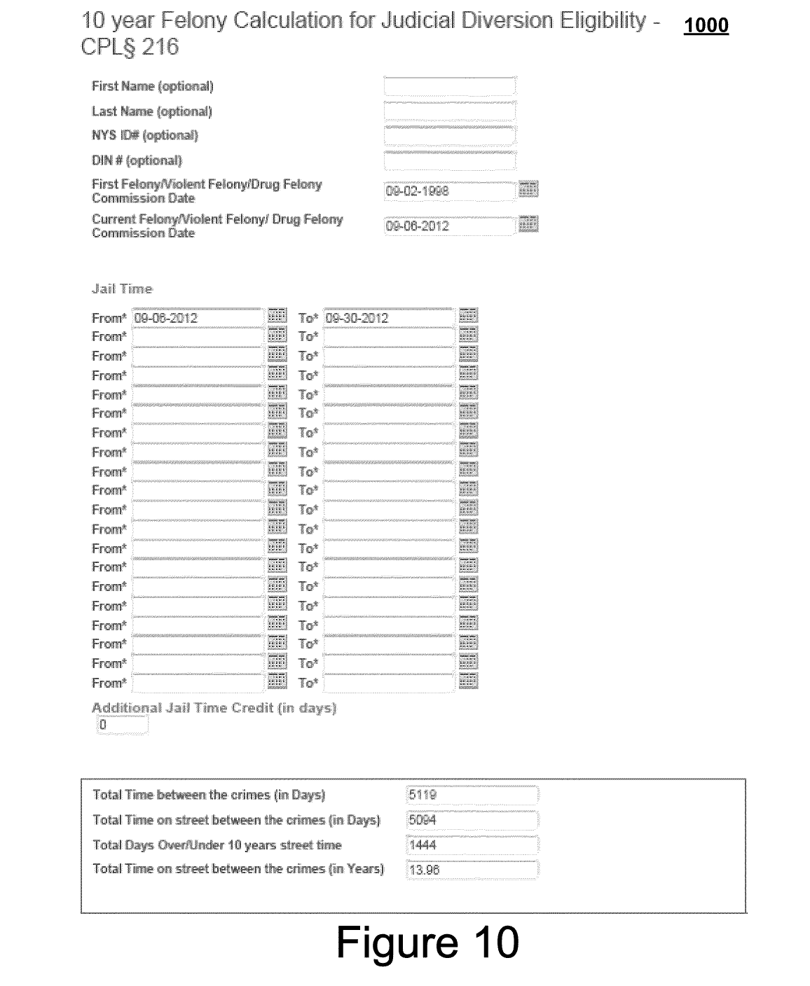

FIG. 10 illustrates a screenshot 1000 of a sentence calculator module 250 that may be utilized to calculate sentence output data for determining whether a prisoner is entitled to judicial diversion.

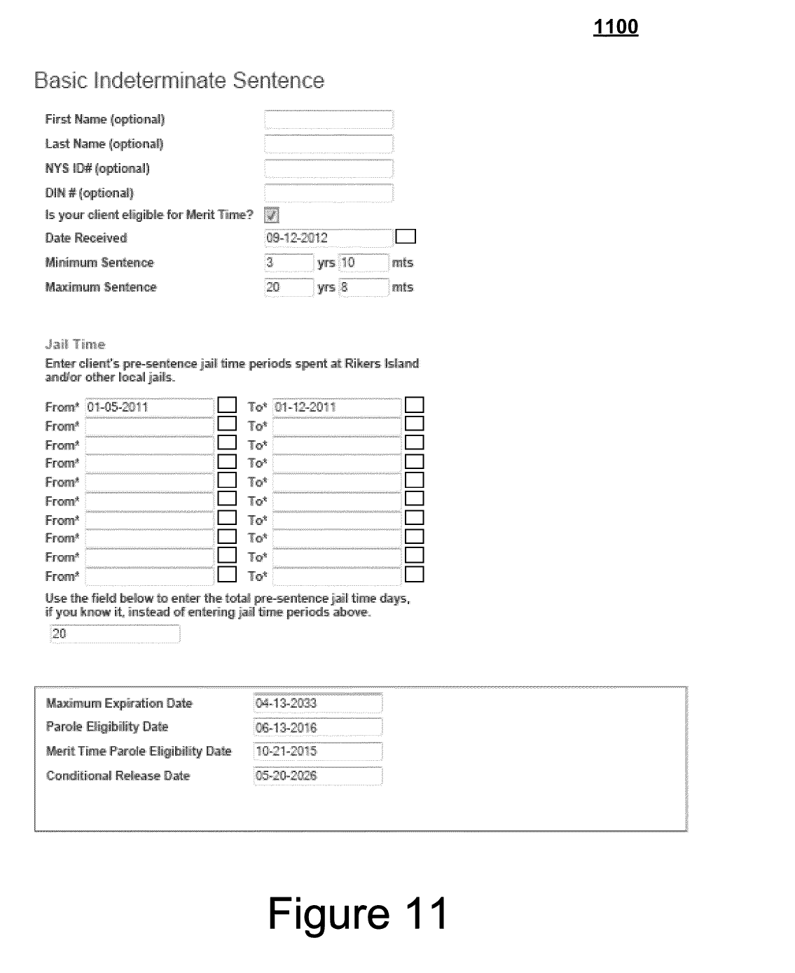

FIG. 11 illustrates a screenshot 1100 of a sentence calculator module 250 that may be utilized to calculate sentence output data for a basic indeterminate sentence if the prison sentence is a new sentence and the prisoner is not on parole or post-release supervision (PRS) for any prior sentence.

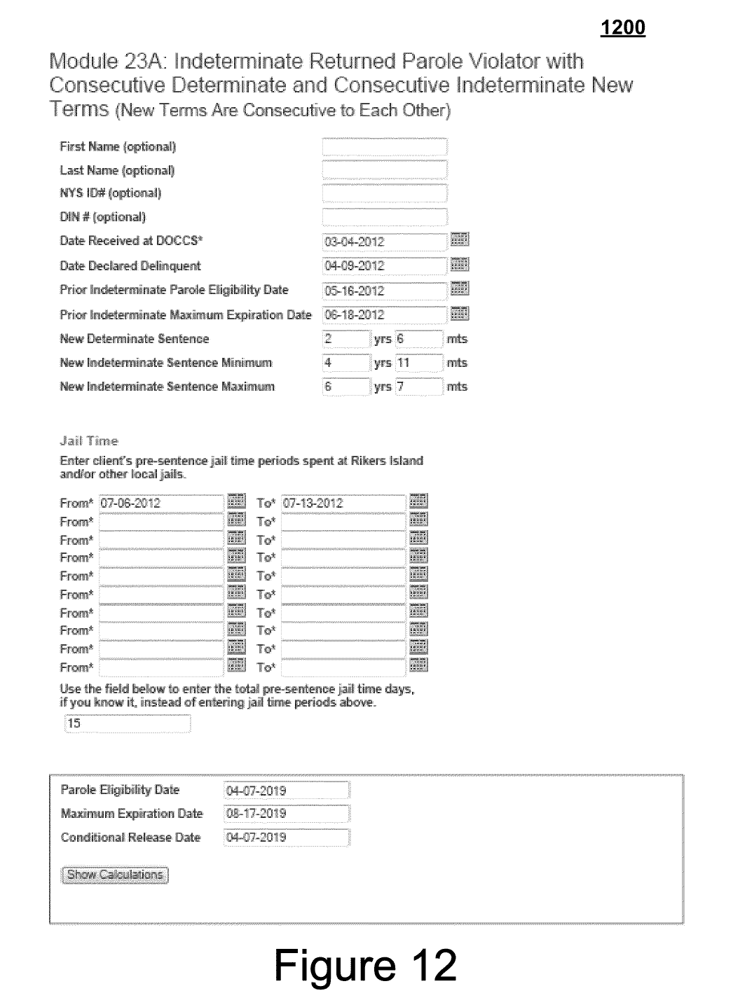

FIG. 12 illustrates a screenshot 1200 of a sentence calculator module 250 that may be utilized to calculate sentence output data for a prisoner that was previously sentenced to an indeterminate prison sentence, and who subsequently violated parole and is now sentenced to new indeterminate and determinate sentences that are consecutive to each other (and where the new sentences are also consecutive to the prior un-discharged indeterminate sentence).

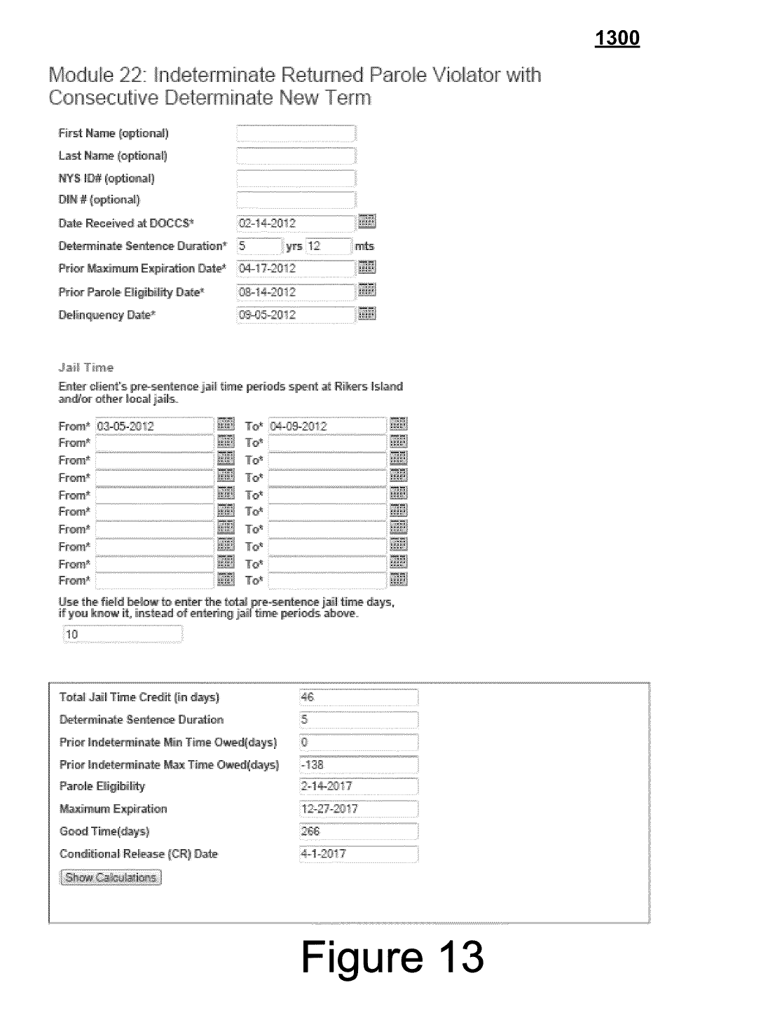

FIG. 13 illustrates a screenshot 1300 of a sentence calculator module 250 that may be utilized to calculate output data for a prisoner being sentenced to a new determinate sentence that is consecutive to a prior un-discharged indeterminate sentence.

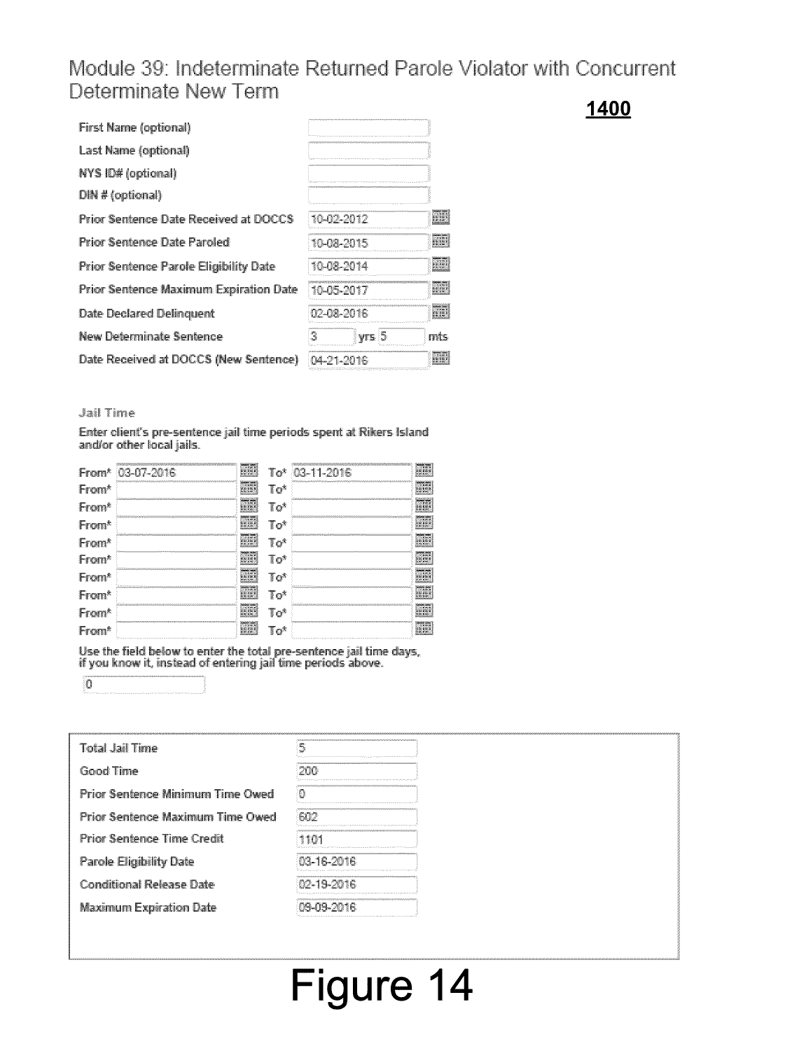

FIG. 14 illustrates a screenshot 1400 of a sentence calculator module 250 that may be utilized to calculate sentence output data for a prisoner being sentenced to a new determinate sentence that is concurrent to a prior un-discharged indeterminate sentence.

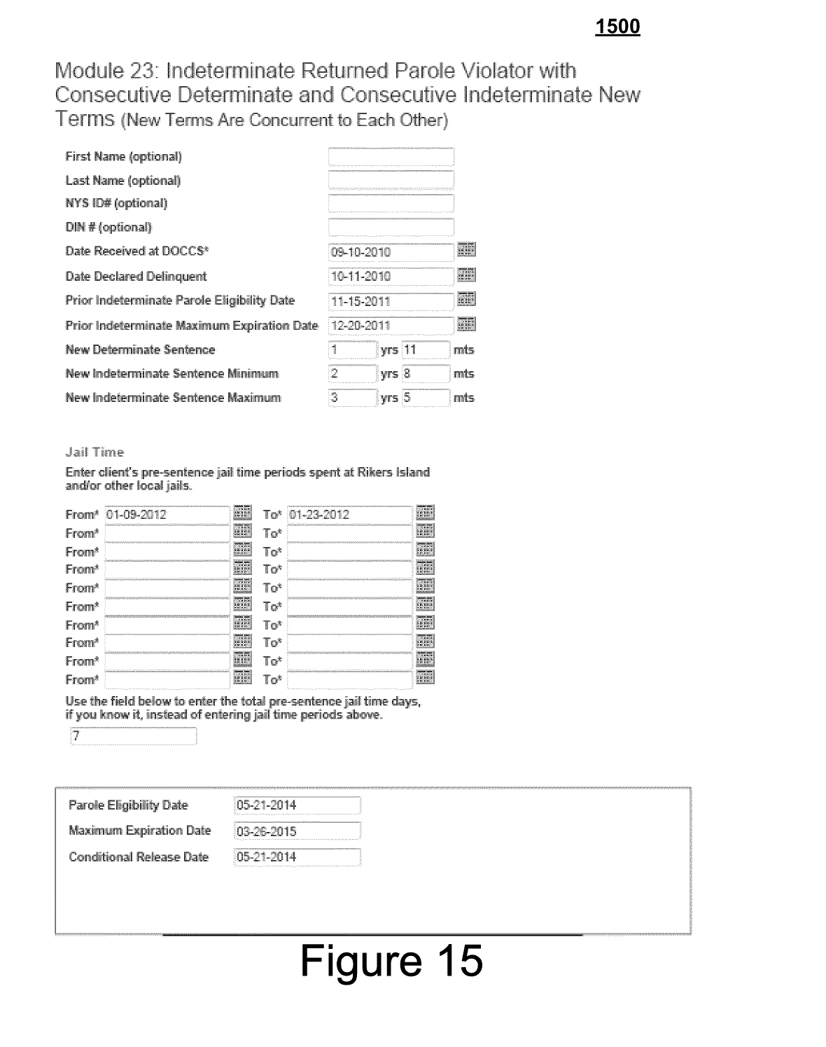

FIG. 15 illustrates a screenshot 1500 of a sentence calculator module 250 that may be utilized to calculate sentence output data for a prisoner being sentenced to new indeterminate and determinate sentences that are concurrent to each other after a parole violation, and which are also consecutive to a prior un-discharged indeterminate sentence.

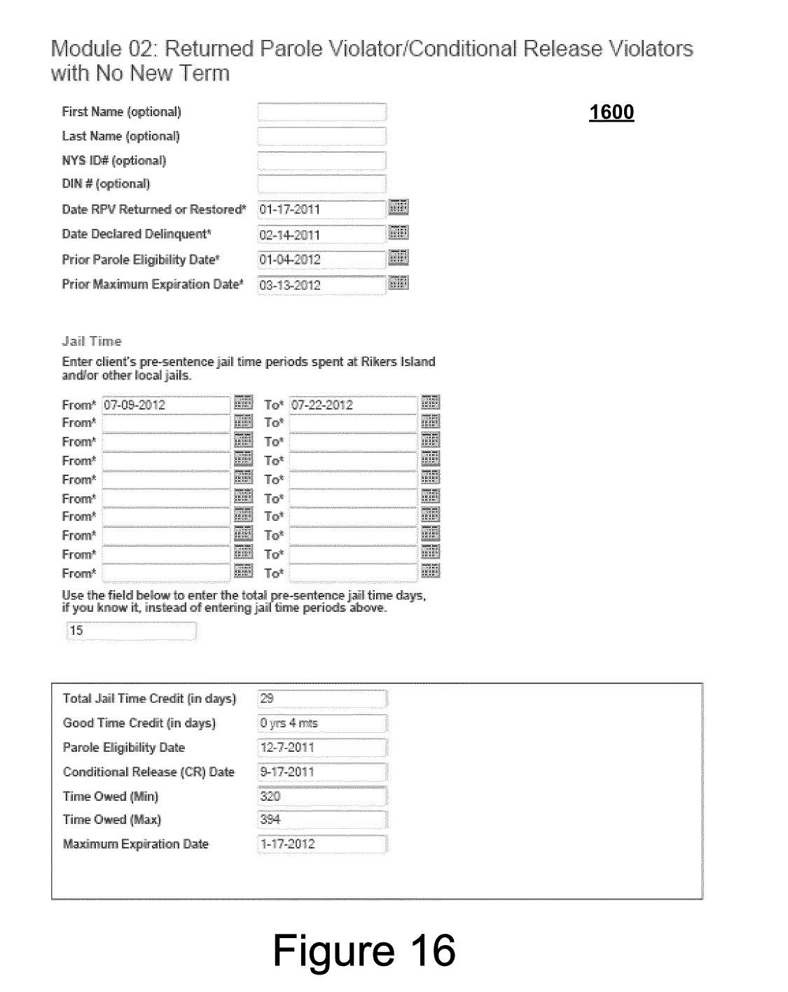

FIG. 16 illustrates a screenshot 1600 of a sentence calculator module 250 that may be utilized to calculate sentence output data for a prisoner in the instance where there is an interruption of a sentence when the prisoner violates parole supervision (or conditional release terms) and no new sentence is imposed.

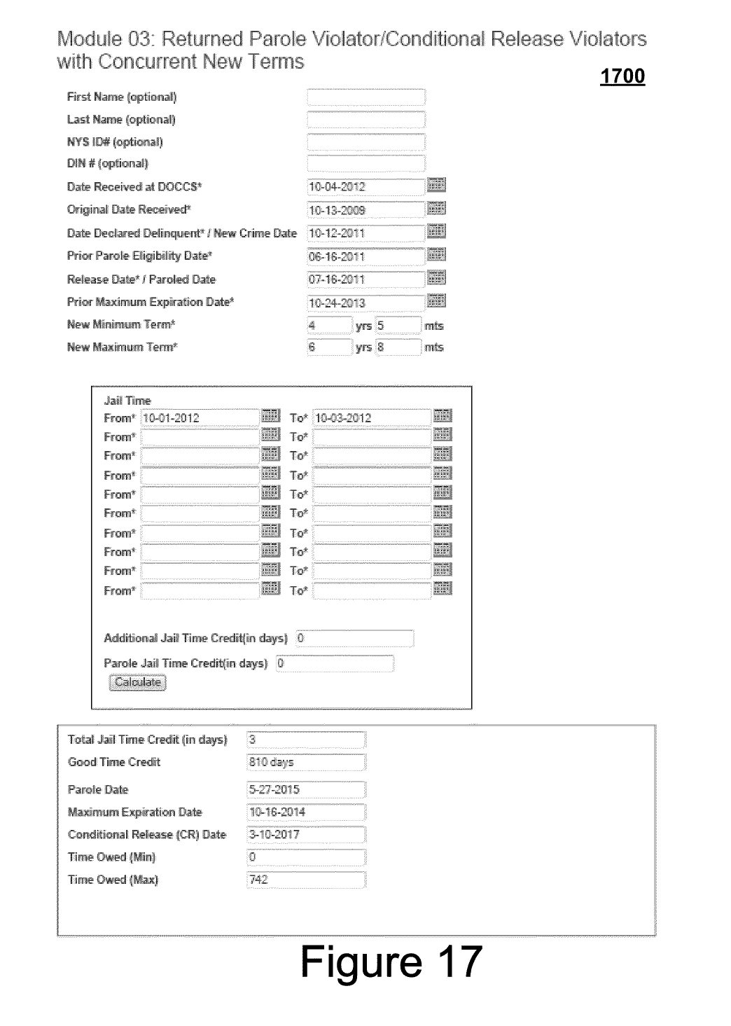

FIG. 17 illustrates a screenshot 1700 of a sentence calculator module 250 that may be utilized to calculate sentence output data for a parole violator or conditional release violator that has been sentenced to a new indeterminate sentence that runs concurrent to a prior un-discharged term.

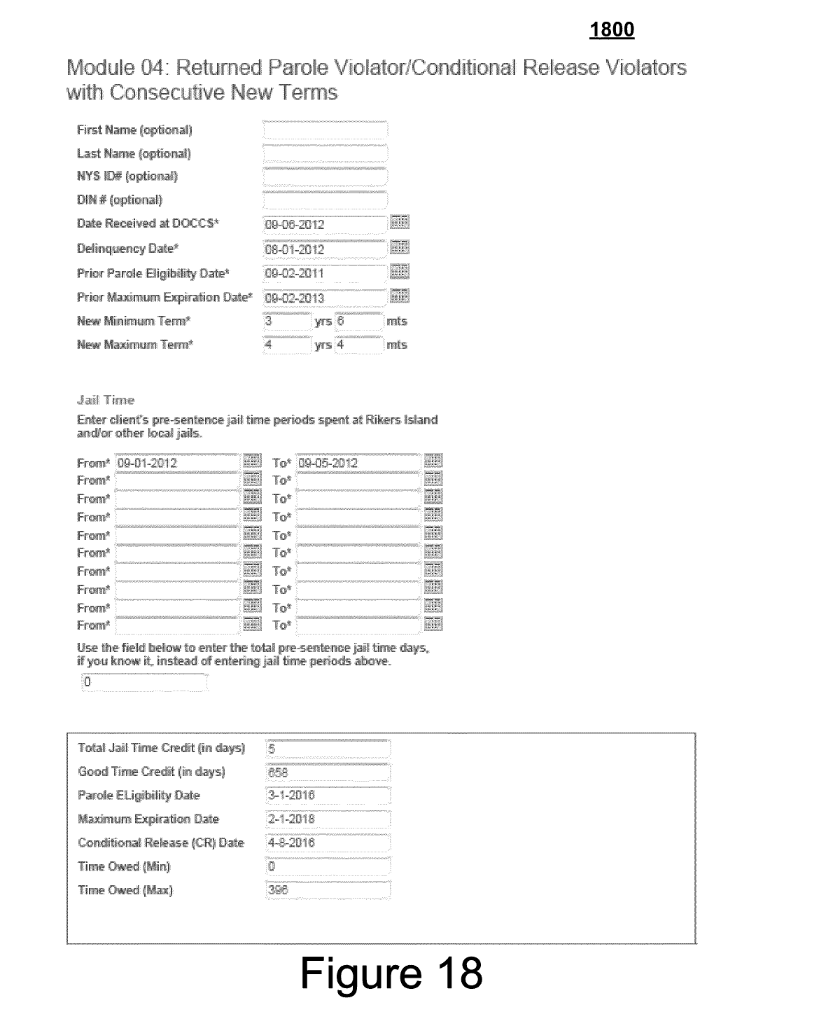

FIG. 18 illustrates a screenshot 1800 of a sentence calculator module 250 that may be utilized to calculate sentence output data for a parole violator or conditional release violator that has been sentenced to a new indeterminate sentence that runs consecutive to a prior un-discharged term.

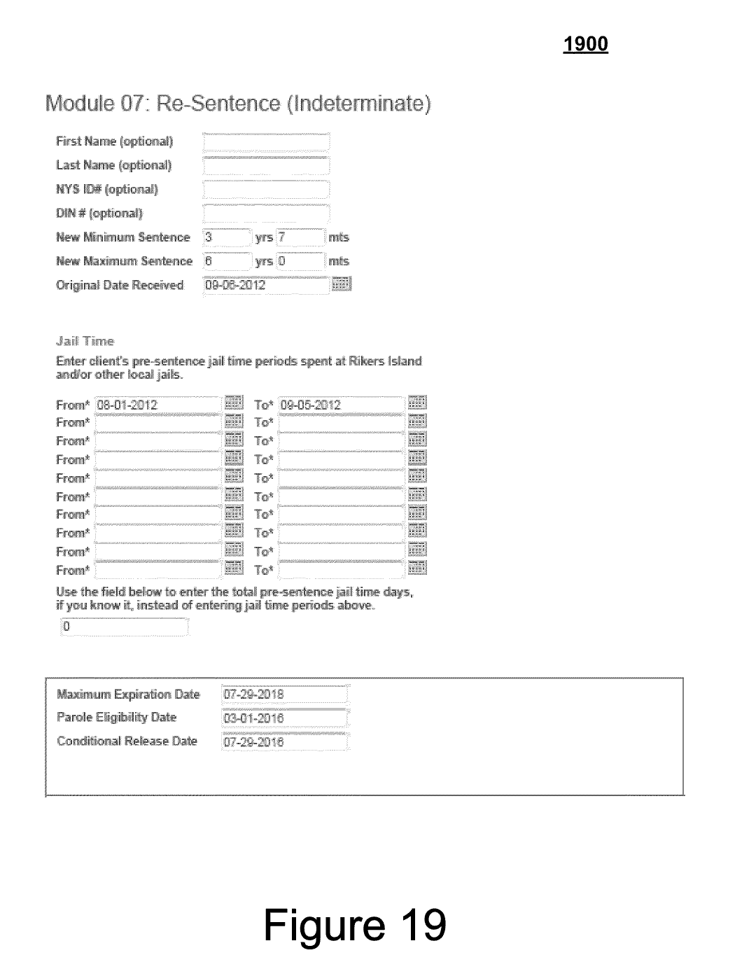

FIG. 19 illustrates a screenshot 1900 of a sentence calculator module 250 that may be utilized to calculate sentence output data for a prisoner subject to re-sentencing for an indeterminate sentence.

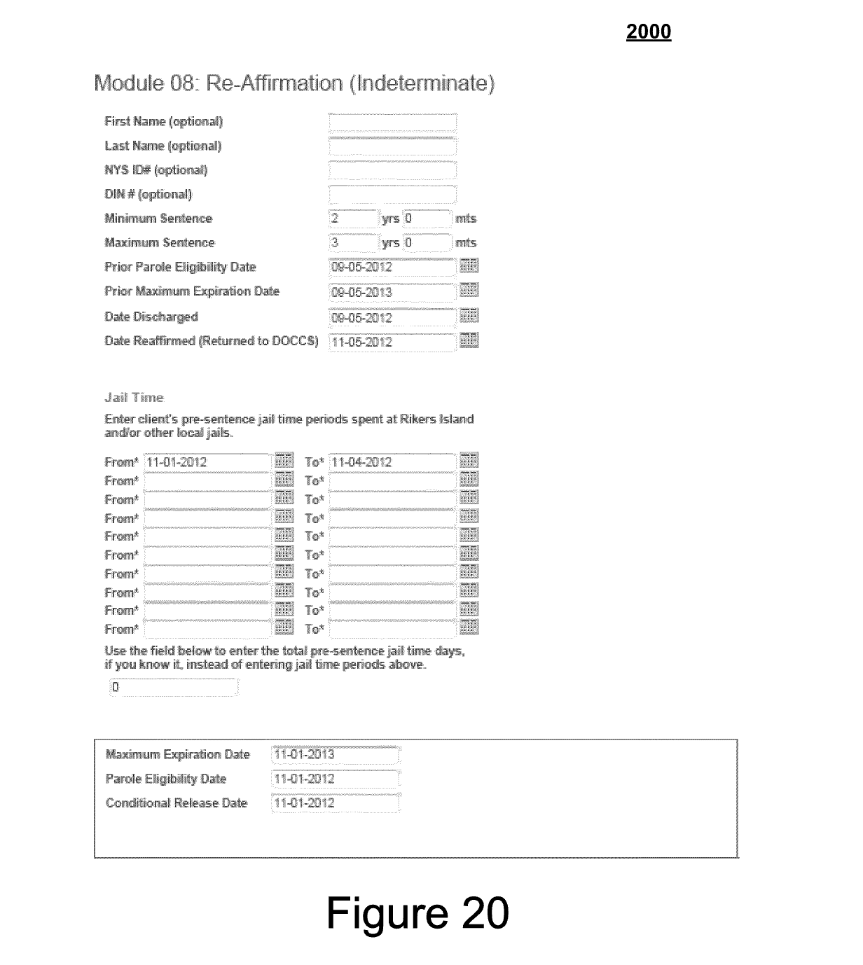

FIG. 20 illustrates a screenshot 2000 of a sentence calculator module 250 that may be utilized to calculate sentence output data for a prisoner that was discharged by a court order and later returned with a reaffirmation or re-sentence.

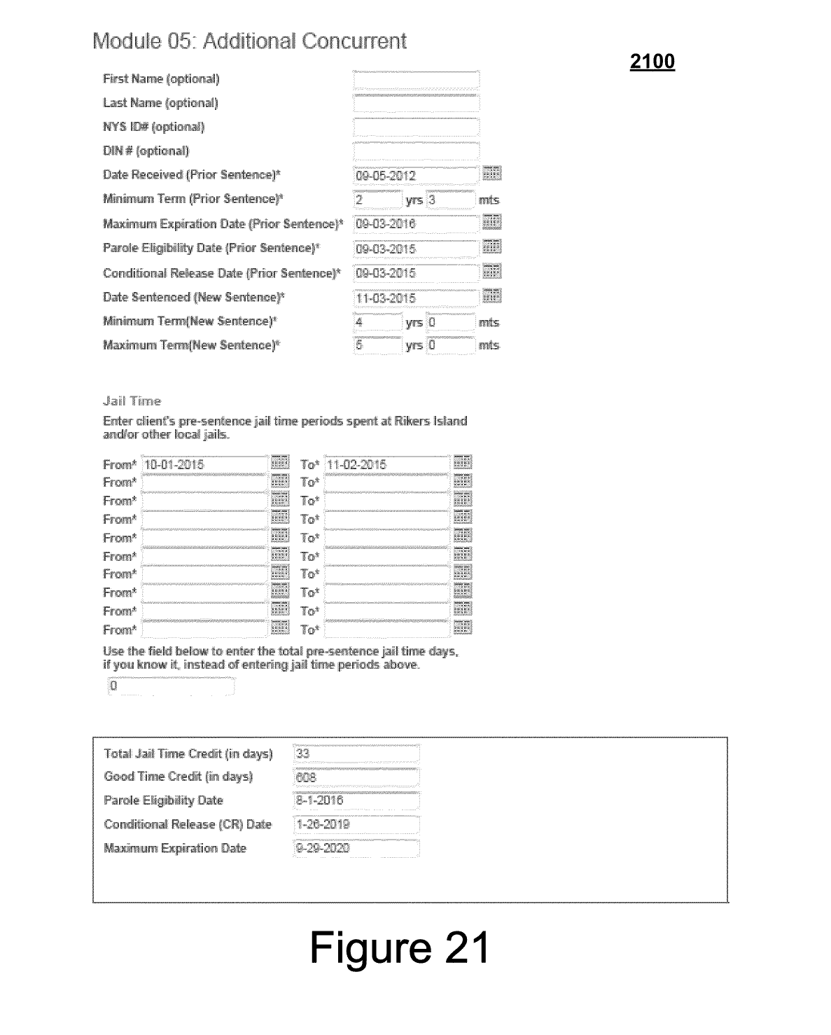

FIG. 21 illustrates a screenshot 2100 of a sentence calculator module 250 that may be utilized to calculate sentence output data for any additional concurrent indeterminate sentence a prisoner receives while serving an indeterminate sentence in a correctional facility.

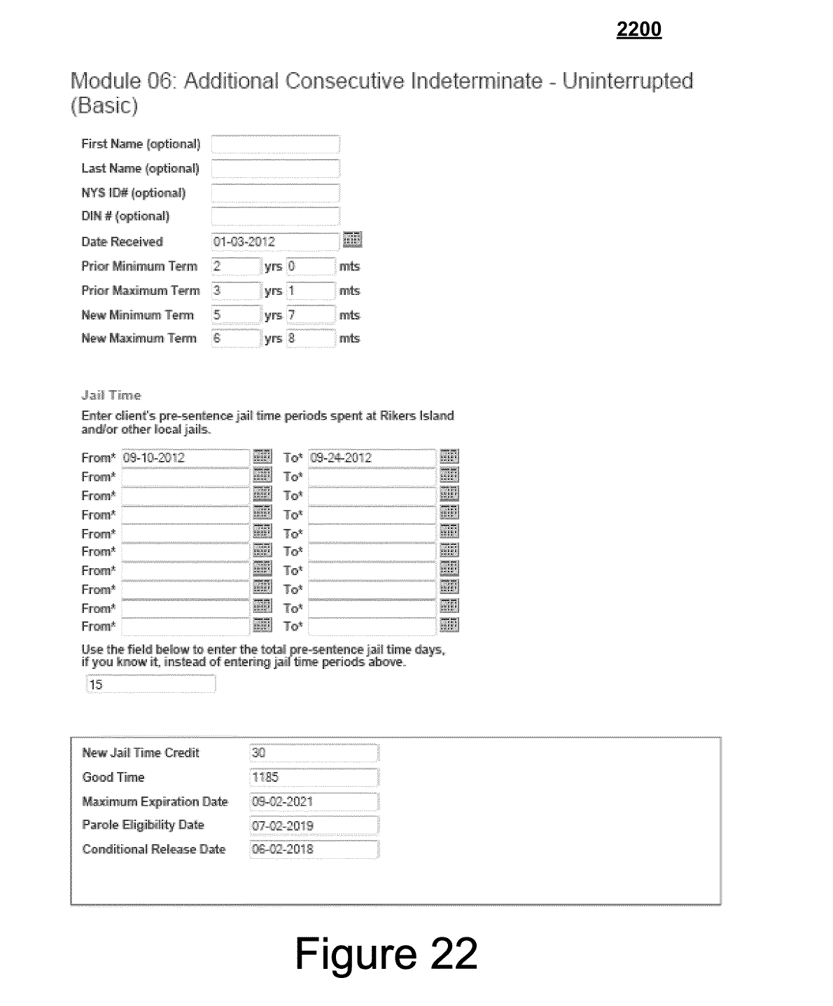

FIG. 22 illustrates a screenshot 2200 of a sentence calculator module 250 that may be utilized to calculate sentence output data for any additional consecutive indeterminate sentence a prisoner receives while serving an indeterminate sentence in a correctional facility.

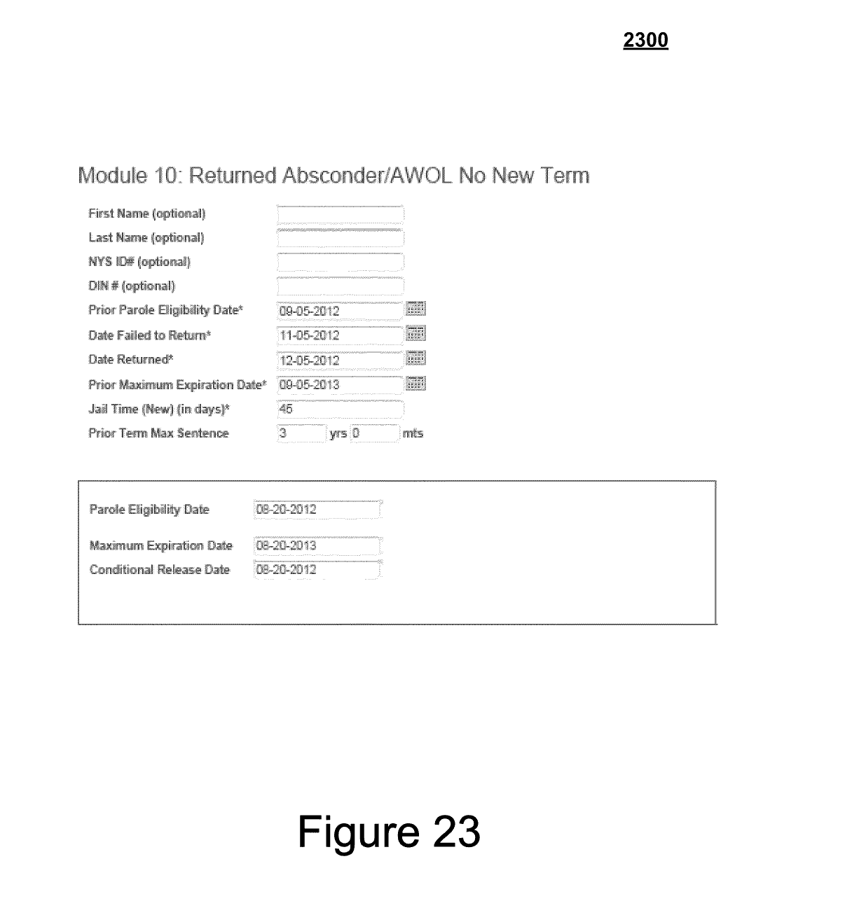

FIG. 23 illustrates a screenshot 2300 of a sentence calculator module 250 that may be utilized to calculate sentence output data for a prisoner that is a returned absconder/AWOL with no new term.

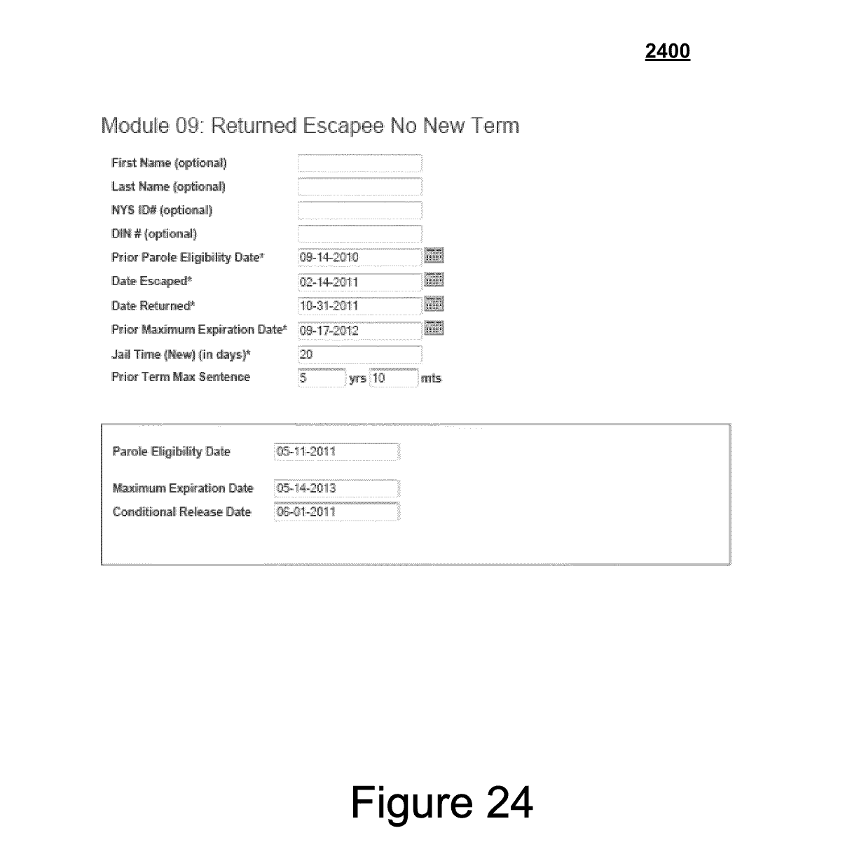

FIG. 24 illustrates a screenshot 2400 of a sentence calculator module 250 that may be utilized to calculate sentence output data for a prisoner that is a returned escapee with no new term.

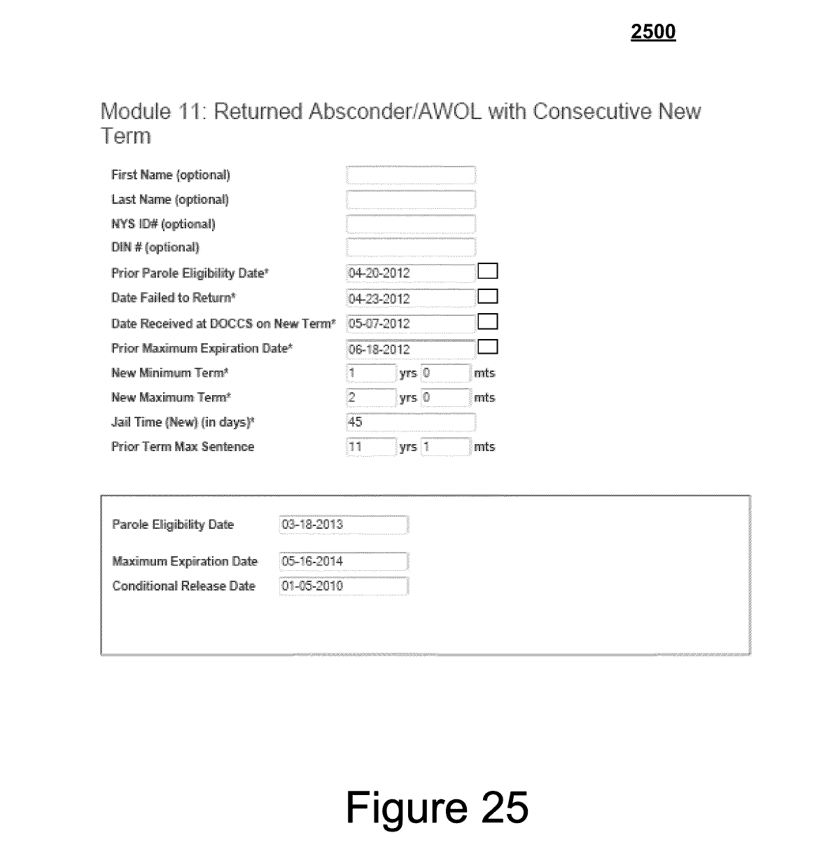

FIG. 25 illustrates a screenshot 2500 of a sentence calculator module 250 that may be utilized to calculate sentence output data for a prisoner that is a returned absconder/AWOL with a consecutive new term.

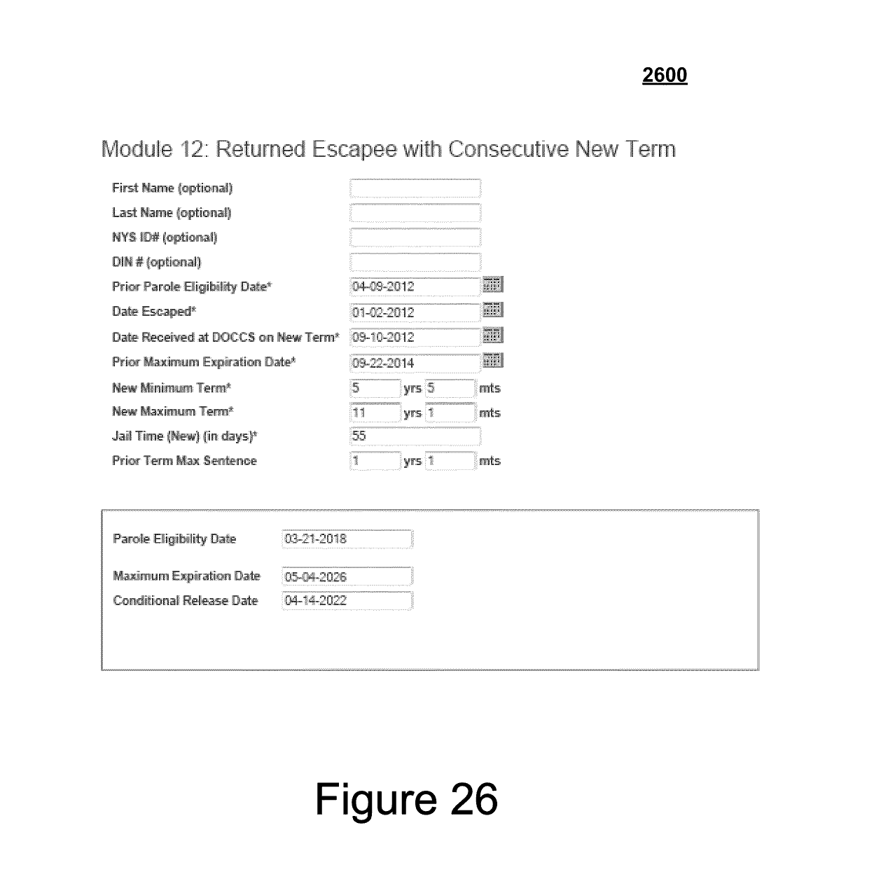

FIG. 26 illustrates a screenshot 2600 of a sentence calculator module 250 that may be utilized to calculate sentence output data for a prisoner that is a returned escapee with a consecutive new term.

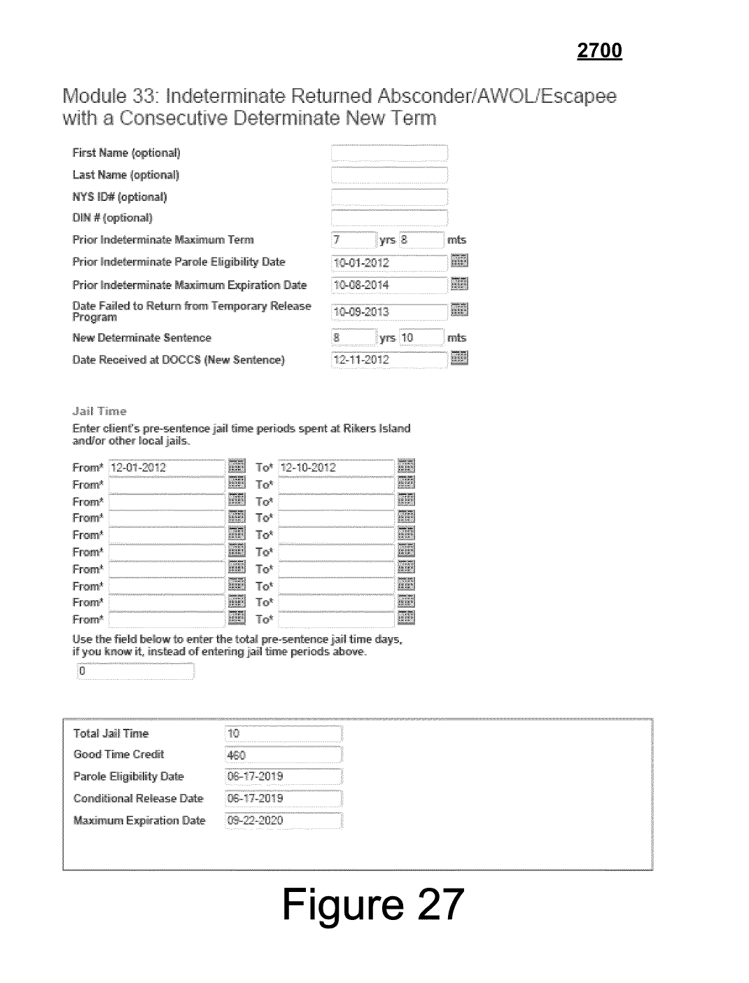

FIG. 27 illustrates a screenshot 2700 of a sentence calculator module 250 that may be utilized to calculate sentence output data for a prisoner that was serving an indeterminate sentence before being returned to a correctional facility as an absconder/AWOL/escapee with a new determinate term that is consecutive to the prior indeterminate term.

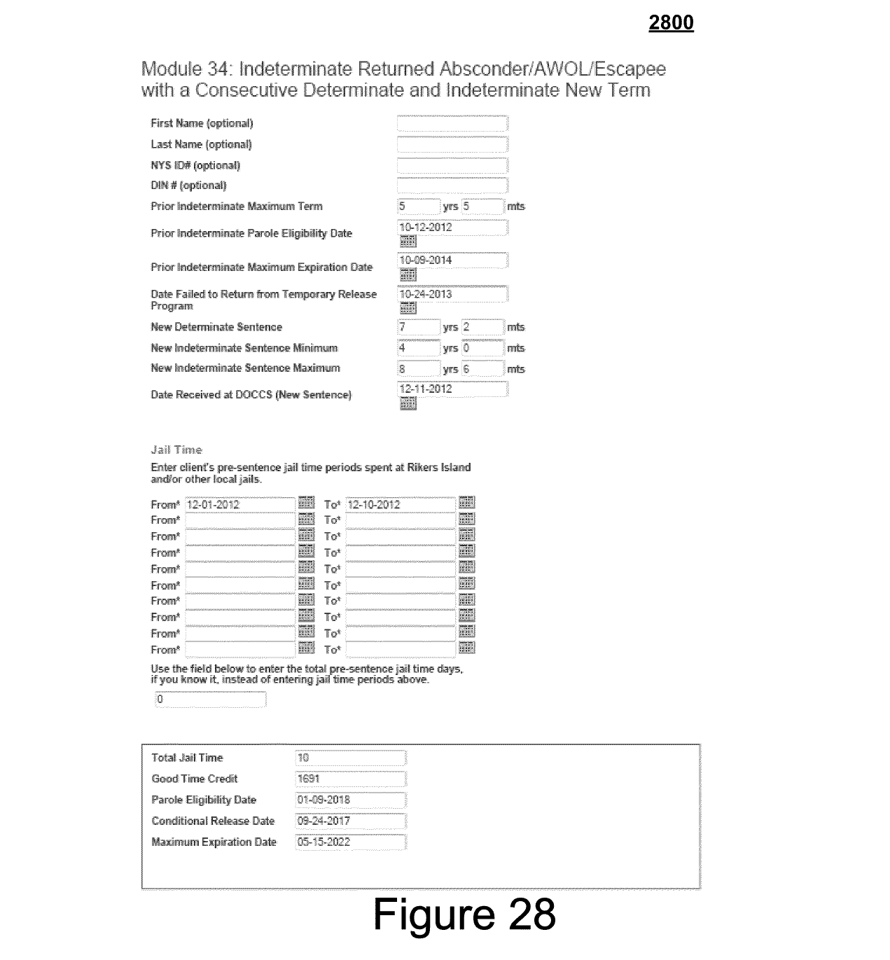

FIG. 28 illustrates a screenshot 2800 of a sentence calculator module 250 that may be utilized to calculate sentence output data for a prisoner that was serving an indeterminate sentence before being returned to a correctional facility as an absconder/AWOL/escapee with new determinate and indeterminate terms that are concurrent with each other, but consecutive to the prior indeterminate term.

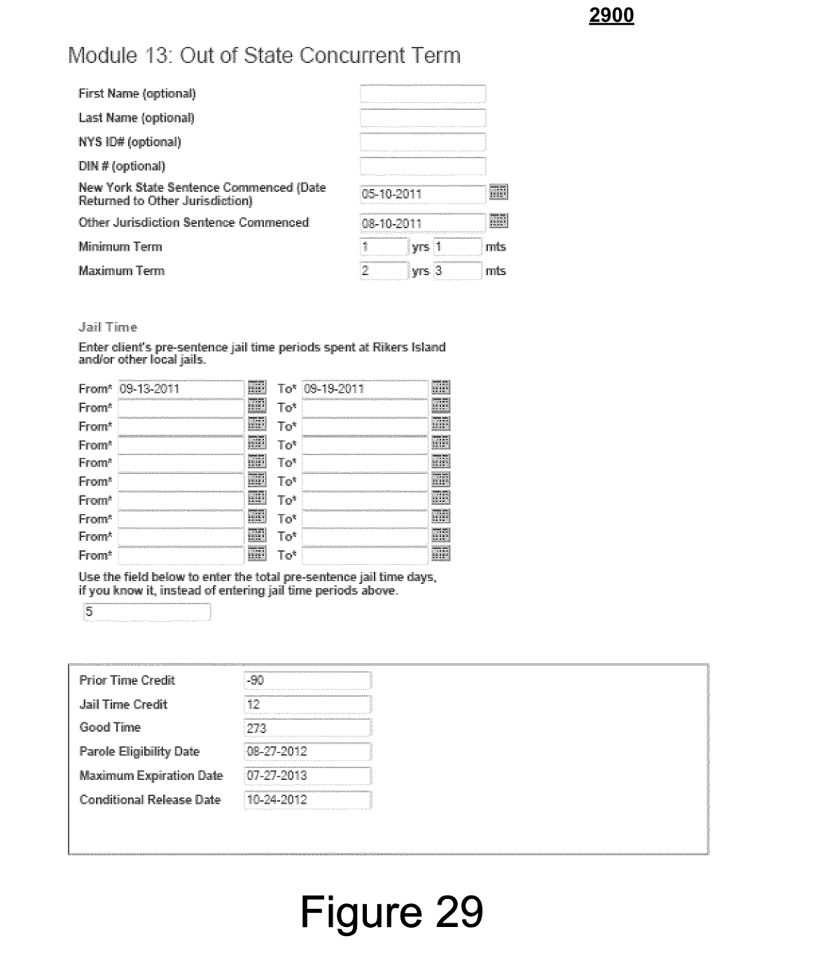

FIG. 29 illustrates a screenshot 2900 of a sentence calculator module 250 that may be utilized to calculate sentence output data for a New York State sentence that is running concurrent with another state or federal sentence.

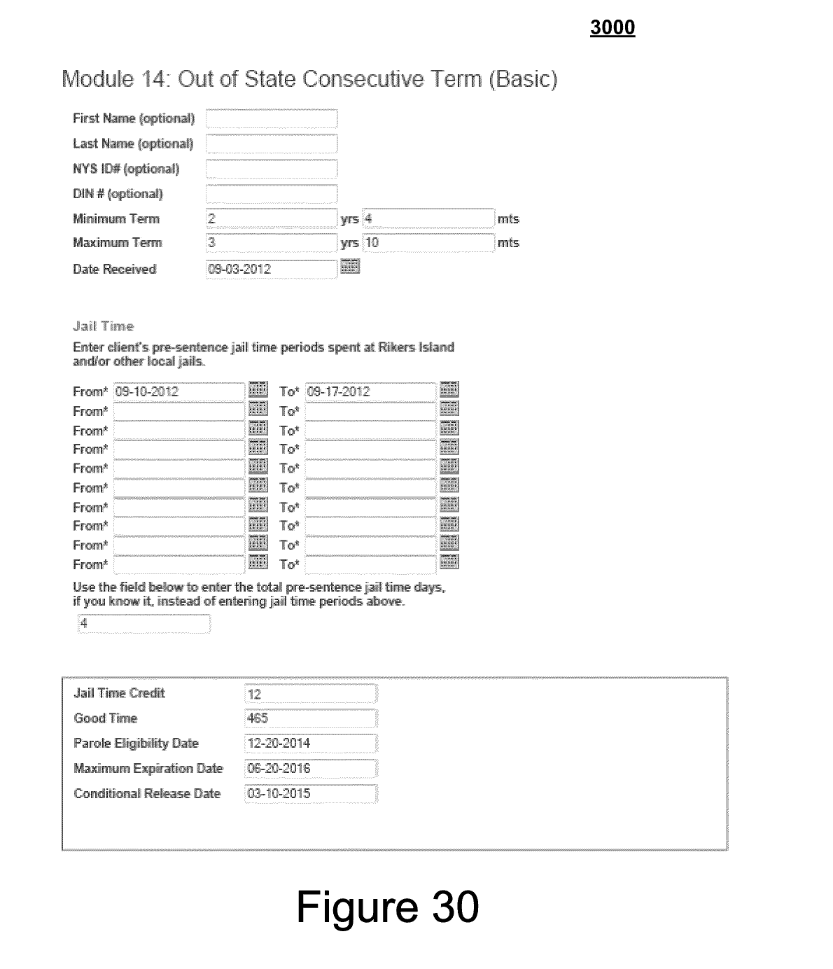

FIG. 30 illustrates a screenshot 3000 of a sentence calculator module 250 that may be utilized to calculate sentence output data for a prisoner who receives a consecutive sentence while serving time on an un-discharged sentence from another state or federal jurisdiction.

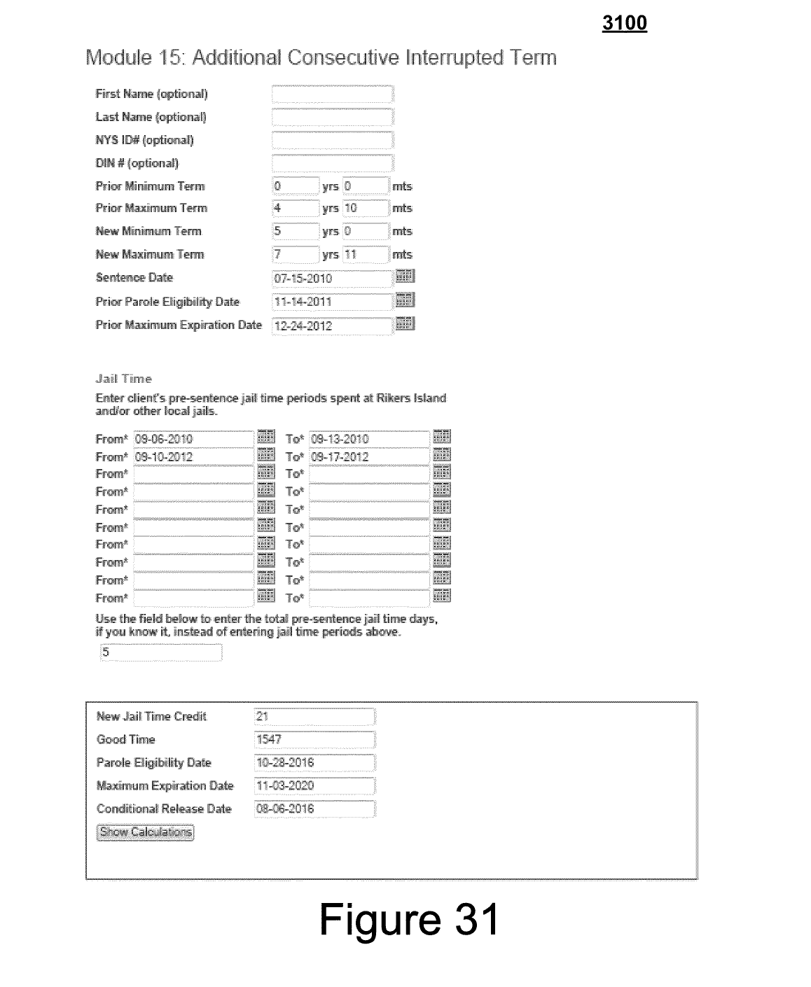

FIG. 31 illustrates a screenshot 3100 of a sentence calculator module 250 that may be utilized to calculate any additional consecutive indeterminate sentence a prisoner receives while serving an indeterminate sentence in a correctional facility, if the prisoner's calculation is anything other than a basic indeterminate computation or if the prisoner has reached the parole eligibility date before the date of the additional sentence.

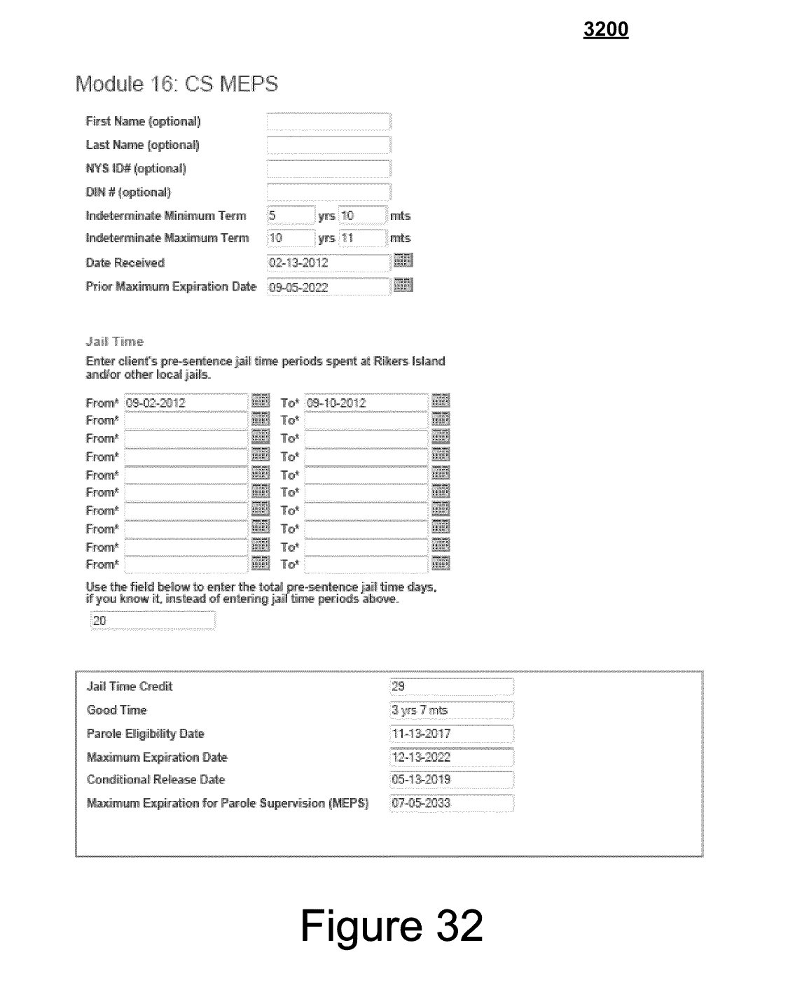

FIG. 32 illustrates a screenshot 3200 of a sentence calculator module 250 that may be utilized to calculate sentence output data for a prisoner who is a returned parole violator that has received a new indeterminate term that is consecutive to the prior un-discharged sentence and there is no delinquency date.

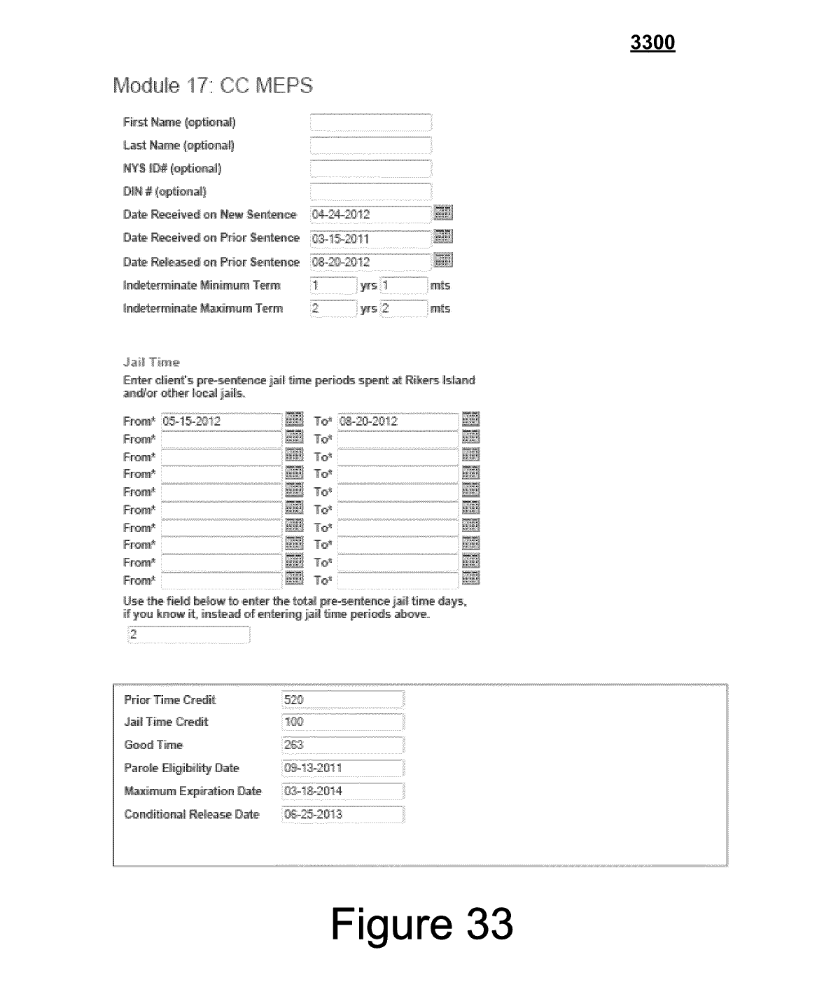

FIG. 33 illustrates a screenshot 3300 of a sentence calculator module 250 that may be utilized to calculate sentence output data for a prisoner who is a returned parole violator that has received a new indeterminate term that is concurrent to the prior un-discharged sentence and there is no delinquency date.

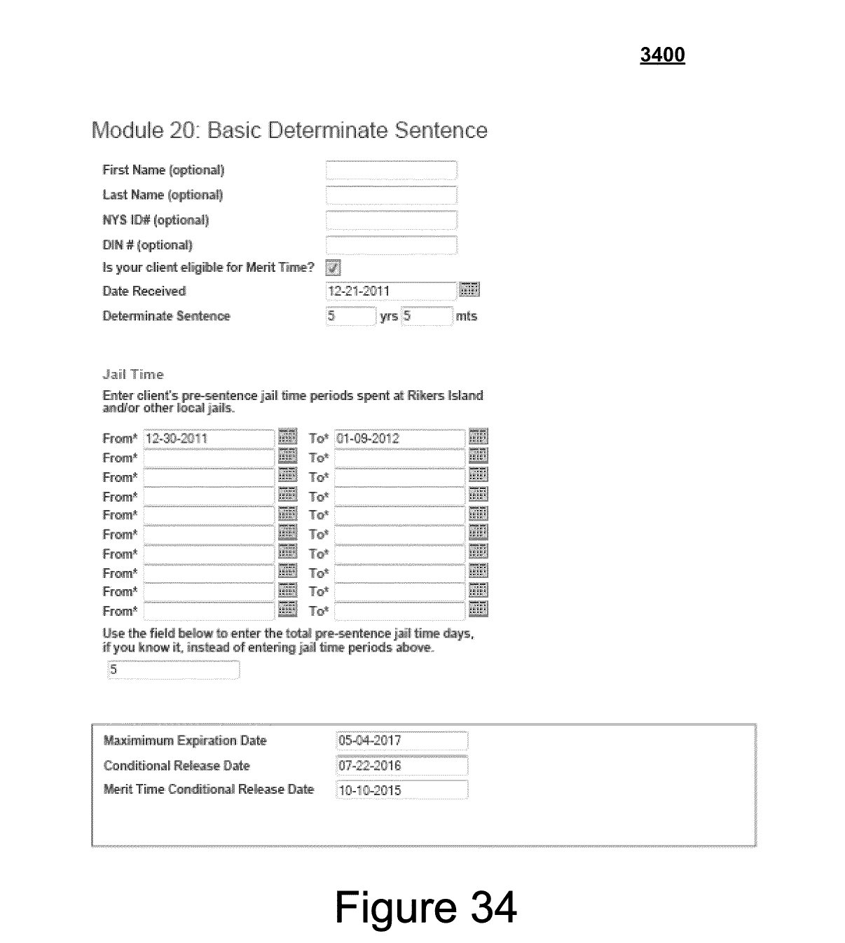

FIG. 34 illustrates a screenshot 3400 of a sentence calculator module 250 that may be utilized to calculate sentence output data for a prisoner has been sentenced to a basic determinate sentence and the prisoner is not on parole or post-release supervision (PRS) for any prior sentence.

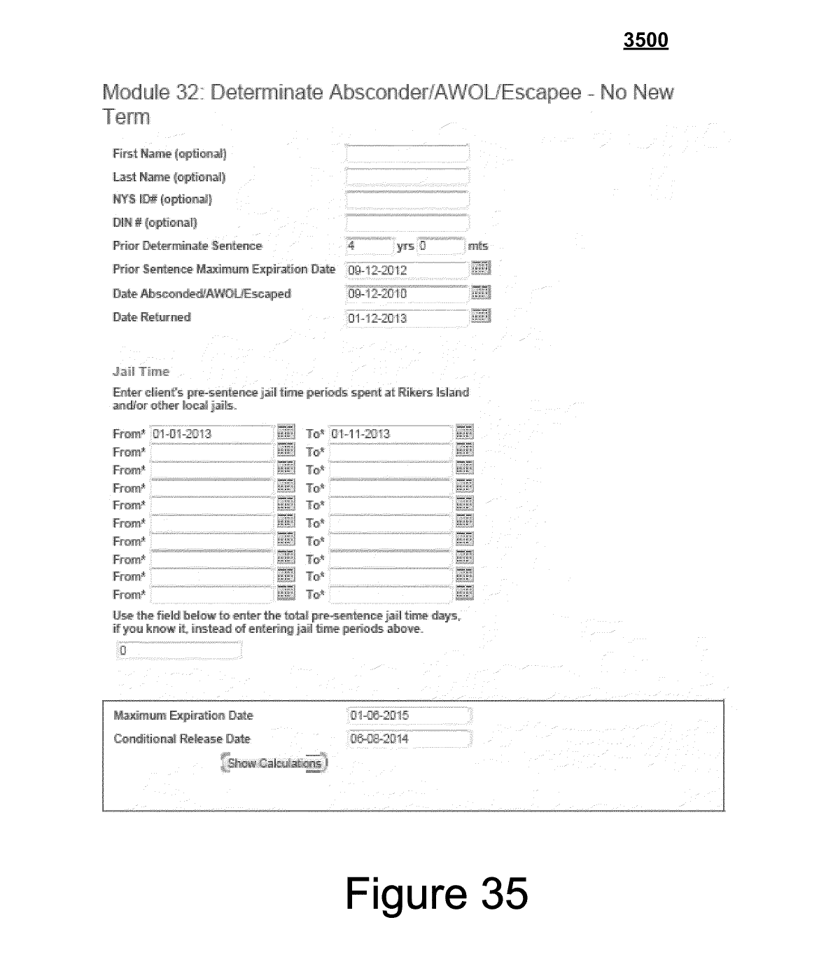

FIG. 35 illustrates a screenshot 3500 of a sentence calculator module 250 that may be utilized to calculate sentence output data for a prisoner originally sentenced to a determinate sentence and who is a returned absconder/AWOL/escapee with no new term.

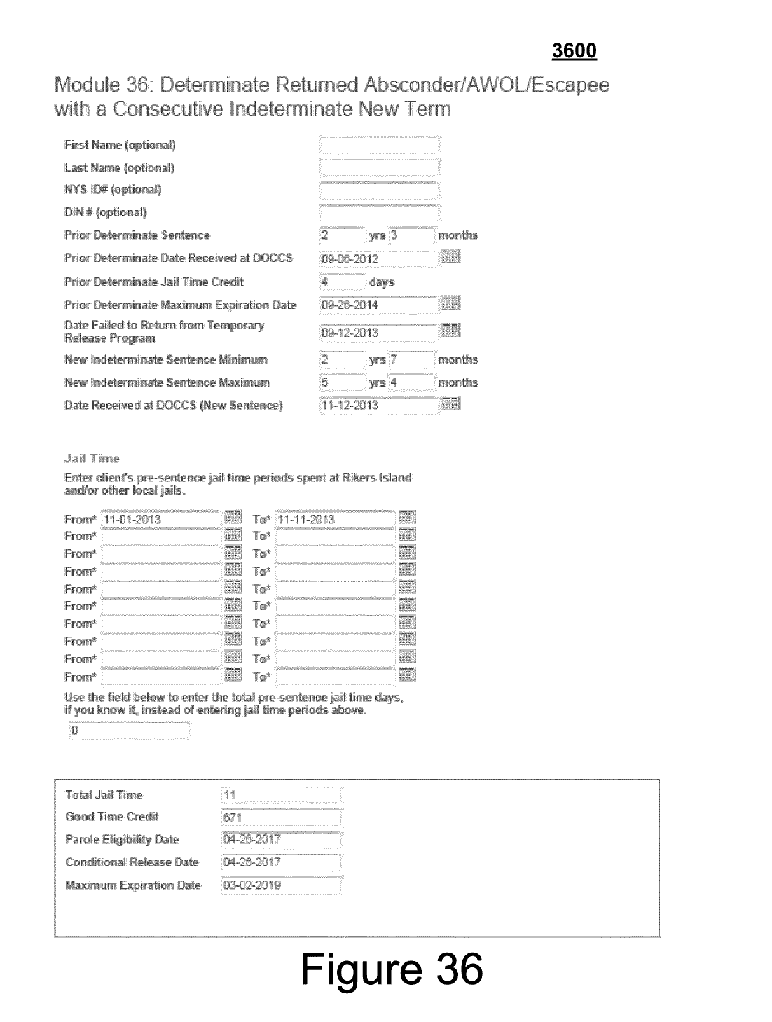

FIG. 36 illustrates a screenshot 3600 of a sentence calculator module 250 that may be utilized to calculate sentence output data for a prisoner originally sentenced to a determinate sentence who is a returned absconder/AWOL/escapee with a consecutive new indeterminate term.

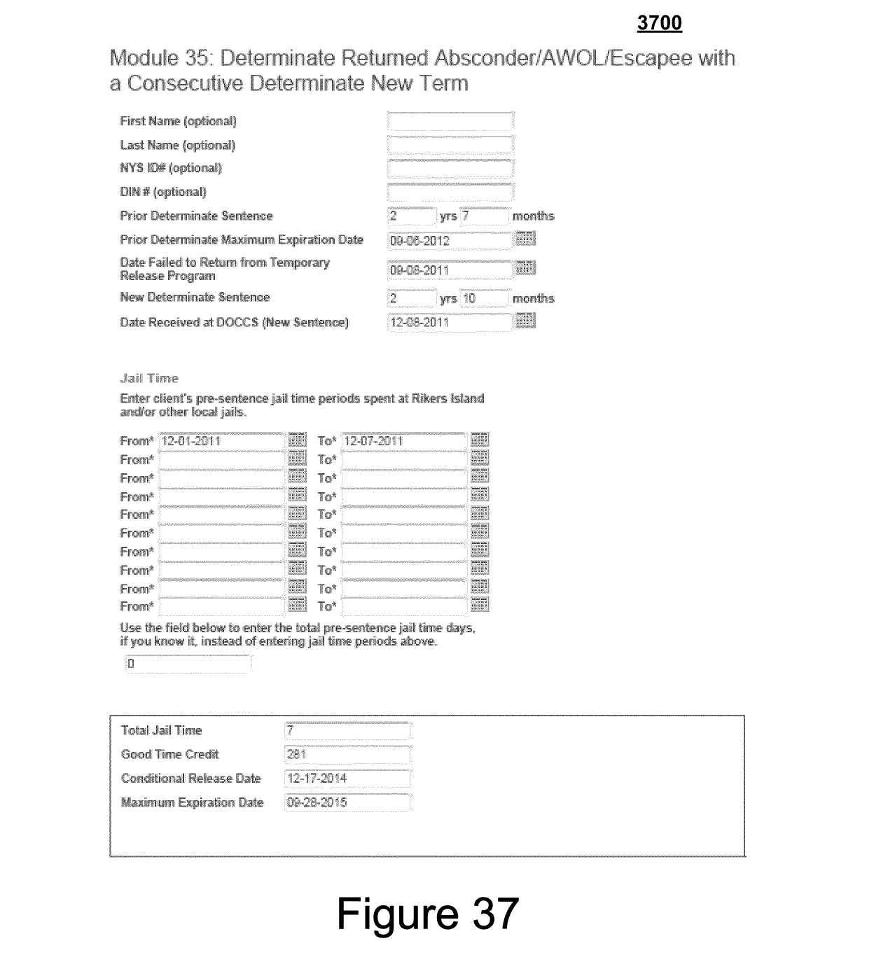

FIG. 37 illustrates a screenshot 3700 of a sentence calculator module 250 that may be utilized to calculate sentence output data for a prisoner originally sentenced to a determinate sentence who is a returned absconder/AWOL/escapee with a consecutive new determinate term.

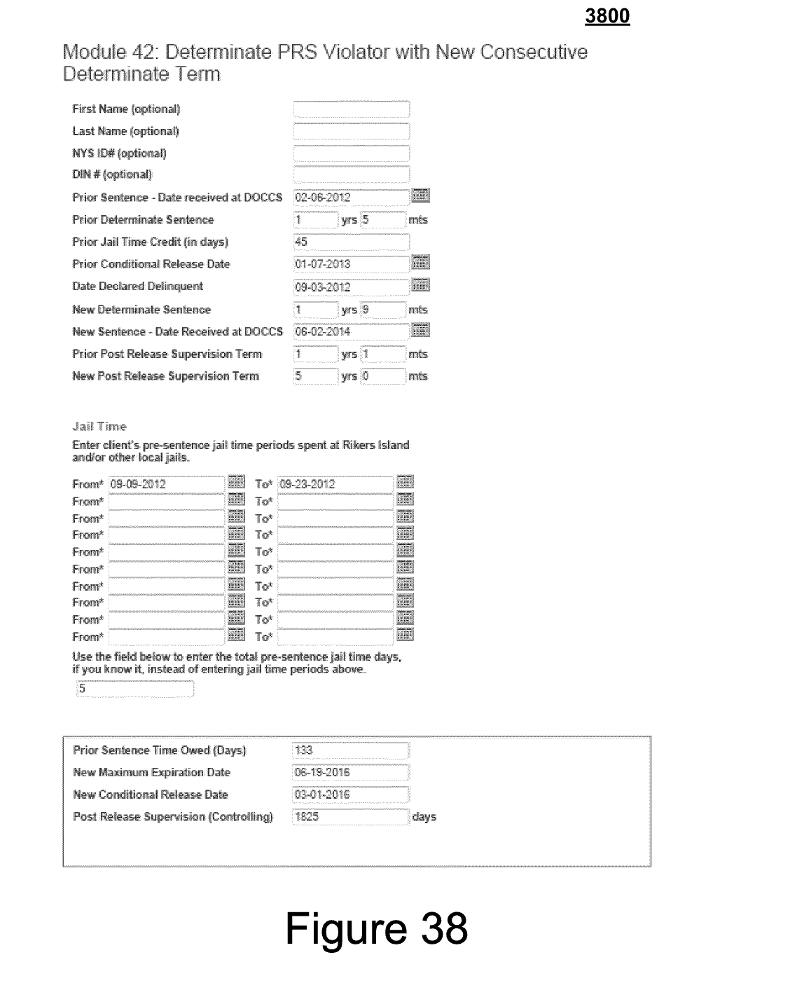

FIG. 38 illustrates a screenshot 3800 of a sentence calculator module 250 that may be utilized to calculate sentence output data for a prisoner who has committed a new crime while on post-release supervision from a prior determinate sentence and who receives a new determinate sentence that is consecutive to the prior determinate sentence.

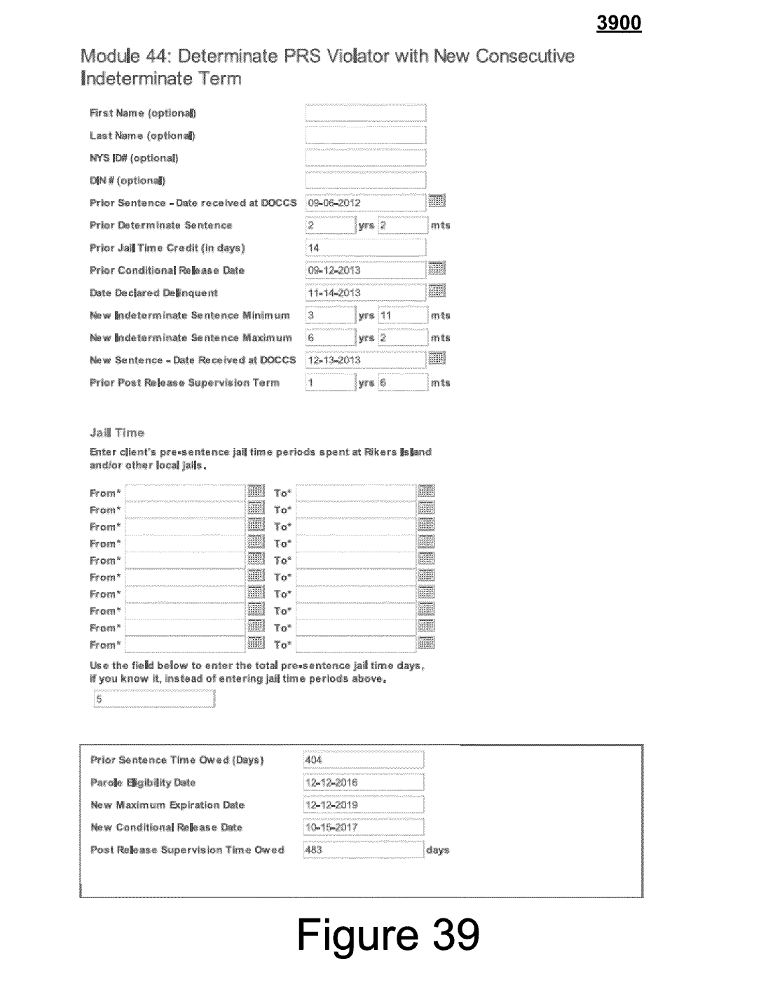

FIG. 39 illustrates a screenshot 3900 of a sentence calculator module 250 that may be utilized to calculate sentence output data for a prisoner who has committed a new crime while on post-release supervision from a prior determinate sentence and who receives a new indeterminate sentence that is consecutive to a prior determinate sentence.

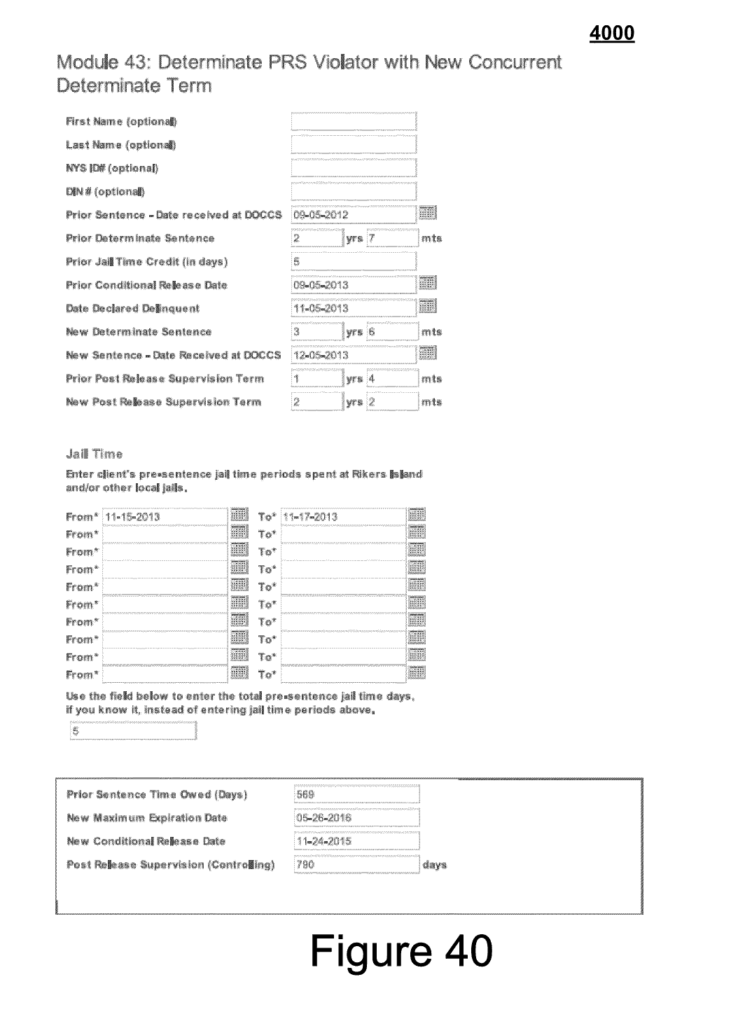

FIG. 40 illustrates a screenshot 4000 of a sentence calculator module 250 that may be utilized to calculate sentence output data for a prisoner who has committed a new crime while on post-release supervision from a prior determinate sentence and who receives a new determinate sentence that is concurrent to the prior determinate sentence.

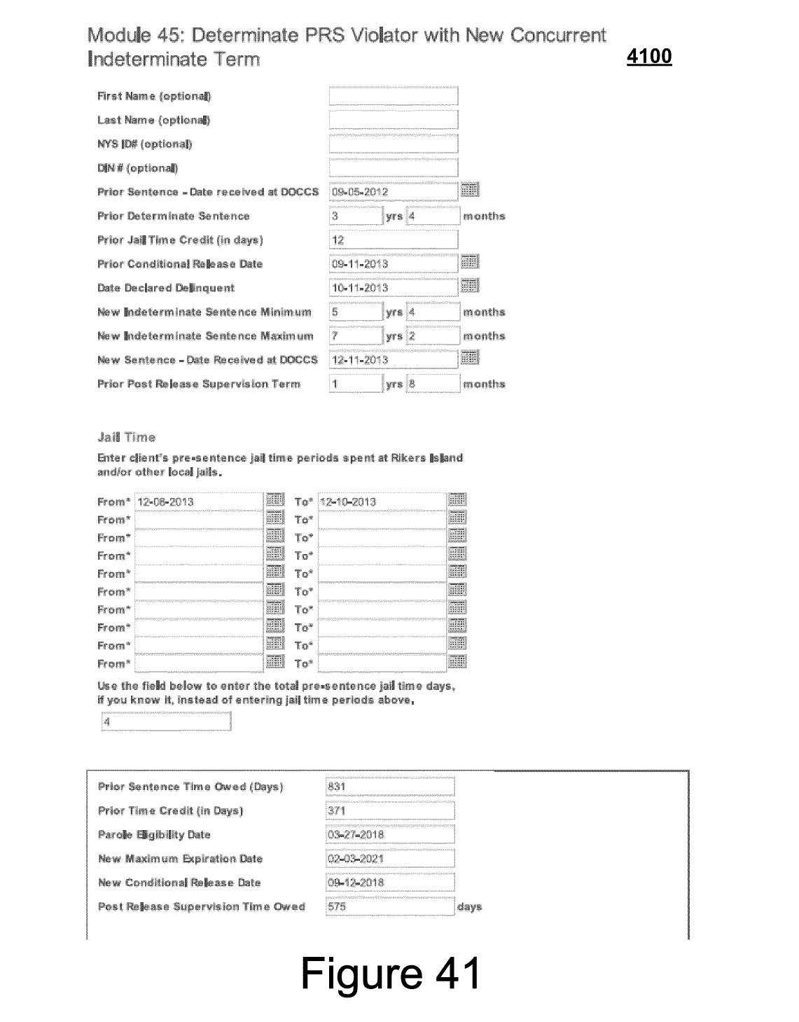

FIG. 41 illustrates a screenshot 4100 of a sentence calculator module 250 that may be utilized to calculate sentence output data for a prisoner who has committed a new crime while on post-release supervision from a prior determinate sentence and who receives a new indeterminate sentence that is concurrent to the prior determinate sentence.

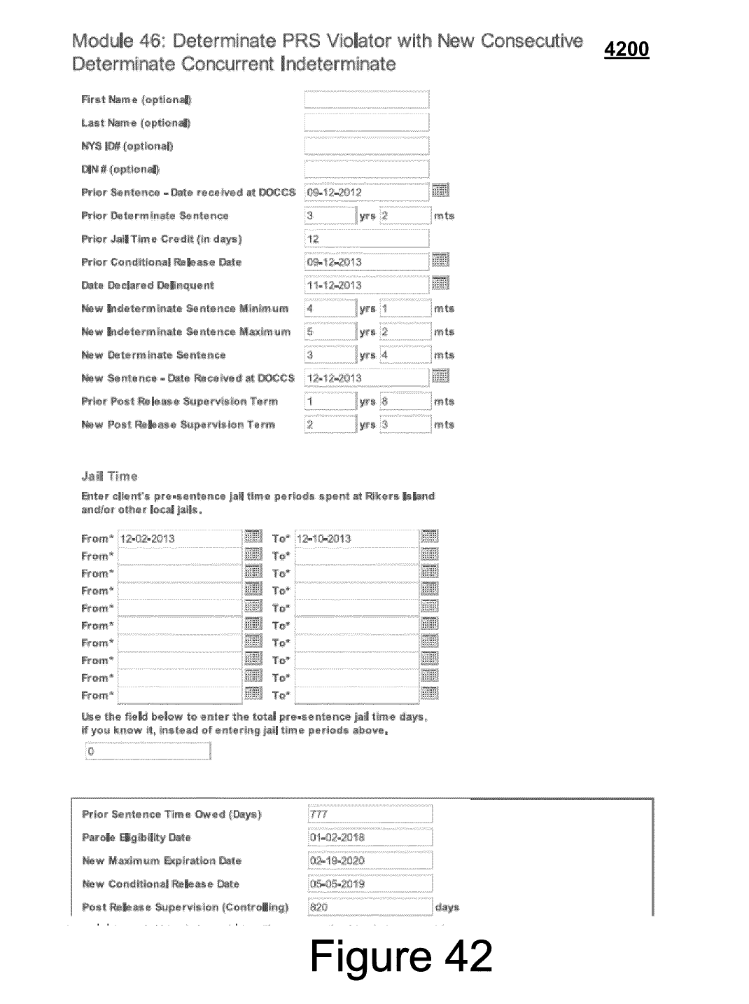

FIG. 42 illustrates a screenshot 4200 of a sentence calculator module 250 that may be utilized to calculate sentence output data for a prisoner who has committed a new crime while on post-release supervision from a prior determinate sentence and who receives a new determinate sentence and a new indeterminate sentence that are concurrent to each other, but consecutive to the prior determinate sentence.

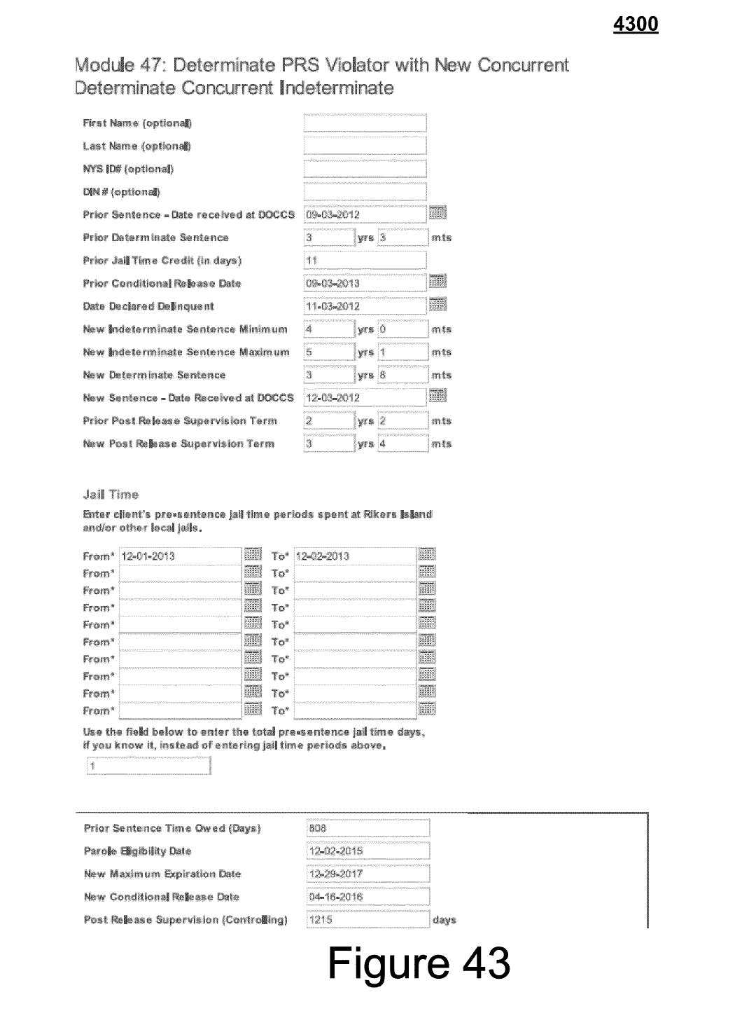

FIG. 43 illustrates a screenshot 4300 of a sentence calculator module 250 that may be utilized to calculate sentence output data for a prisoner who has committed a new crime while on post-release supervision from a prior determinate sentence and who receives a new determinate sentence and a new indeterminate sentence that are consecutive to each other and concurrent to the prior determinate sentence.

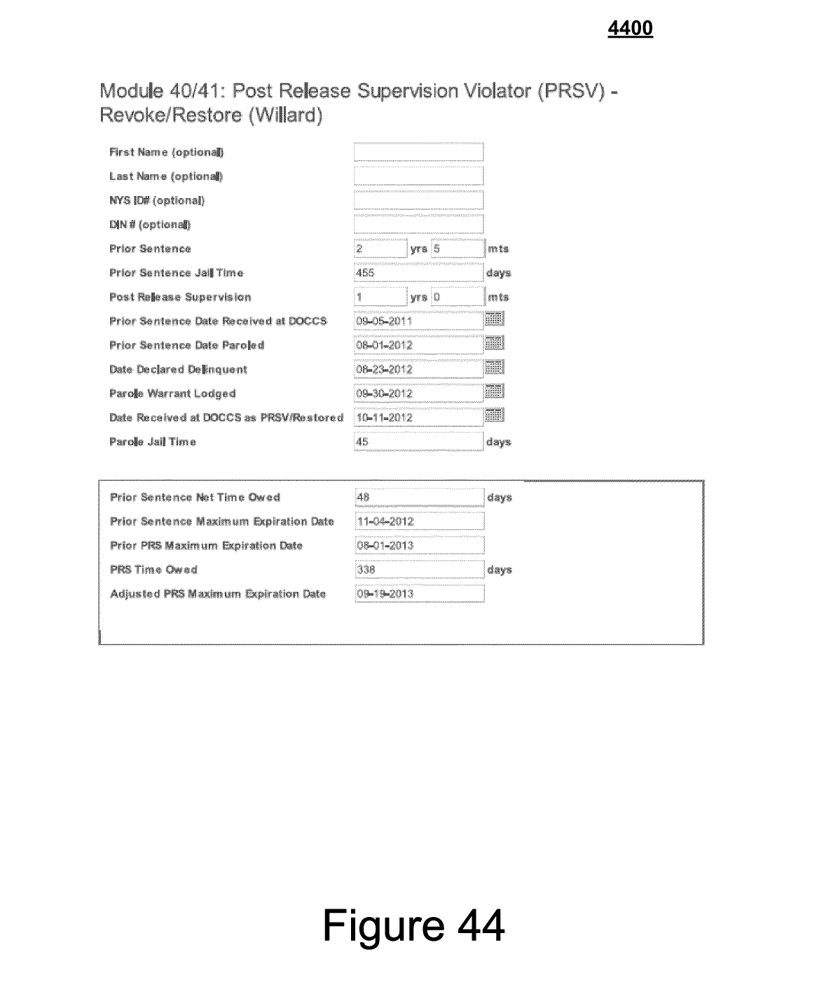

FIG. 44 illustrates a screenshot 4400 of a sentence calculator module 250 that may be utilized to calculate sentence output data for a prisoner deemed to be a post-release supervision violator who did not receive a new term, and who was revoked and restored to parole supervision, but the sentence time owed is greater than the period of post-release supervision.

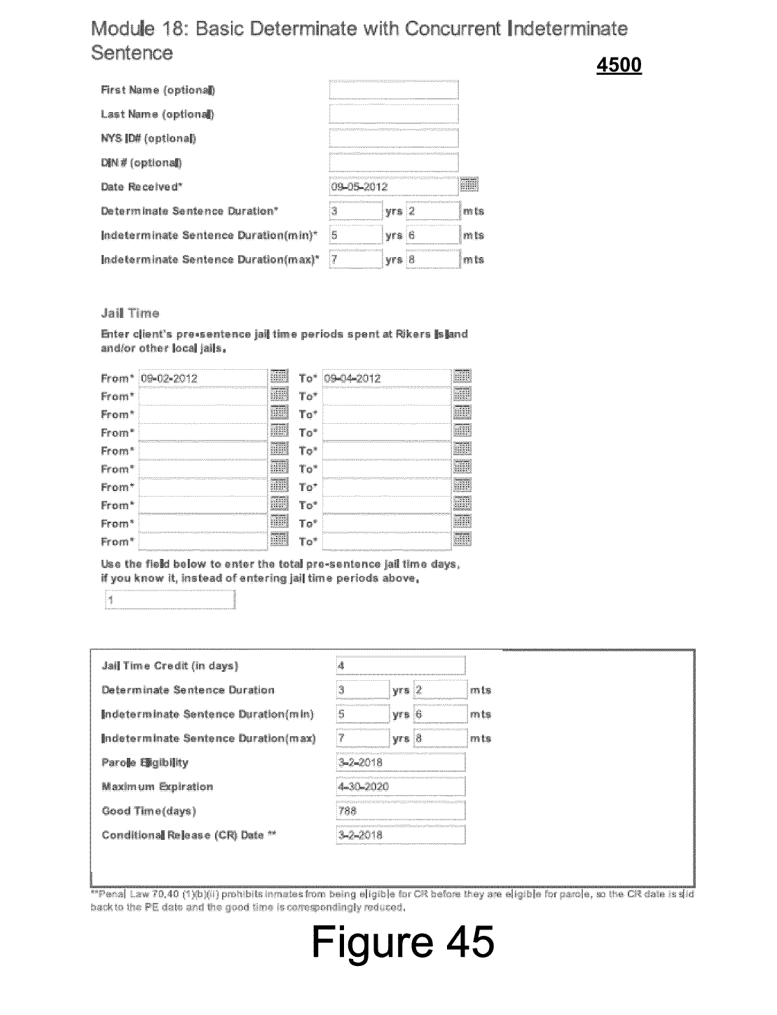

FIG. 45 illustrates a screenshot 4500 of a sentence calculator module 250 that may be utilized to calculate sentence output data for a prisoner who has received two or more concurrent sentences wherein at least one sentence is indeterminate and at least one sentence is determinate.

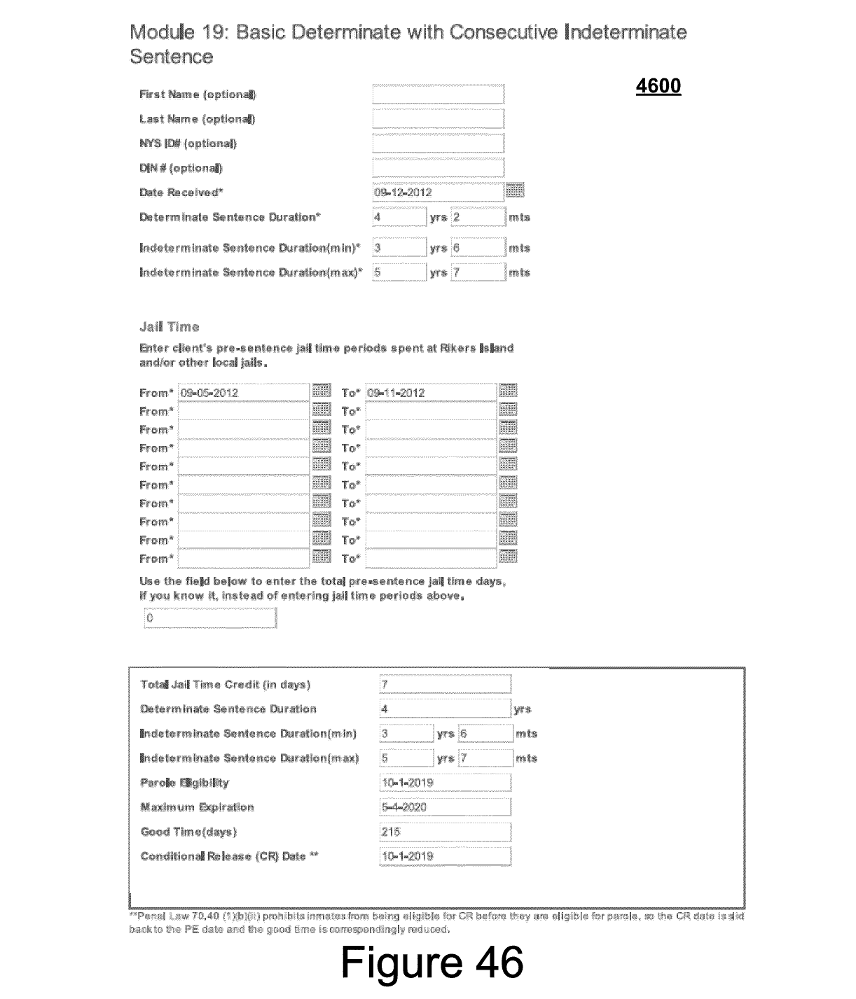

FIG. 46 illustrates a screenshot 4600 of a sentence calculator module 250 that may be utilized to calculate sentence output data for a prisoner who received two or more consecutive sentences wherein at least one sentence is indeterminate and at least one sentence is determinate.

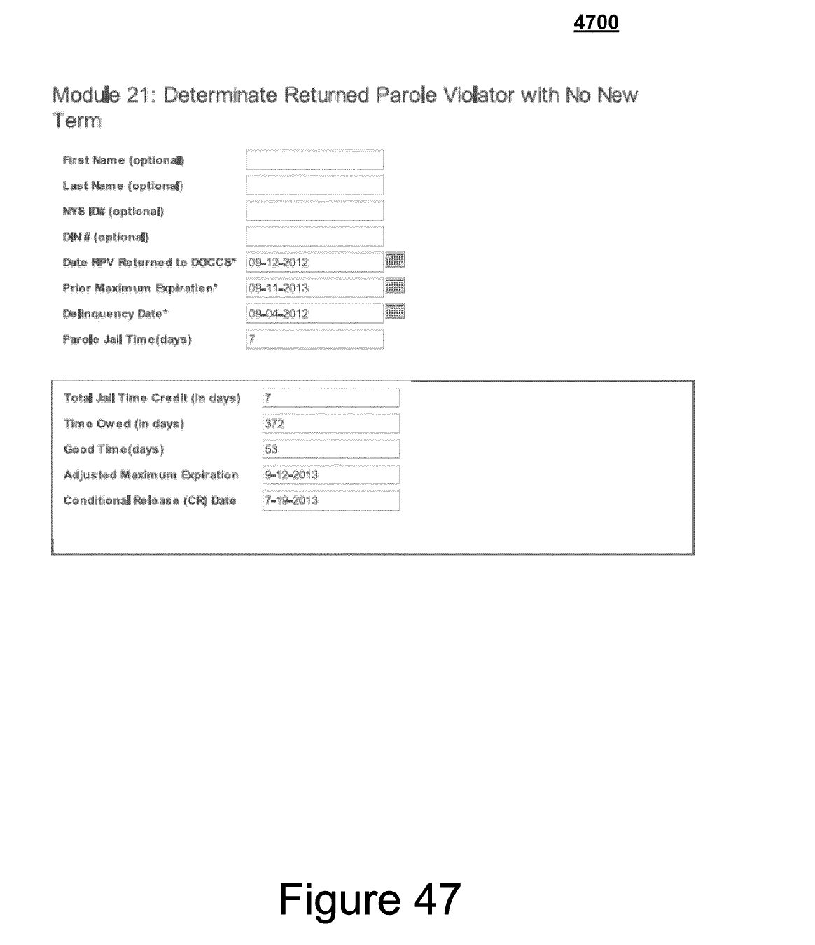

FIG. 47 illustrates a screenshot 4700 of a sentence calculator module 250 that may be utilized to calculate sentence output data for a prisoner who violates parole on a prior determinate sentence and does not receive a new sentence.

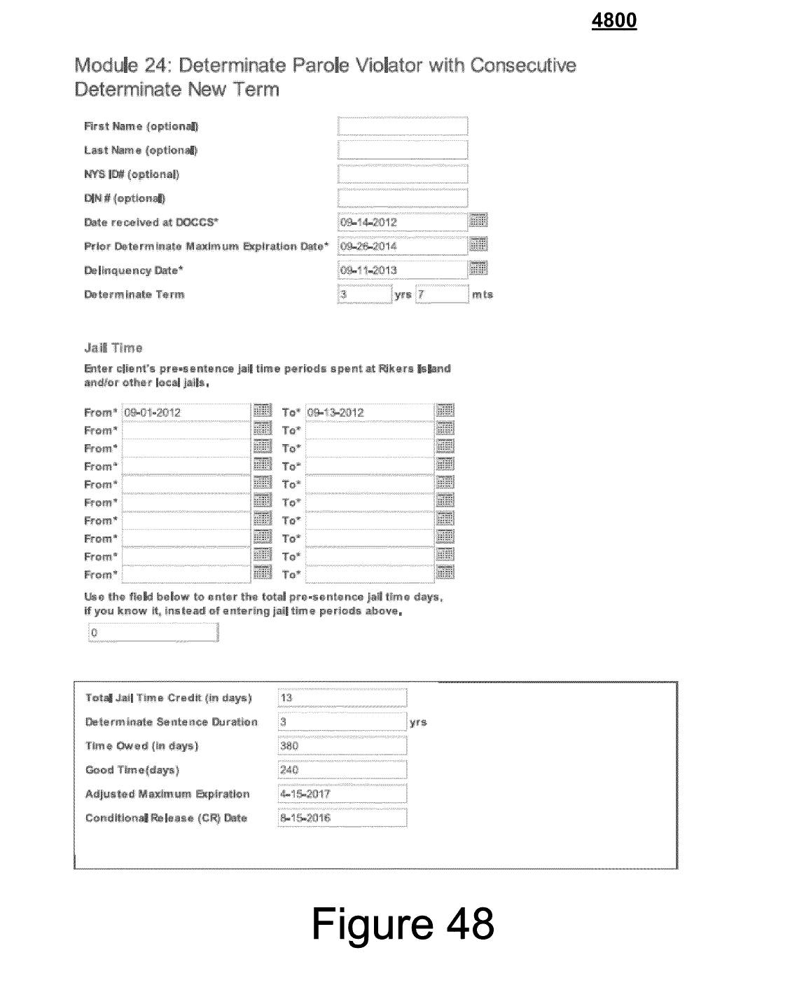

FIG. 48 illustrates a screenshot 4800 of a sentence calculator module 250 that may be utilized to calculate sentence output data for a prisoner who violates parole on a prior determinate sentence and receives a new consecutive determinate sentence.

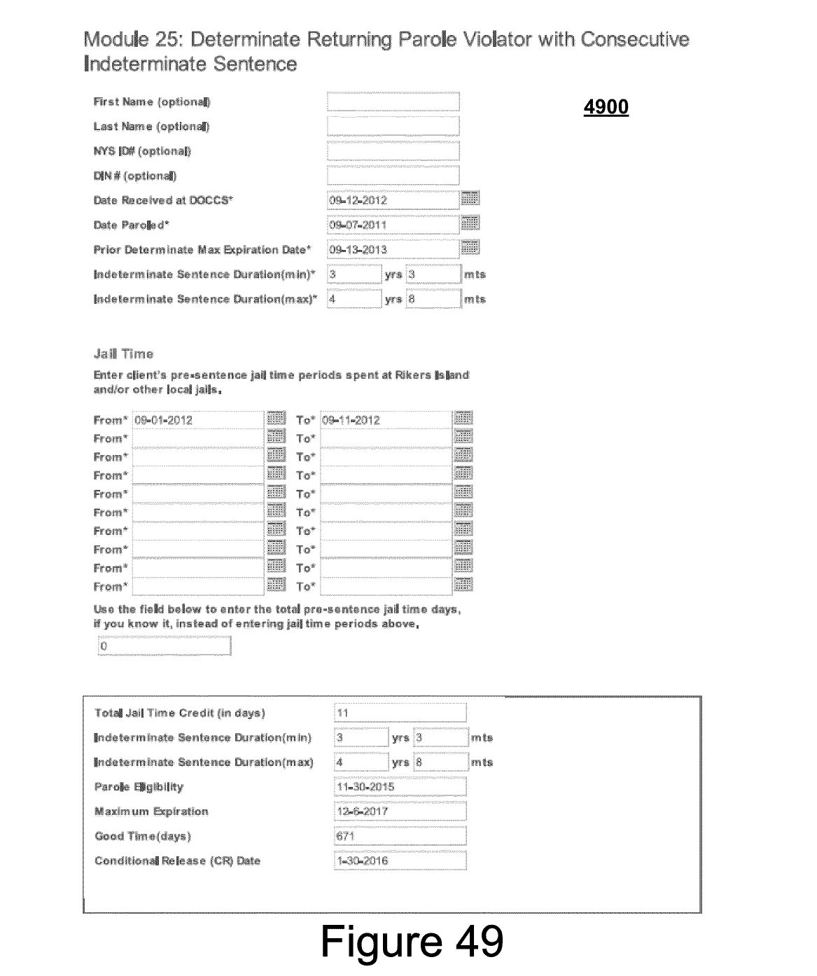

FIG. 49 illustrates a screenshot 4900 of a sentence calculator module 250 that may be utilized to calculate sentence output data for a prisoner who violates parole on a prior determinate sentence and receives a new consecutive indeterminate sentence.

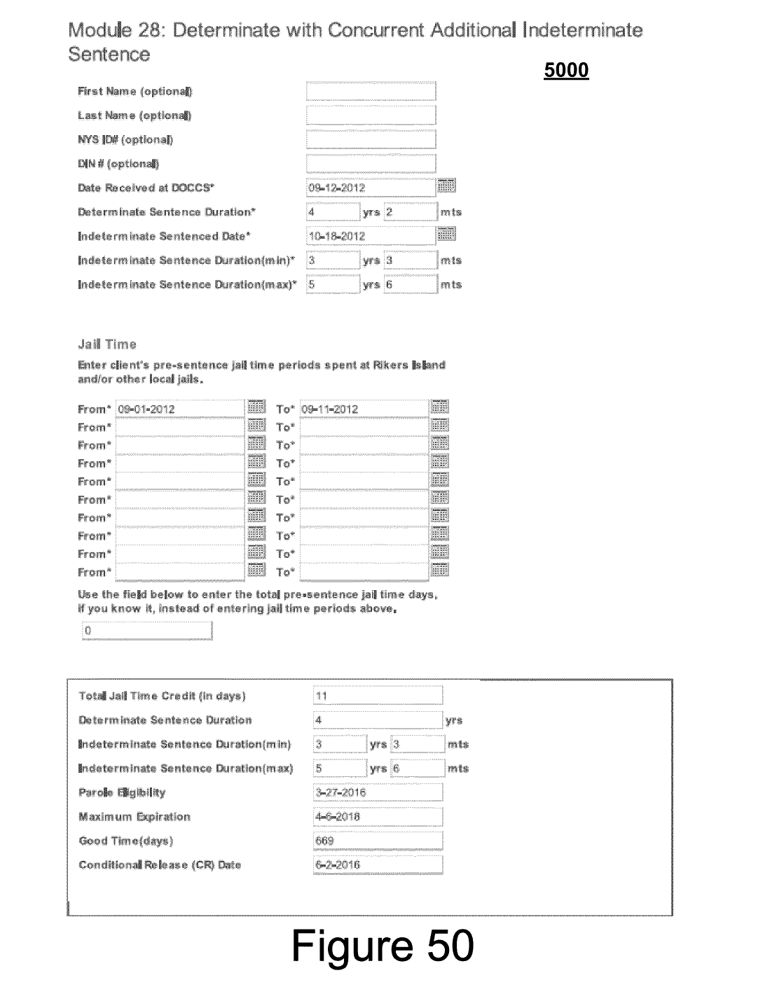

FIG. 50 illustrates a screenshot 5000 of a sentence calculator module 250 that may be utilized to calculate sentence output data for a prisoner who was first received at a correctional facility to serve a determinate sentence and subsequently receives a new concurrent indeterminate sentence.

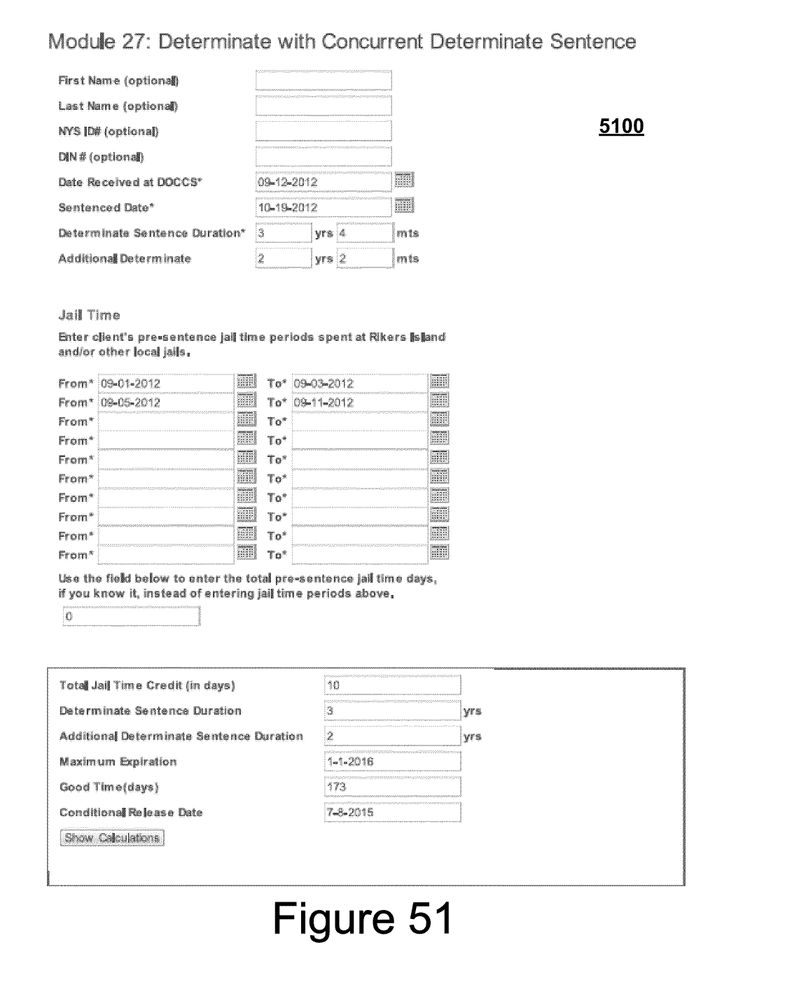

FIG. 51 illustrates a screenshot 5100 of a sentence calculator module 250 that may be utilized to calculate sentence output data for a prisoner who was first received at a correctional facility to serve a determinate sentence and subsequently receives a new concurrent determinate sentence.

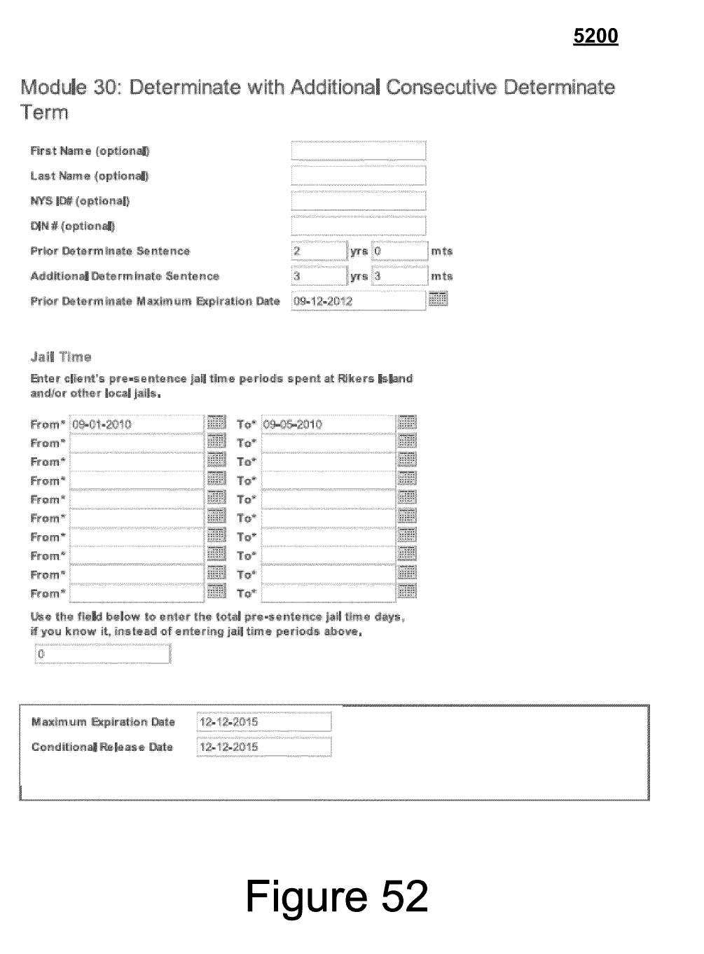

FIG. 52 illustrates a screenshot 5200 of a sentence calculator module 250 that may be utilized to calculate sentence output data for a prisoner who was first received at a correctional facility to serve a determinate sentence and subsequently receives a new consecutive determinate sentence.

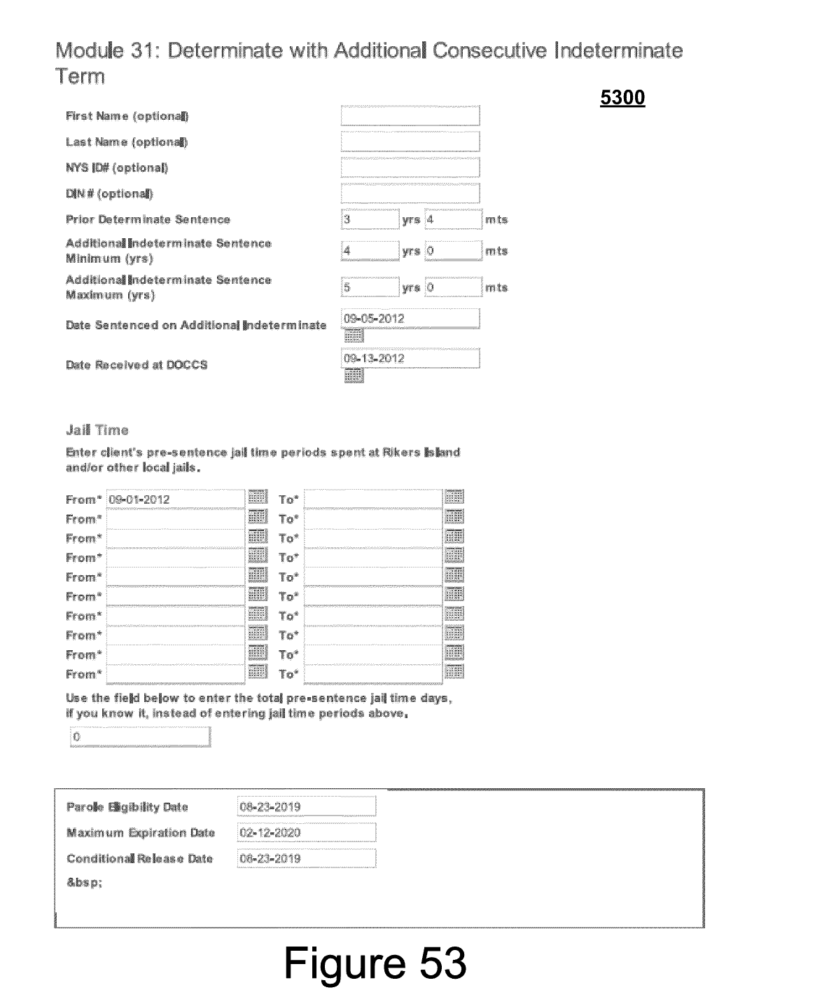

FIG. 53 illustrates a screenshot 5300 of a sentence calculator module 250 that may be utilized to calculate sentence output data for a prisoner who was first received at a correctional facility to serve a determinate sentence and subsequently receives a new consecutive indeterminate sentence.

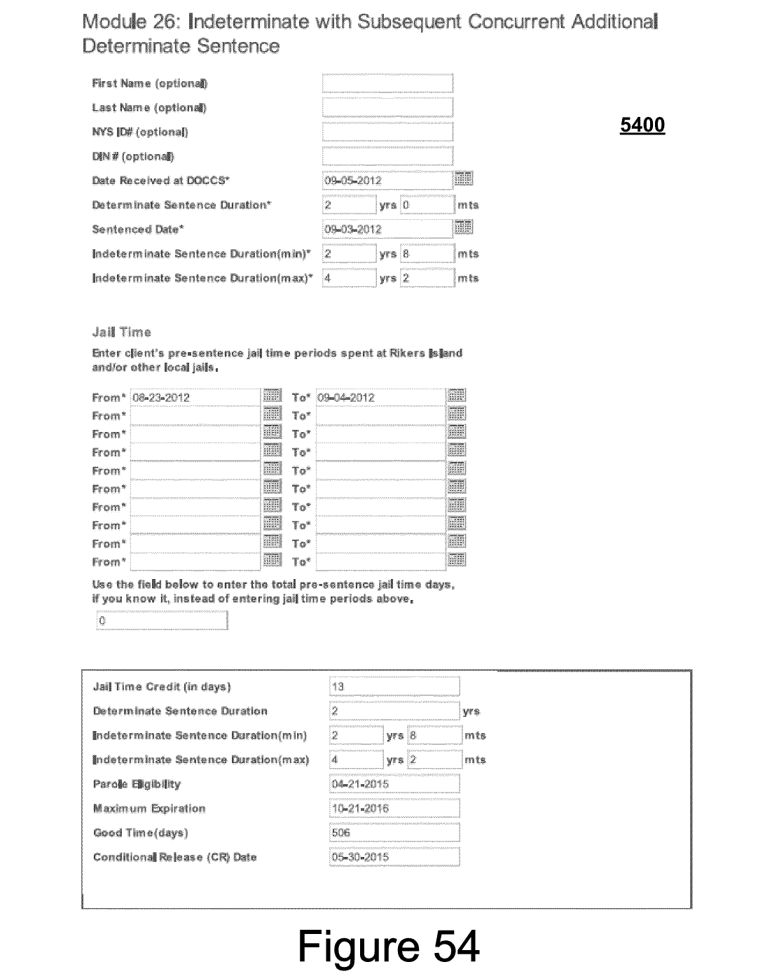

FIG. 54 illustrates a screenshot 5400 of a sentence calculator module 250 that may be utilized to calculate sentence output data for a prisoner who was first received at a correctional facility to serve an indeterminate sentence and subsequently receives a new concurrent determinate sentence.

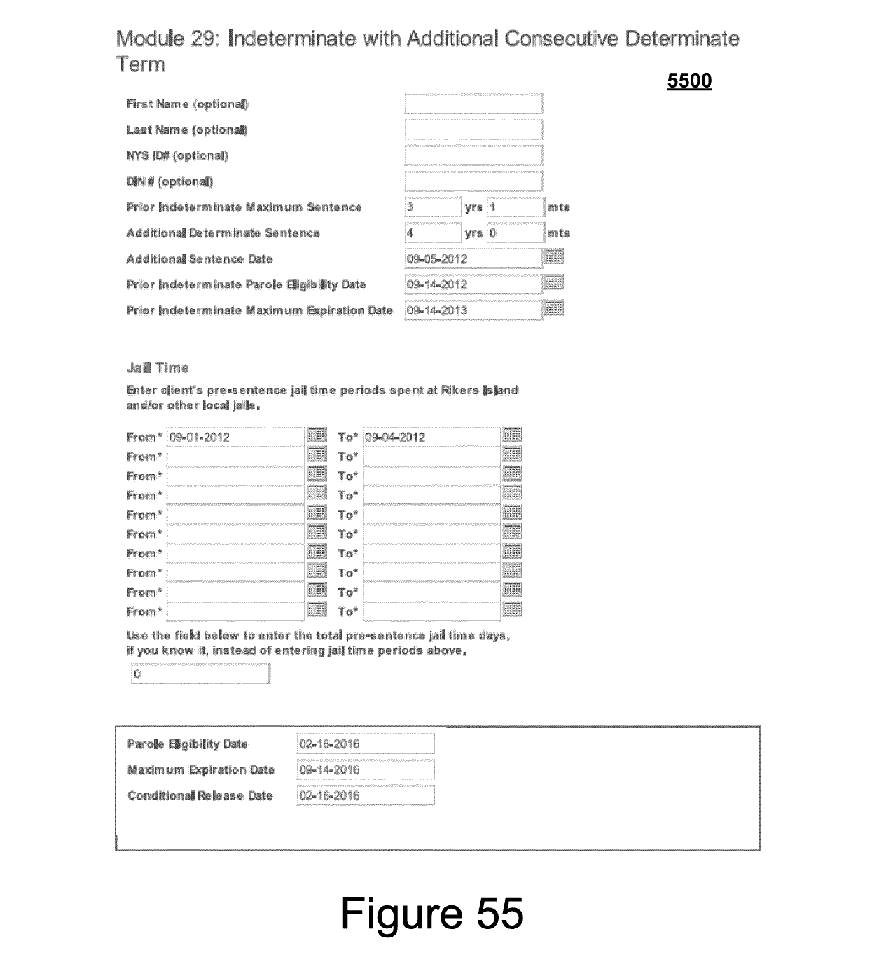

FIG. 55 illustrates a screenshot 5500 of a sentence calculator module 250 that may be utilized to calculate sentence output data for a prisoner who was first received at a correctional facility to serve an indeterminate sentence and subsequently receives a new consecutive determinate sentence.

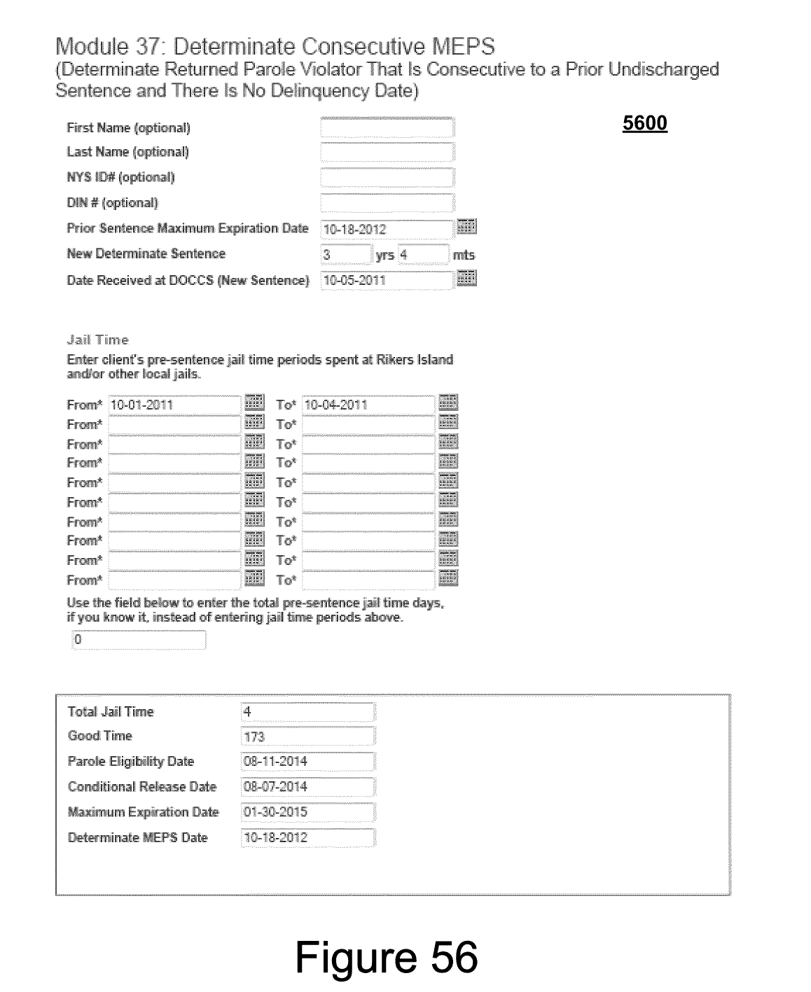

FIG. 56 illustrates a screenshot 5600 of a sentence calculator module 250 that may be utilized to calculate sentence output data for a prisoner who violates parole on a prior un-discharged sentence and receives a new consecutive determinate sentence (and there is no delinquency date).

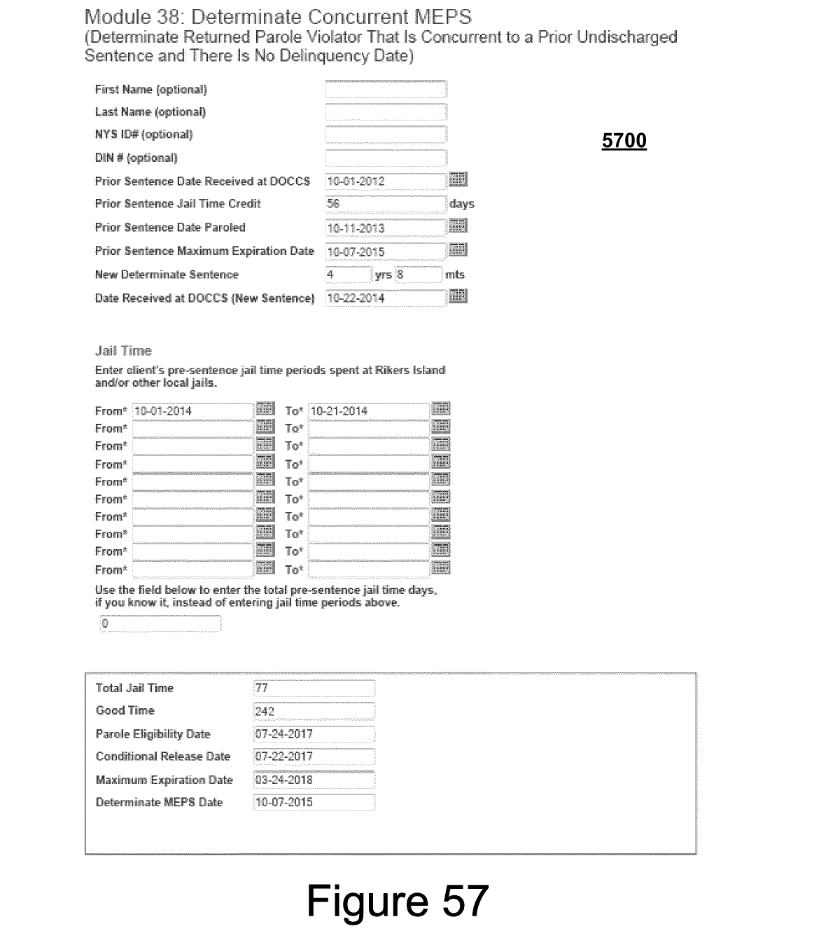

FIG. 57 illustrates a screenshot 5700 of a sentence calculator module 250 that may be utilized to calculate sentence output data for a prisoner who violates parole on a prior un-discharged sentence and receives a new concurrent determinate sentence (and there is no delinquency date).

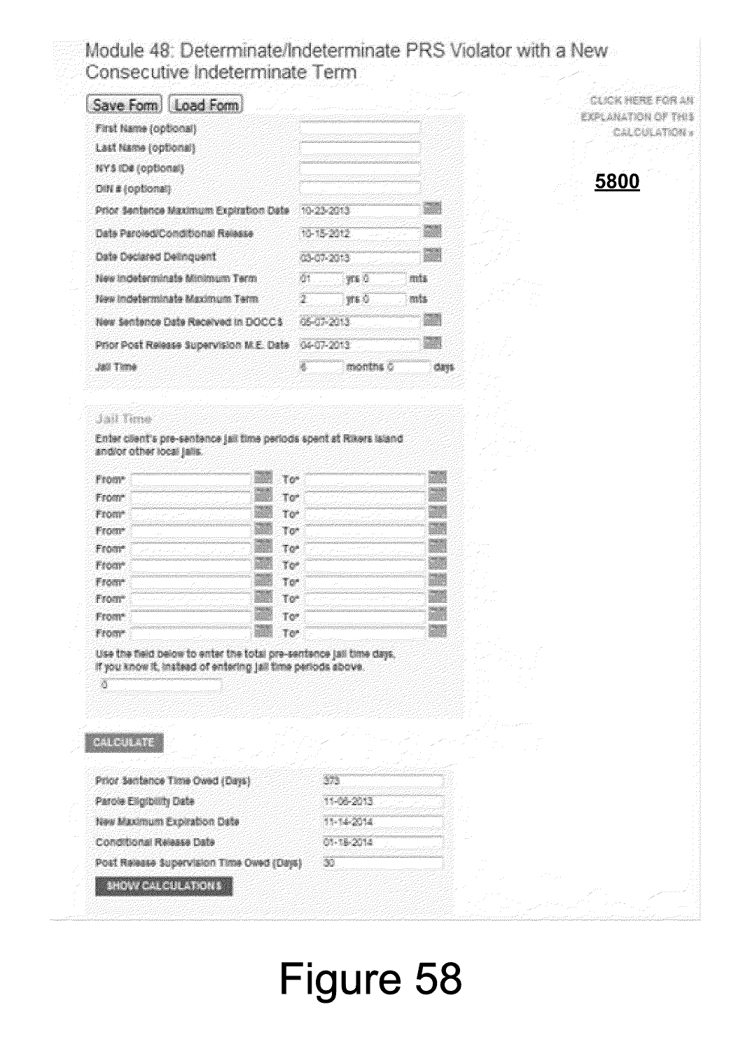

FIG. 58 illustrates a screenshot 5800 of a sentence calculator module 250 that may be utilized to calculate sentence output data for a prisoner who commits a new crime while on post release supervision from a prior determinate sentence that has a minimum period of time owed as a result of a minimum term from a previous indeterminate sentence, and the prisoner has received a new indeterminate sentence that is consecutive to the prior determinate sentence and the indeterminate minimum term that was carried forward.

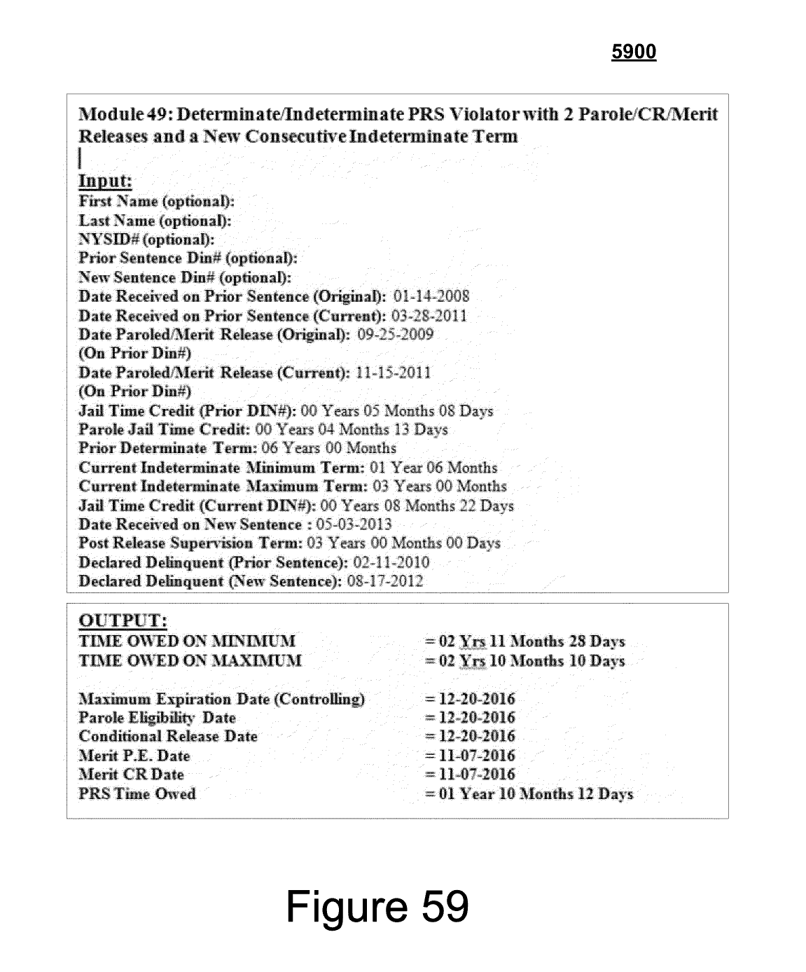

FIG. 59 illustrates a screenshot 5900 of a sentence calculator module 250 that may be utilized to calculate sentence output data for a post-release supervision violator that was originally assigned a determinate sentence, who was released twice based on parole, conditional release or merit, and who subsequently received a new consecutive indeterminate term.

It should be recognized that while the exemplary sentence calculators modules 250 shown in FIGS. 3-59 are tailored to the laws of the State of New York, similar sentence calculators 250 may be provided for any other jurisdiction in the United States or jurisdiction elsewhere in the world. It should also be noted that numerous variations can be made to the layout of a sentence calculator modules 250. For example, rather than providing a plurality of sentence calculators 155 and corresponding modules 250 that are tailored to specific sentencing scenarios as described above, the sentence calculation platform 150 may provide a single sentence calculator and module (or one for each jurisdiction) that includes an input portion and output portion that are able to account for any factors that may affect the calculation of the sentence output data. For example, the sentence calculator module 250 may include a single form that is able to collect all relevant input and a single sentence calculator 155 that is able to calculate sentence output data for any scenario. The sentence calculator 155 may calculate sentence output data for definite, determinate and indeterminate sentences and may account for any sentencing factors (e.g., parole, consecutive/concurrent sentences, etc.) which may affect the computation of the sentence output data. Other types of variations and alterations can also be implemented.

### III. Sentence Calculator Selection and Navigation

Based on the above discussion, it should be apparent that the sentence calculation platform 150 may provide a relatively large number of separate sentence calculators 155 and corresponding modules 250 in certain embodiments. Given the number of sentence calculators 155 that may be provided, the identification of an appropriate sentence calculator or corresponding module for computing the sentence output data may be complicated. In fact, the task of identifying an appropriate sentence calculator 155 can be difficult and time-consuming. In the case that a user 110 is an employee at a correctional facility or courthouse who is required to compute the sentence output data for a large number of prisoners, these difficulties and time constraints may have a significant impact on the user's 110 efficiency.

To address the above concerns and ensure that a proper sentence calculator 155 is able to be identified by a user 110 in an expedited manner, the sentence calculation platform 150 may be configured to provide the user 110 with user-friendly interfaces that permit the user to easily identify or navigate to an appropriate sentence calculator 155. The manner in which this is accomplished may vary.

In the case that a plurality of separate calculators 155 are provided by the sentence calculation platform 150, the interfaces displayed to the users 110 may include a hierarchy of navigable menus that assist users in identifying an appropriate calculator. Each menu option provided by the navigable menus may represent a hyperlink or other selectable interface element that directs users 110 to a subset of sentence calculator modules (or, in some cases, directly to the proper sentence calculator module 250), one of which is guaranteed to correspond to the desired sentence calculator 155 being sought by the user 110. In certain embodiments, by classifying the sentence calculators 250 into logical subsets, a user 110 can quickly identify an appropriate sentence calculator or module 250 by selecting less than three or four menu options.

After selecting an appropriate jurisdiction (e.g., New York) associated with a prisoner's incarceration, a user 110 may be presented with a first tier of calculator selection categories. For example, in the case that the selected jurisdiction is New York, the user 110 may be presented with the following categories and menu options:
1) New York Local Sentence Calculators: category of sentence calculators that may be used to compute local sentences (e.g., local city sentences) and/or definite sentences (e.g., which tend to be less than one year).
2) New York State Sentence Calculators: category of sentence calculators that may be used to compute a full range of indeterminate and determinate sentences associated with the various sections of Article 70 of the New York State Penal Law.
3) Rockefeller Drug Laws Calculator: menu option that directs a user to a sentence calculator that may be used to compute re-sentencing eligibility under statutes dealing with the sale and possession of narcotic drugs within the New York State Penal Law.
4) 10 Year Felony Calculator: category of sentence calculators that may be used to determine whether a prisoner can be sentenced as a predicate, persistent, or mandatory felony offender and/or whether a person is entitled to judicial diversion program (e.g., a judicial diversion program associated with substance abuse or dependence, alcohol abuse or dependence, and/or mental disorder or mental illness).

As can be seen, the first tier of calculator selection categories may include broad categories that encompass a plurality of sentence calculator modules 250 (e.g., local sentence calculators and state sentence calculators), as well as menu options that direct a user to sentence calculator modules 250 for specific types of laws or offenses (e.g., Rockefeller Drug Laws or 10 Year Felony Laws).

A second tier of calculator selection categories may serve to further subdivide and group related calculators into smaller subsets, thus allowing the user to navigate to the correct module 250 for the prison sentence at issue. For example, the following categories and menu options may be available for a second tier of calculator selection categories falling under the “New York State Sentences” category:
1) Indeterminate Sentences: Upon selecting this category, the user may be presented with an additional sub-menu for selecting a further subset of sentence calculator modules. This further subset of sentence calculator modules may be grouped as follows (see below): Basic Indeterminate, Returned Parole Violators, Returned Absconder Escapee AWOL, Out of State Sentences, and Other Indeterminate Sentences.
2) Determinate Sentences: Upon selecting this category, the user may be presented with an additional sub-menu for selecting a further subset of sentence calculator modules. This further subset of modules may be grouped as follows (see below): Basic Determinate, Returned Absconder Escapee AWOL, Post-release Supervision Violators, and Mixed Sentence Including Return Parole Violations.

A third tier of calculator selection categories further subdivide and group the sentences calculators 250 into smaller subsets, thus allowing the user to find and navigate to the correct sentence calculator module 250 for the sentence at issue. For example, the following menu sub-categories and menu options may be made available upon selecting the “Indeterminate Sentences” category in the second tier of calculator selection categories:
i. Basic Indeterminate: Upon selecting this menu option, the user may be presented with a sentence calculator module for calculating a typical indeterminate sentence (e.g., which does not need to account for parole violations, out-of-state sentences or other complicating factors).
ii. Returned Parole Violators: Upon selecting this category, the user may be presented with the following menu options which may be selected by the user for displaying a corresponding sentence calculator module:
   a. Indeterminate Returned Parole Violator with Consecutive Determinate and Consecutive Indeterminate New Terms (New Terms are Consecutive to each other)
   b. Indeterminate returned Parole Violator with Consecutive Determinate New Term
   c. Indeterminate Returned Parole Violator with Concurrent Determinate New Term
   d. Indeterminate Returned Parole Violator with Consecutive Determinate and Consecutive Indeterminate New Term (New Terms are Concurrent to each other)
   e. Returned Parole Violator/Conditional Release Violators with No New Term
   f. Returned Parole Violator/Conditional Release Violators with Concurrent New Terms
   g. Returned Parole Violator/Conditional Release Violators with Consecutive New Terms
   h. Re-Sentence (Indeterminate)
   i. Re-Affirmation (Indeterminate)
   j. Additional Concurrent
   k. Additional Consecutive Indeterminate—Uninterrupted (Basic)
iii. Returned Absconder Escapee AWOL: Upon selecting this category, the user may be presented with the following menu options which may be selected by the user for displaying a corresponding sentence calculator module:
   a. Returned Absconder/AWOL with No New Term
   b. Returned Escapee with No New Term
   c. Returned Absconder/AWOL with Consecutive New Term
   d. Returned Escapee with Consecutive New Term
   e. Indeterminate Returned Absconder/AWOL/Escapee with a Consecutive Determinate New Term
   f. Indeterminate Returned Absconder/AWOL/Escapee with a Consecutive Determinate and Indeterminate New Term
iv. Out of State Sentences: Upon selecting this category, the user may be presented with the following menu options which may be selected by the user for displaying a corresponding sentence calculator module:
   a. Out of State Concurrent Term
   b. Out of State Consecutive Term (Basic)
v. Other Indeterminate Sentences: Upon selecting this category, the user may be presented with the following menu options which may be selected by the user for displaying a corresponding sentence calculator module:
   a. Additional Consecutive Interrupted Term
   b. CS MEPS
   c. CC MEPS

Likewise, the following menu sub-categories and menu options may be made available upon selecting the “Determinate Sentences” menu option in the second tier of calculator selection categories:
i. Basic Determinate: Upon selecting this menu option, the user may be presented with a sentence calculator module for calculating a typical determinate sentence (e.g., which does not need to account for escapees, post-release supervision violators or other complicating factors).
ii. Returned Absconder/Escapee/AWOL: Upon selecting this category, the user may be presented with the following menu options which may be selected by the user for displaying a corresponding sentence calculator module:
   a. Determinate Absconder/AWOL/Escapee
   b. No New Term
   c. Determinate Returned Absconder/AWOL/Escapee with a Consecutive Indeterminate New Term
   d. Determinate Returned Absconder/AWOL/Escapee with a Consecutive Determinate New Term
iii. Post-release Supervision Violators: Upon selecting the Out of State Sentences category, the user may be presented with the following menu options which may be selected by the user for displaying a corresponding sentence calculator module:
   a. Determinate PRS Violator With New Consecutive Determinate Term
   b. Determinate PRS Violator With New Consecutive Indeterminate Term
   c. Determinate PRS Violator With New Concurrent Determinate Term
   d. Determinate PRS Violator With New Concurrent Indeterminate Term
   e. Determinate PRS Violator With New Consecutive Determinate Concurrent Indeterminate
   f. Determinate PRS Violator With New Concurrent Determinate Concurrent Indeterminate
   g. Post-Release Supervision Violator (PRSV)—Revoke/Restore (Willard)
iv. Mixed Sentence Including Return Parole Violations: Upon selecting the Out of State Sentences category, the user may be presented with the following menu options which may be selected by the user for displaying a corresponding sentence calculator module:
   a. Basic Determinate with Concurrent Indeterminate Sentence
   b. Basic Determinate with Consecutive Indeterminate Sentence
   c. Determinate Returned Parole Violator with No New Term
   d. Determinate Returned Parole Violator with Consecutive Determinate New Term
   e. Determinate Returned Parole Violator with Consecutive Indeterminate New Term
   f. Determinate with Concurrent Additional Indeterminate Sentence
   g. Determinate with Concurrent Additional Determinate Sentence
   h. Determinate with Additional Consecutive Determinate Term
   i. Determinate with Additional Consecutive Indeterminate Term
   j. Indeterminate with Concurrent Additional Determinate Sentence
   k. Indeterminate with Additional Consecutive Determinate Term
   l. Determinate Consecutive MEPS
   m. Determinate Concurrent MEPS

The above hierarchy of calculator selection categories and menu options is merely an exemplary organizational scheme that demonstrates how a plurality of sentence calculator modules 250 may be organized in accordance with the penal laws of the State of New York. Depending on the laws of the selected jurisdiction (or upon the number of calculators which are provided), categories and menu options may be added to or removed from the organizational hierarchy. In certain embodiments, the lowest level of the hierarchy may include the sentence calculator modules themselves (or hyperlinks to the sentence calculators) for computing the sentence output data according to the laws of the chosen jurisdiction.

It should be recognized that the sentence calculation platform 150 may utilize alternative schemes for organizing or presenting the sentence calculator modules to a user 110. For example, rather than organizing the sentence calculator modules into a hierarchy of categories and sub-categories, links to all of the sentence calculator modules may be presented on an interface in a single list (e.g., which may be divided into categories by appropriate headings and sub-headings). Alternatively, as explained above, a single sentence calculator module 250 may be provided for a jurisdiction that includes an input portion and an output portion that are able to account for any sentencing factor that may affect the calculation of sentence output data.

In certain embodiments, the sentence calculation platform 150 may include an “interactive wizard” that assists users 100 in identifying an appropriate sentence calculator module by asking the users 110 one or more questions and requesting feedback from the user 110. The interactive wizard may be configured to analyze the input or feedback received from a user 110 in order to guide the user 110 to the appropriate sentence calculator module 250 and corresponding sentence calculator 155. The wizard may present the user with the same sequence of questions each time the wizard is accessed by the user 110 or, alternatively, may tailor the questions presented to the user 110 based upon previous feedback provided by the user 110 to earlier questions. Tailoring the questions may allow the wizard to select an appropriate sentence calculator with fewer questions posed to the user by quickly narrowing down the set of applicable calculators and avoiding inapplicable questions. Users 110 may answer questions posed during the interactive wizard by clicking a button, typing an appropriate response, performing a gesture on touch screen interface which is recognized by the application or another software layer (e.g., OS or gesture library) or by providing other means of input.

Background calculations may be performed by the interactive wizard. For example, a background calculation may be performed to determine whether or not the prisoner is eligible to be sentenced as a predicate offender or otherwise eligible for judicial diversion based upon feedback provided by the user 110 to the interactive wizard. The results of the background calculations may be presented to the user 110 via messages (e.g., pop-up windows or overlay elements on an interface), in a sentence calculator module window, at the input screen to a sentence calculator and/or by other means of output. If a module is not implemented for a particular sentencing situation as determined by the interactive session, the user 110 may be notified via a message and referred to additional resources (e.g., applicable statutes or web pages with relevant information).

Below is a list of exemplary questions that may be asked by an interactive wizard in order to identify an appropriate sentence calculator module:
Are there multiple sentences?
   If so:
   Are the sentences consecutive/concurrent?
   Are the sentences definite/determinate/indeterminate/mixed?
If not:
   Is the sentence definite/determinate/indeterminate?

Has the subject been previously incarcerated?

Is the subject a returned parole violator?

Is the subject a returned absconder/escapee/AWOL?

Is an out-of-state sentence involved?

Numerous other questions may be asked by the interactive wizard. By analyzing the feedback provided by the user 110, the interactive wizard is able to quickly narrow the subset of applicable sentence calculators 155 and display the appropriate sentence calculator module 250 to the user 110 without requiring the user 100 to navigate through a hierarchy of navigable menus.

### IV. Exemplary Sentence Calculators

As explained above, each sentence calculator 155 may be associated with a sentence calculator module 250 and may include a particular algorithm and set of instructions that are tailored to a particular sentencing scenario. The inputs received via the sentence calculator modules 250 may be utilized by the algorithms and instructions to compute sentence output data for the sentencing scenarios. The description provided below demonstrates applicable statutes and procedures that may provide a basis for calculations that are performed by the sentence calculators 155 underlying the exemplary modules illustrated in FIGS. 3-59. While the description below may be applicable to the legal framework for the State of New York, it should be recognized that similar principles may be utilized for sentence calculators 155 that are tailored to legal frameworks for other jurisdictions.

### 1 Definite Sentence—Simple Sentence:

### PL70.30(3)

In any case where a person has been in custody due to a charge that culminated in a dismissal or acquittal, the amount of time that would have been credited against a sentence for such charge, had one been imposed, shall be credited against any sentence that is based on a charge for which a warrant or commitment was lodged during the pendency of such custody.

Note:

If your client was incarcerated at any time during the pendency of both cases, enter the Jail Time from the date when s/he was arrested on the dismissed case until his/her incarceration on the sentenced case.

### 2. Definite Sentence—Dismissed Sentence:

PL70.30(3) In any case where a person has been in custody due to a charge that culminated in a dismissal or acquittal, the amount of time that would have been credited against a sentence for such charge, had one been imposed, shall be credited against any sentence that is based on a charge for which a warrant or commitment was lodged during the pendency of such custody.

Note:

If your client was incarcerated at any time during the pendency of both cases, enter the Jail Time from the date when s/he was arrested on the dismissed case until his/her incarceration on the sentenced case.

### 3. Definite Sentence—Consecutive Sentences:

§70.25 Concurrent and consecutive terms of imprisonment.

1. Except as provided in subdivisions two, two-a and five of this section, when multiple sentences of imprisonment are imposed on a person at the same time, or when a person who is subject to any undischarged term of imprisonment imposed at a previous time by a court of this state is sentenced to an additional term of imprisonment, the sentence or sentences imposed by the court shall run either concurrently or consecutively with respect to each other and the undischarged term or terms in such manner as the court directs at the time of sentence. If the court does not specify the manner in which a sentence imposed by it is to run, the sentence shall run as follows:

(b) A definite sentence shall run concurrently with any sentence imposed at the same time and shall be consecutive to any other term.

### §70.30 Calculation of Terms of Imprisonment

3. Jail time. The term of a definite sentence or the maximum term of an indeterminate sentence imposed on a person shall be credited with and diminished by the amount of time the person spent in custody prior to the commencement of such sentence as a result of the charge that culminated in the sentence. In the case of an indeterminate sentence, if the minimum period of imprisonment has been fixed by the court or by the board of parole, the credit shall also be applied against the minimum period. The credit herein provided shall be calculated from the date custody under the charge commenced to the date the sentence commences and shall not include any time that is credited against the term or maximum term of any previously imposed sentence or period of post-release supervision to which the person is subject. Where the charge or charges culminate in more than one sentence, the credit shall be applied as follows:

(a) If the sentences run concurrently, the credit shall be applied against each such sentence;

(b) If the sentences run consecutively, the credit shall be applied against the aggregate term or aggregate maximum term of the sentences and against the aggregate minimum period of imprisonment.

In any case where a person has been in custody due to a charge that culminated in a dismissal or an acquittal, the amount of time that would have been credited against a sentence for such charge, had one been imposed, shall be credited against any sentence that is based on a charge for which a warrant or commitment was lodged during the pendency of such custody.
NB Effective Sep. 1, 2011
4. Good behavior time. Time allowances earned for good behavior, pursuant to the provisions of the correction law, shall be computed and applied as follows:

(b) In the case of a person serving a definite sentence, the total of such allowances shall not exceed one-third of his term or aggregate term and the allowances shall be applied as a credit against such term.

### 4. Definite Sentence—Concurrent Sentences:

§70.25 Concurrent and consecutive terms of imprisonment.

1. Except as provided in subdivisions two, two-a and five of this section, when multiple sentences of imprisonment are imposed on a person at the same time, or when a person who is subject to any undischarged term of imprisonment imposed at a previous time by a court of this state is sentenced to an additional term of imprisonment, the sentence or sentences imposed by the court shall run either concurrently or consecutively with respect to each other and the undischarged term or terms in such manner as the court directs at the time of sentence. If the court does not specify the manner in which a sentence imposed by it is to run, the sentence shall run as follows:

(b) A definite sentence shall run concurrently with any sentence imposed at the same time and shall be consecutive to any other term.

§70.30 Calculation of terms of imprisonment

3. Jail time. The term of a definite sentence or the maximum term of an indeterminate sentence imposed on a person shall be credited with and diminished by the amount of time the person spent in custody prior to the commencement of such sentence as a result of the charge that culminated in the sentence. In the case of an indeterminate sentence, if the minimum period of imprisonment has been fixed by the court or by the board of parole, the credit shall also be applied against the minimum period. The credit herein provided shall be calculated from the date custody under the charge commenced to the date the sentence commences and shall not include any time that is credited against the term or maximum term of any previously imposed sentence or period of post-release supervision to which the person is subject. Where the charge or charges culminate in more than one sentence, the credit shall be applied as follows:

(a) If the sentences run concurrently, the credit shall be applied against each such sentence;

(b) If the sentences run consecutively, the credit shall be applied against the aggregate term or aggregate maximum term of the sentences and against the aggregate minimum period of imprisonment.

In any case where a person has been in custody due to a charge that culminated in a dismissal or an acquittal, the amount of time that would have been credited against a sentence for such charge, had one been imposed, shall be credited against any sentence that is based on a charge for which a warrant or commitment was lodged during the pendency of such custody.
NB Effective Sep. 1, 2011
4. Good behavior time. Time allowances earned for good behavior, pursuant to the provisions of the correction law, shall be computed and applied as follows:

(b) In the case of a person serving a definite sentence, the total of such allowances shall not exceed one-third of his term or aggregate term and the allowances shall be applied as a credit against such term.
NB Effective until Sep. 1, 2011
4. Good behavior time. Time allowances earned for good behavior, pursuant to the provisions of the correction law, shall be computed and applied as follows:

(b) In the case of a person serving a definite sentence, the total of such allowances shall not exceed one-third of his term or aggregate term and the allowances shall be applied as a credit against such term.
NB Effective Sep. 1, 2011

5. Time served under vacated sentence. When a sentence of imprisonment that has been imposed on a person is vacated and a new sentence is imposed on such person for the same offense, or for an offense based upon the same act, the new sentence shall be calculated as if it had commenced at the time the vacated sentence commenced, and all time credited against the vacated sentence shall be credited against the new sentence. In any case where a vacated sentence also includes a period of post-release supervision, all time credited against the period of post-release supervision shall be credited against the period of post-release supervision included with the new sentence. In the event a period of post-release supervision is not included with the new sentence, such period shall be credited against the new sentence.

If the first sentence expires before the second sentence commences the 2 sentences cannot run concurrently. The second sentence has to be calculated from the date it was imposed and credited only with the jail time spent on that sentence. The first sentence and corresponding jail time is a previously imposed sentence and the time credited to that sentence cannot be credited to the second sentence.

### 5. Multiple Definite Sentences/Mix Concurrent and Consecutive Sentences:

PL 70.30 (2) A definite sentence of imprisonment commences when the prisoner is received in the institution named in the Commitment. Where a person is under more than one definite sentence, the sentences shall be calculated as follows: (a) If the sentences run concurrently and are to be served in a single institution, the terms merge in and are satisfied by discharge of the term which has the longest unexpired time to run; (b) If the sentences run consecutively and are to be served in a single institution, the terms are added to arrive at an aggregate term and are satisfied by discharge of such aggregate term, or by service of two years imprisonment plus any term imposed for an offense committed while the person is under the sentences, whichever is less; (c) If the sentences run concurrently and are to be served in more than one institution, the term of each such sentence shall be credited with the portion of any concurrent term served after that sentence was imposed; (d) If the sentences run consecutively and are to be served in more than one institution, the aggregate of the time served in all of the institutions shall not exceed two years plus any term imposed for an offense committed while the person is under the sentences.

### 6. Rockefeller Drug Laws Calculator:

Rockefeller Drug Laws Calculator computes Re-Sentencing Eligibility under statutes dealing with the sale and possession of narcotic drugs within the New York State Penal Law.

Rockefeller Drug Law Reform Resentencing Eligibility (2009): Calculating The 10 Year Look Back

Class B Drug Offense Resentence—CPL §440.46

Determining the 10 Year Look Back Period

Step 1: Calculate the period of time between the date of the filing of the motion for resentencing on the present class B drug offense and the date of the commission of the “exclusion offense.”

Step 2: If the period of time calculated in Step 1 is 10 years or less the defendant is ineligible for resentencing and no further calculation is necessary. If the period of time calculated in Step 1 is 10 years and 1 day or more, go on to Step 3.

Step 3: Calculate the amount of time the defendant was incarcerated for any reason between the date of the commission of the previous “exclusion offense” and the date of the commission of the present class B drug offense for which resentencing is sought.

Step 4: Subtract the time calculated in Step 3 from the time calculated in Step 1.

Step 5: If the total time resulting from the calculation performed in Step 4 is 10 years and 1 day or more, the defendant is eligible for resentencing. If the time resulting from the calculation performed in Step 4 is 10 years or less, the defendant is ineligible for resentencing.

### Exclusion Offense

The “exclusion offense” occurring in the preceding 10 year look back period referenced in CPL §440.46 (a) includes a conviction for any of the following crimes: a violent felony offense or manslaughter in the second degree, or vehicular manslaughter in the first degree, or criminally negligent homicide, or an offense defined in article 130 of the Penal Law, or incest, or an offense defined in article 263 of the Penal Law, or aggravated harassment of an employee by an inmate.

### Applicable Statutes:

CPL §440.46 Motion for resentence; certain controlled substance Offenders

(5) The provisions of this section shall not apply to any person who is serving a sentence on a conviction for or has a predicate felony conviction for an exclusion offense. For purposes of this subdivision, an “exclusion offense” is:

(a) a crime for which the person was previously convicted within the preceding ten years, excluding any time during which the offender was incarcerated for any reason between the time of commission of the previous felony and the time of commission of the present felony, which was: (i) a violent felony offense as defined in section 70.02 of the penal law; or (ii) any other offense for which a merit time allowance is not available pursuant to subparagraph (ii) of paragraph (d) of subdivision one of section eight hundred three of the correction law; or (b) a second violent felony offense pursuant to section 70.04 of the penal law or a persistent violent felony offense pursuant to section 70.08 of the penal law for which the person has previously been adjudicated.

Correction Law §803(1)(d)(ii)

Such merit time allowance shall not be available to any person serving an indeterminate sentence authorized for an A-I felony offense, other than an A-I felony offense defined in article two hundred twenty of the penal law, or any sentence imposed for a violent felony offense as defined in section 70.02 of the penal law, manslaughter in the second degree, vehicular manslaughter in the second degree, vehicular manslaughter in the first degree, criminally negligent homicide, an offense defined in article one hundred thirty of the penal law, incest, or an offense defined in article two hundred sixty-three of the penal law, or aggravated harassment of an employee by an inmate.

### 7. Predicate/Persistent Felony 10 Year Calculation:

Predicate/Persistent Felony 10 Year Calculation assists in determining whether a person can or cannot be sentenced as a Predicate/Persistent/Mandatory Felony Offender as in PL 70.04, 70.06, 70.08, 70.07, 70.10, 70.70, 70.71 and 70.80

This calculation is the same for the following Predicate and Persistent Felony sentence calculations as defined in:

### PL§70.04, 70.06, 70.08, 70.07, 70.10, 70.70, 70.71 and 70.80

Once the client is determined to fall into any one of the above categories only the sentence varies for each category.

### PL§70.04(1) (b)

Sentence must have been imposed not more than 10 years before commission of the felony for which the defendant presently stands convicted.

Therefore, calculate the time from sentence date of the previous felony to commission date of the current felony in order to determine the total time between the crimes.
Deduct all the jail time from the date of commission of the first felony to the date of commission of the current felony from the above time between the 2 crimes to arrive at the ‘total street time’. If this time is less than 10 years then he is a Persistent Violent Felony Offender or a Predicate Violent Felony Offender depending on if he has 2 or more violent felonies within this 10 year period.

### PL§70.06(1) (iv) and (v)

Sentence must have been imposed not more than 10 years before commission of the felony for which the defendant presently stands convicted.

Therefore, calculate the time from sentence date of the previous felony to commission date of the current felony in order to determine the total time between the crimes.
Deduct all the jail time from the date of commission of the first felony to the date of commission of the current felony from the above time between the 2 crimes to arrive at the ‘total street time’. If this time is less than 10 years then he is a Second (Predicate) Felony Offender.
   8. 10 year Felony Calculation for Judicial Diversion Eligibility—CPL§216:

10 year Felony Calculation for Judicial Diversion Eligibility—CPL§216 assists in determining whether a person is entitled to judicial diversion in accordance with CPL§216.

### N.Y. CPL. LAW §216.00:

NY Code—Section 216.00: Definitions

The following definitions are applicable to this article:

1. “Eligible defendant” means any person who stands charged in an indictment or a superior court information with a class B, C, D or E felony offense defined in article two hundred twenty or two hundred twenty-one of the penal law or any other specified offense as defined in subdivision four of section 410.91 of this chapter, provided, however, a defendant is not an “eligible defendant” if he or she:

(a) within the preceding ten years, excluding any time during which the offender was incarcerated for any reason between the time of commission of the previous felony and the time of commission of the present felony, has previously been convicted of: (i) a violent felony offense as defined in section 70.02 of the penal law or (ii) any other offense for which a merit time allowance is not available pursuant to subparagraph (ii) of paragraph (d) of subdivision one of section eight hundred three of the correction law, or (iii) a class A felony offense defined in article two hundred twenty of the penal law; or

(b) has previously been adjudicated a second violent felony offender pursuant to section 70.04 of the penal law or a persistent violent felony offender pursuant to section 70.08 of the penal law.

A defendant who also stands charged with a violent felony offense as defined in section 70.02 of the penal law or an offense for which merit time allowance is not available pursuant to subparagraph (ii) of paragraph (d) of subdivision one of section eight hundred three of the correction law for which the court must, upon the defendant's conviction thereof, sentence the defendant to incarceration in state prison is not an eligible defendant while such charges are pending. A defendant who is excluded from the judicial diversion program pursuant to this paragraph or paragraph (a) or (b) of this subdivision may become an eligible defendant upon the prosecutor's consent.

2. “Alcohol and substance abuse evaluation” means a written assessment and report by a court-approved entity or licensed health care professional experienced in the treatment of alcohol and substance abuse, or by an addiction and substance abuse counselor credentialed by the office of alcoholism and substance abuse services pursuant to section 19.07 of the mental hygiene law, which shall include:

(a) an evaluation as to whether the defendant has a history of alcohol or substance abuse or alcohol or substance dependence, as such terms are defined in the diagnostic and statistical manual of mental disorders, fourth edition, and a co-occurring mental disorder or mental illness and the relationship between such abuse or dependence and mental disorder or mental illness, if any;

(b) a recommendation as to whether the defendant's alcohol or substance abuse or dependence, if any, could be effectively addressed by judicial diversion in accordance with this article;

(c) a recommendation as to the treatment modality, level of care and length of any proposed treatment to effectively address the defendant's alcohol or substance abuse or dependence and any co-occurring mental disorder or illness; and

(d) any other information, factor, circumstance, or recommendation deemed relevant by the assessing entity or specifically requested by the court.
NB Effective Oct. 7, 2009

### 9. Basic Indeterminate Sentence:

The basic computation is used when the factors involved are limited to a sentence, jail time, and date received. Penal Law 70.30 (1) states that the sentence commences when the inmate is received in this Department. Penal Law 70.30 (3) states that the sentence is credited with jail time. Correction Law 601-a states that the jail time must be certified by the New York City Department of Corrections or the County Sheriff. Penal Law 70.30 (4) states that good time may be subtracted from the maximum expiration date. Correction Law 803 (1) states the amount of good time. Penal Law 70.40 (1) states that the inmate is eligible for parole after serving his/her minimum term. During certain circumstances an inmate may be released prior to serving his/her minimum term. These are: shock incarceration, sentences of parole supervision (Willard), merit, medical parole, and early parole to deportation. The inmate is usually seen by the Parole Board two months prior to his/her parole eligibility date. The Board may release him or they may hold him for a reappearance at a later date. If the inmate is not released by the Parole Board, he may eventually be released by conditional release. The inmate is usually seen by the Time Allowance Committee four months prior to his/her conditional release date. The Time Allowance Committee reviews the inmates incarceration behavior and programming to decide if he has earned his/her good time. There is no conditional release on a maximum term of life. If he is not released by the parole board or the time allowance committee, he will remain in custody until his/her maximum expiration date.

10. Indeterminate Returned Parole Violator with Consecutive Determinate and Consecutive Indeterminate New Terms (New Terms are Consecutive to Each Other):

Formula for an indeterminate returned parole violator with a consecutive determinate new term and indeterminate new term. The new terms are consecutive to each other, and consecutive to the prior indeterminate time owed. To compute the parole eligibility date, add 6/7 of the determinate term and the new indeterminate minimum term; then subtract the jail time, add the prior indeterminate minimum time owed, and add the date received. Compute the Maximum Expiration dates twice; compare them, and whichever is longer controls. To compute the first ME, add the determinate term and the new indeterminate minimum term; then subtract the jail time, add the prior indeterminate minimum time owed, and add the date received. To compute the second ME, subtract the jail time from the new indeterminate maximum term; then add the prior indeterminate maximum time owed, and add the date received. Compute the good time and subtract it from the controlling Maximum Expiration date. To compute the good time, add 1/7 of the determinate term, ⅓ of the indeterminate maximum term and ⅓ of the prior indeterminate maximum time owed.
Penal Law 70.40 (1)(b)(ii) prohibits inmates from being eligible for CR before they are eligible for parole.
   11. Indeterminate Returned Parole Violator with Consecutive Determinate New Term:

Formula for an indeterminate returned parole violator with a consecutive determinate new term. To compute the Parole Eligibility date, add 6/7 of the determinate term to the prior indet min time owed, if any. To compute the Maximum Expiration date, add the determinate term to the prior indeterminate minimum time owed, if any. Add prior indeterminate maximum time owed to the date received, and whichever is longer controls. To compute the Conditional Release*, use the controlling Maximum Expiration date. The good time is 1/7 of the determinate term plus ⅓ of the prior indeterminate maximum time owed. *Penal Law 70.40 (1)(b)(ii) prohibits inmates from being eligible for CR before they are eligible for parole, so the CR date is slid back to the PE date and the good time is correspondingly reduced.

12. Indeterminate Returned Parole Violator with Concurrent Determinate New Term:

Formula for an indeterminate returned parole violator with a concurrent determinate new term. To compute the Parole Eligibility date, add 6/7 of the determinate term minus jail time to date received and subtract prior time credit. Add the prior indeterminate minimum time owed to the date received; whichever is longer controls.

To compute the Maximum Expiration date, add the determinate term minus jail time to date received and subtract prior time credit. Add the prior indeterminate maximum time owed to the date received, and whichever is longer controls.

To compute the Conditional Release*, use the controlling maximum expiration date. The good time on the determinate term is 1/7 of the determinate term. The good time on the indeterminate term is ⅓ of the prior indeterminate maximum time owed if time owed is greater than one year. Compare the good time, and whichever is greater must be subtracted from the controlling maximum expiration date.
Penal Law §70.40 (1)(b)(ii)
   13. Indeterminate Returned Parole Violator with Consecutive Determinate and Consecutive Indeterminate New Term (New Terms are Concurrent to Each Other):

Formula for an indeterminate returned parole violator with a consecutive determinate new term and indeterminate new term. The new terms are concurrent with each other, but consecutive to the prior time owed. Compute the Parole Eligibility dates twice; compare them, and whichever is longer controls. To compute the first PE, subtract the jail time from 6/7 of the determinate term, then add the prior indeterminate minimum time owed, if any, and add the date received. To compute the second PE, subtract the jail time from the new indeterminate minimum term; then add the prior indeterminate minimum time owed, if any, and add the date received.

Compute the Maximum Expiration dates twice; compare them and whichever is longer controls. To compute the first ME, subtract the jail time from the determinate term; then add the prior indeterminate minimum time owed, if any, and add the date received. To compute the second ME, subtract the jail time from the new indeterminate maximum term; then add the prior indeterminate maximum time owed, and add the date received.

Compute the good time twice, compare them, and whichever is greater must be subtracted from the controlling Maximum Expiration date. Add 1/7 of the determinate term to ⅓ of the prior indeterminate maximum time owe.

Add ⅓ of the indeterminate maximum term to ⅓ of the prior indeterminate max time owed.
Penal Law §70.40 (1)(b)(ii) prohibits inmates from being eligible for CR before they are eligible for parole, so the CR date is slid back to the PE date and the good time is correspondingly reduced.
   14. Returned Parole Violator/Conditional Release Violators with No New Term:

This computation is sued to show the interruption of a sentence when an inmate violates parole supervision. After an inmate is released, he must remain under parole supervision until his/her sentence is satisfied by maximum expiration or by discharge under Executive Law 259-j. Penal Law 70.40 (3) states that if an inmate violates his/her parole his/her sentence is interrupted on the delinquency date. If the Parole board has determined that the violator should be returned to NYSDOCCS, the sentence will recommence when the inmate is returned to this Department. If the Parole Board has determined that the violator does not need to be returned to NYSDOCCS, the sentence will recommence when the inmate is restored to parole from the county jail or NYCDOC (this is known as a revoke and restore). Penal Law 70.40 (3)(a), (b), and (c) lists the three ways that inmates may earn credit towards their maximum term in the form of parole jail time. Executive Law 259-c (12) states that the Division of Parole is responsible for issuing parole jail time certificates. There are many types of inmates that are paroled prior to completion of their minimum term. These are: shock incarceration, sentences of parole supervision (Willard), merit, medical parole, and early parole to deportation. Therefore, the prior parole eligibility date must always be checked to see if the inmate still owes time on the minimum term. If you cannot subtract the delinquency date from the prior parole eligibility date, then the inmate does not have minimum time owed and you do not have to adjust the PE date. Correction Law 803 (5) states that the when an inmate violates parole all of his/her good time is forfeited. He may subsequently receive good time that is one-third of the remaining time owed on his/her indeterminate sentence, provided that it is more than one year. If the remaining time owed is one year or less, there is no good time and no conditional release date.

15. Returned Parole Violator/Conditional Release Violators with Concurrent New Terms:

This computation is used to show the interruption of a sentence when an inmate violates parole supervision. After an inmate is paroled, he must remain under parole supervision until his/her sentence is satisfied by maximum expiration or by discharge under Executive Law 259-j. Penal Law 70.40 (3) states that if an inmate violates his/her parole his/her sentence is interrupted on the delinquency date. Executive Law 259-l (3)(d)(iii) states that the inmate can be automatically declared delinquent for committing a felony while under parole supervision. If the new felony is concurrent with the prior sentence, this computation is sued. Use Penal Law §70.25 to determine if the new sentence is concurrent or consecutive. To compute the new parole eligibility date when a parole or conditional release violator has a commitment that is concurrent pursuant to 70.25 (1) or has a new commitment that states “concurrent with previous sentence,” the new minimum is computed like a basic and the inmate receives prior time credit. Prior time credit is authorized by Penal Law 70.30 (1)(a). When two or more indeterminate sentences are concurrent, all time credited to the minimum of one sentence must be credited to the minimum of all the concurrent sentence. Prior time credit is deducted from the interim PE date. Prior time credit is calculated from the date of reception in a State facility to date of parole or conditional release (jail time is not included). There are many types of inmates that are paroled prior to completion of their minimum term. These are: shock incarceration, sentences or parole supervision (Willard), merit, medical parole, and early parole to deportation. Therefore, the prior parole eligibility date must always be checked to see if the inmate still owes time on the minimum term. To compute the minimum time owed, subtract the delinquency date from the prior parole eligibility date. If you cannot subtract the delinquency date from the prior parole eligibility date, then the inmate does not have minimum time owed. To compute the adjusted parole eligibility date, add the minimum time owed to the date received. The date with the longer time to run becomes the controlling parole eligibility date. When a parole or conditional release violator has a commitment that states concurrent with Parole Time Owed, the new minimum is computed like a basic and the inmate does NOT receive prior time credit. -People ex rel. Mathis v. Harris 444 NYS2d 114 (2d Dept. 1981) To compute the new maximum expiration date, subtract the jail time from the maximum term and add the date received. To compute the adjusted maximum expiration date, add the net time owed to the date received. The date with the longer time to run becomes the controlling maximum expiration date. If parole jail time and jail time cover the same period, request that the Division of Parole reduce their parole jail time. If the adjusted Maximum Expiration Date is controlling, the good time will be computed as one-third of the maximum time owed. If the new Maximum Expiration date is controlling, the good time will be computed as one-third of the new maximum term.

16. Returned Parole Violator/Conditional Release Violators with Consecutive New Terms:

This computation is used to show the interruption of a sentence when an inmate violates parole supervision. After an inmate is paroled, he must remain under parole supervision until his/her sentence is satisfied by maximum expiration or by discharge under Executive Law 259-j. Penal Law 70.40 (3) states that if an inmate violates his/her parole, his/her sentence is interrupted on the delinquency date. Executive Law 259-i (3)(d)(iii) states that the inmate can be automatically declared delinquent for committing a felony while under parole supervision. If the new felony is consecutive with the prior sentence, this computation is used. Use Penal Law 70.25 to determine if the new sentence is concurrent or consecutive. To compute the new parole eligibility date, subtract the jail time from the new minimum term, add the time owed minimum, and add the date received. To compute the time owed minimum, subtract the delinquency date from the prior parole eligibility date. There are many types of inmates that are paroled prior to completion of their minimum term. These are: shock incarceration, sentences of parole supervision (Willard), medical parole, merit, and early parole to deportation. Therefore, the prior parole eligibility date must always be checked to see if the inmate still owes time on the minimum term. If you cannot subtract the delinquency date from the prior parole eligibility date, then the inmate does not have minimum time owed. To compute the new maximum expiration date, subtract the jail time form the new maximum term, add the time owed maximum, and add the date received. To compute the time owed maximum, subtract the delinquency date form the prior maximum expiration date and subtract the parole jail time.

### 17. Re-Sentence (Indeterminate):

The calculations performed for this computation are the same as those performed for the Basic Indeterminate. Re-sentences always go back to the date of the original sentence, whether or not so stated on the new commitment. The re-sentence computation cannot be used with delinquent time owed. Occasionally a re-sentence brings an individual beyond his/her new conditional release date. In that case, he should be released immediately after his/her case has been considered by the Tim Allowance Committee. If a re-sentence brings an individual beyond his/her new maximum expiration date, he is discharged immediately. If the subject was court-ordered discharged and subsequently returned, an 08 computation will also be needed. Penal Law §70.30 (5).

### 18. Re-Affirmation (Indeterminate):

When an inmate is discharged by court order and later returned with a reaffirmation or re-sentence, his/her time is adjusted to reflect the interruption. In the time computation, the date reaffirmed refers to the date the inmate is returned to DOCS custody. If an inmate goes out to court and his/her sentence continues to run, there is no change in the time computation. Penal Law §70.30 (5).

### 19. Additional Concurrent:

The minimum and maximum terms of concurrent sentences merge and are satisfied by the term which has the longest unexpired time to run. Use Penal Law 70.25 to determine if the new sentence is concurrent or consecutive. Pursuant to Penal Law 70.30 (1)(a) the minimum and maximum terms of an additional concurrent sentence commence on the date the sentence is imposed and prior time credit is deducted from the minimum term of the additional sentence. Prior time credit is calculated form the date received on the prior sentence to the date sentenced on the present sentence. Compare the existing minimum term to the new minimum term; if the new term is less than or the same as the old term, the current Parole Eligibility Date will remain. If not, a new Parole Eligibility Date should be calculated. By hand, compute the new maximum expiration date and compare it to the current maximum expiration date; the larger of the two becomes the inmates maximum expiration date. If the maximum expiration date does not change, the conditional release date does not change. It is important to realize that not all additional concurrent sentences will result in a change in release dates.

### 20. Additional Consecutive Indeterminate—Uninterrupted (Basic):

If a commitment does not state whether it is concurrent or consecutive to a previously imposed sentence, use Penal Law §70.25 to determine if the sentences are concurrent or consecutive. When multiple sentences are imposed to run consecutively, both the minima and maxima are added to arrive at an aggregate total, subject to the limitations in Penal Law §70.30 (1)(e).

1. For crimes committed on or after 10/1/95, refer to the Penal Law or contact the Office of Sentencing Review.

2. For crimes committed between 5/31/83 and 9/30/95, the Reduction Statute was used as follows:

a. If one of the consecutive felonies is a Class A felony, there is no reduction.

b. The aggregate maximum term of consecutive sentences imposed for three or more violent felony offenses committed prior to the time the person was imprisoned under any of such sentences and at least one of which is a Class B violent felony offense, shall, if it exceeds fifty years, be deemed to be fifty years.

c. The aggregate maximum term of consecutive sentences imposed for two violent felony offenses committed prior to the time the person was imprisoned under any of such sentences and at least one of which is a class B violent felony offense, shall, if it exceeds forty years, be deemed to be forty years.

d. The aggregate maximum term of consecutive sentences committed prior to the time the person was imprisoned under any of such sentences and at least one of which is a Class B felony offense, shall, if it exceeds thirty years, be deemed to be thirty years.

e. The aggregate maximum term of consecutive sentences committed prior to the time the person was imprisoned under any of such sentences, shall, if it exceeds twenty years, be deemed to be twenty years.

Where this reduction is made, the aggregate minimum period of imprisonment, if it exceeds one-half of the reduced aggregate maximum term, shall be deemed to be one-half of the reduced aggregate maximum term.

3. For crimes committed between 9/1/78 and 5/30/83, the aggregate maximum term of consecutive sentences imposed for two or more crimes, other than two or more crimes that include a Class A felony, committed prior to the time the person was imprisoned under any of such sentences, shall, if it exceeds twenty years, be deemed to be twenty years, unless one of the sentences was imposed for a Class B felony, in which case the aggregate maximum term shall, if it exceeds thirty years, be deemed to be thirty years. Where the aggregate maximum term of two or more consecutive sentences is reduced by calculation made pursuant to the above, the aggregate minimum period of imprisonment, if it exceeds one-half of the aggregate maximum term as so reduced, shall be deemed to be one-half of the aggregate maximum term as so reduced.

4. For crimes committed between 9/1/78 and 6/1/80, the aggregate minimum could not exceed one-half the longest single maximum imposed except for Class A or B felonies.

5. For crimes committed between 9/1/67 and 8/31/78, the aggregate maximum term of consecutive sentences imposed for two or more crimes committed prior to the time the person was imprisoned under any of such sentences shall, if it exceeds twenty years, be deemed to be twenty years, unless one of the sentences was imposed for a Class B felony, in which case the aggregate maximum term shall, I fit exceeds thirty years, be deemed to be thirty years.

6. For crimes committed between Sep. 1, 1967 and Aug. 31, 1978, the consecutive minima merged in and were satisfied by service of the longest minimum term. If an additional consecutive sentence was imposed after the minimum or the prior sentence was exceeded, the new minimum was calculated from the date of imposition of the additional sentence.

7. For crimes committed prior to Sep. 1, 1967, the under the “old Law,” the Parole Board paroled inmates on paper to allow them to finish one sentence and then start a consecutive sentence.

### 21. Returned Absconder/AWOL No New Term:

Formula for a returned absconder/AWOL with no new term: Penal Law 70.30 (7) states that the sentence is interrupted when the inmate fails to return and recommences when the inmate is returned. He may earn jail time for the time he is gone during certain circumstances. Refer to Penal Law §70.30 (7)(a), (b), and (c).

### 22. Returned Escapee No New Term:

Formula for a returned escapee with no new term. Penal Law §70.30 (6) states that the sentence is interrupted when the inmate escapes and recommences when the inmate is returned. He may ear jail time for the time he is gone during certain circumstances. Refer to Penal Law §70.30 (6)(a), (b), and (c).

23. Returned Absconder/AWOL with Consecutive New Term:

Formula for a returned absconder/AWOL with a consecutive new term. Penal Law §70.30 (7) states that the sentence is interrupted when the inmate fails to return from his/her temporary release program and recommences when the inmate is returned.

24. Returned Escapee with Consecutive New Term:

Formula for a returned escapee with a consecutive new term. Penal Law §70.30 (6) states that the sentence is interrupted when the inmate escapes and recommences when the inmate is returned.

25. Indeterminate Returned Absconder/AWOL/Escapee with a Consecutive Determinate New Term:

Formula for an indeterminate returned absconder/AWOL/escapee with a consecutive determinate new term.

To compute the Parole Eligibility date, add 6/7 of the determinate term to the prior indeterminate minimum time owed, if any.

To compute the Maximum Expiration date, add the determinate term to the prior indeterminate minimum time owed, if any. Add the prior indeterminate maximum time owed to the date received, and whichever is longer controls.

To compute the Conditional Release*, use the controlling Maximum Expiration date.

The good time is 1/7 of the determinate term plus the good time from the prior term.
Penal Law §70.40 (1)(b)(ii) prohibits inmates from being eligible for CR before they are eligible for parole, so the CR date is slid back to the PE date and the good time is correspondingly reduced.
   26. Indeterminate Returned Absconder/AWOL/Escapee with a Consecutive Determinate and Indeterminate New Term:

Formula for an indeterminate returned absconder/AWOL/escapee with a consecutive determinate new term and indeterminate new term. The new terms are concurrent with each other but consecutive to prior term.

To compute the Parole Eligibility date, add 6/7 of the determinate term to the prior indeterminate minimum time owed, if any. Add the new indeterminate minimum term to the prior indeterminate minimum time owed, if any. Whichever is longer controls.

To compute the Maximum Expiration date, add the determinate term to the prior indeterminate minimum time owed, if any. Add the new indeterminate maximum term to the prior indeterminate maximum time owed. Whichever is longer controls.

Compute the good time twice; compare them, and whichever is greater must be subtracted from the controlling Maximum Expiration date. Add 1/7 of the determinate term to the good time from the prior term. Add ⅓ of the indeterminate term to the good time from the prior term.
Penal Law §70.40 (1)(b)(ii) prohibits inmates from being eligible for CR before they are eligible for parole, so the CR date is slid back to the PE date and the good time is correspondingly reduced.

### 27. Out of State Concurrent Term:

Pursuant to Penal Law §70.25 (4) for crimes committed after 9/1/75, sentences concurrent with undischarged terms in other jurisdictions were permitted. The commitment must state the sentence is concurrent; otherwise, it is deemed to be consecutive. The concurrent New York State sentence begins to run when an individual is returned to the custody of the other jurisdiction; if this date is unknown, the NYS date sentenced is used.* Prior time credit is received on the minimum term for time from commencement of the sentence in the other jurisdiction to commencement of the New York State sentence. For crimes committed before Oct. 1, 1995, subject can only receive prior time credit if the other jurisdiction's sentence is indeterminate.

In order to be considered for parole, an individual must meet the New York State Parole Board face-to-face [Executive Law §259-l (2)(a)]. Thus, he cannot be paroled while incarcerated in another jurisdiction. He can, however, be conditionally released while still in the other jurisdiction's custody by securing a favorable adjustment report.
The concurrent New York State sentence begins to run when an individual is returned to the custody of the other jurisdiction; if this date is unknown, the NYS date sentenced is used.

### 28. Out of State Consecutive Term (Basic):

Formula for an inmate that receives a consecutive sentence while serving time on an undischarged sentences from another jurisdiction (such as another state or federal).

### 29. Additional Consecutive Interrupted Term:

For an additional consecutive sentence that requires more than just a basic computation. The new minimum term is added to the later of the sentence date or prior parole eligibility date. The maximum term is added to the prior maximum expiration date.

Good time is ⅓ of the new maximum term plus the good time from the prior term.

### 30. CS MEPS:

Formula for an indeterminate returned parole violator that is consecutive to prior undischarged sentence and there is no delinquency date.

The good time is ⅓ of the indeterminate maximum term.

### 31. CC MEPS:

Formula for an indeterminate returned parole violator that is concurrent with a prior undischarged sentence and there is no delinquency date.

The good time is ⅓ of the indeterminate maximum term.

The CC MEPS date is the maximum expiration date from the prior DIN. When the subject is released from DOCS, the later of the two dates controls.

### 32. Basic Determinate Sentence:

The basic determinate formula is sued when the factors involved are limited to a determinate sentence, jail time, and date received. Determinate terms are at least 1 year and at most 30 years. Parole Eligibility date: Inmates with only determinate sentence(s) do not have parole eligibility dates and are not entitled to a parole board appearance. To compute the Maximum Expiration date, add the date received and subtract the jail time. The good time is 1/7 of the determinate term.

### 33. Determinate Absconder/AWOL/Escapee—No New Term:

Formula for a determinate returned absconder/AWOL/escape with no new term.

Parole Eligibility date: Inmates with only determinate sentence(s) do not have Parole Eligibility dates and are not entitled to a Parole Board appearance.

The good time is the same as it was before the inmate absconded/AWOL/escaped.

34. Determinate Returned Absconder/AWOL/Escapee with a Consecutive Indeterminate New Term:

Formula for a determinate returned absconder/AWOL/escapee with a consecutive indeterminate new term.

The good time is ⅓ of the indeterminate maximum term plus the good time from the prior term.
Penal Law §70.40 (1)(b)(ii) prohibits inmates from bng eligible for CR before they are eligible for parole, so the CR date is slid back to the PE date and the good time is correspondingly reduced.
   35. Determinate Returned Absconder/AWOL/Escapee with a Consecutive Determinate New Term:

Formula for a determinate returned absconder/AWOL/escapee with a consecutive determinate new term.

Parole Eligibility date: Inmates with only determinate sentence(s) do not have Parole Eligibility dates and are not entitled to a Parole Board appearance.

To compute the time owed, subtract the date of the interruption from the prior Maximum Expiration date.

To compute the Maximum Expiration date, add the determinate term to the prior determinate maximum time owed.

The good time is 1/7 of the determinate term plus the good time from the prior term.

36. Determinate PRS Violator with New Consecutive Determinate Term:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

37. Determinate PRS Violator With New Consecutive Indeterminate Term:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

38. Determinate PRS Violator with New Concurrent Determinate Term:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

39. Determinate PRS Violator with New Concurrent Indeterminate Term:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

40. Determinate PRS Violator with New Consecutive Determinate Concurrent Indeterminate:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

41. Determinate PRS Violator with New Concurrent Determinate Concurrent Indeterminate:

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

### 42. Post Release Supervision Violator (PRSV)—Revoke/Restore (Willard) (Where Sentence Time Owed PRS):

Formula for a post-release supervision violator that did not receive a new term and was revoked and restored to parole supervision but the sentence time owed is greater than the period of post-release supervision.

For determinate sentenced only: Enter FMAX in the PHT field; leave the ERD, PHD, and PE fields blank.

For determinate and indeterminate mix cases: Do not change the PE, PHD, PHT, or ERD fields.

To compute the adjusted maximum expiration date, subtract the date released from the Maximum Expiration date to arrive at the Sentence Time Owed. Then subtract the Parole Jail Time to arrive at the sentence net time owed. Then add the adjusted post-release supervision maximum expiration date and then subtract the period of post-release supervision to arrive at the adjusted sentence maximum expiration date.

To compute the Adjusted Post-Release Supervision Maximum Expiration date, subtract the Delinquency Date from the Post-Release Supervision Maximum Expiration date (PRSME) to arrive at the post-release supervision time owed. Then add the date restored to parole to arrive at the Adjusted Post-Release Supervision Maximum Expiration date.

43. Basic Determinate with Concurrent Indeterminate Sentence:

Formula for inmate received with two or more concurrent sentences. At least one indeterminate and one determinate. To compute the Parole Eligibility date, compare 6/7 of the determinate against the indeterminate minimum. The longer controls. To compute the Maximum Expiration date, compare the determinate against the indeterminate maximum term. The longer controls. To compute the Conditional Release*, use the controlling maximum expiration date. The good time on the determinate term is 1/7 of the determinate term. The good time on the indeterminate term is ⅓ of the maximum term. Compare the good time, and whichever is greater must be subtracted from the controlling maximum expiration date. *Penal Law 70.40 (1)(b)(ii) prohibits inmates from being eligible for CR before they are eligible for parole, so the CR date is slid back to the PE date and the good time is correspondingly reduced.

44. Basic Determinate with Consecutive Indeterminate Sentence:

Formula for an inmate received with two or more consecutive sentences. At least one indeterminate and one determinate. To compute the Parole Eligibility date, add 6/7 of the determinate term to the indeterminate minimum. To compute the Maximum Expiration date, add the determinate term to the indeterminate minimum term. Add the indeterminate maximum term to the date received, and whichever is longer controls. To compute the Conditional Release*, use the controlling Maximum Expiration date. The good time is 1/7 of the determinate term plus ⅓ of the indeterminate maximum term.*Penal Law 70.40 (1)(b)(ii) prohibits inmates from being eligible for CR before they are eligible for parole, so the CR date is slid back to the PE date and the good time is correspondingly reduced.

45. Determinate Returned Parole Violator with No New Term:

Formula for determinate returned parole violator with no new term. To compute the adjusted Maximum Expiration date, start with the prior Maximum Expiration date, subtract the delinquency date and parole jail time and add the date returned. The good time is 1/7 of the time owed before the parole jail time is subtracted. The formula for computer 1/7 is (364×Y)+(30×M)+D/7. If the remaining time owed is one year or less, there is no good time and no Conditional Release date.

46. Determinate Returned Parole Violator with Consecutive Determinate New Term:

Formula for a determinate returned parole violator with a consecutive determinate new term. Parole Eligibility date: Inmates with only determinate sentence(s) do not have parole eligibility dates and are not entitled to a parole board appearance. To compute the Maximum Expiration date, add the determinate term to the prior determinate maximum time owed. The good time is 1/7 of the determinate term plus 1/7 of the prior time owed.

47. Determinate Returned Parole Violator with Consecutive Indeterminate New Term:

Formula for a determinate returned parole violator with a consecutive indeterminate new term. To compute the Conditional Release*, use the controlling Maximum Expiration date. The good time is 1/7 of the determinate time owed plus ⅓ of the indeterminate maximum term.
Penal Law 70.40 (1)(b)(ii) prohibits inmates from being eligible for CR before they are eligible for parole, so the CR date is slid back to the PE date and the good time is correspondingly reduced.
   48. Determinate with Concurrent Additional Indeterminate Sentence:

Formula for an inmate received with a determinate sentence that subsequently received an additional concurrent indeterminate sentence. To compute the Parole Eligibility date, add 6/7 of the determinate term to the date received. Add the indeterminate minimum term to the date sentenced, and whichever is longer controls. To compute the Maximum Expiration date, add the determinate term to the date received. Add the indeterminate maximum term to the date sentenced, and whichever is longer controls. To compute the Conditional Release*, use the controlling Maximum Expiration date. The good time on the determinate term is 1/7 of the determinate term. The good time on the indeterminate term is ⅓ of the maximum term. Compare the good time; whichever is greater must be subtracted from the controlling Maximum Expiration date. *Penal Law 70.40 (1)(b)(ii) prohibits inmates from being eligible for CR before they are eligible for parole, so the CR date is slid back to the PE date and the good time is correspondingly reduced.

49. Determinate with Concurrent Additional Determinate Sentence:

Formula for an inmate received with a determinate sentence that subsequently received an additional concurrent determinate. No Parole Eligibility date. The good time is 1/7 of the larger determinate term.

50. Determinate with Additional Consecutive Determinate Term:

Formula for an inmate received with a determinate sentence that subsequently received an additional consecutive determinate sentence.

Parole Eligibility date: Inmates with only determinate sentences do not have Parole Eligibility dates and are not entitled to a parole board appearance.

To compute the Maximum Expiration date, add the additional consecutive determinate term to the prior Maximum Expiration date.

The good time is 1/7 of the additional determinate term plus 1/7 of the prior determinate term.

51. Determinate with Additional Consecutive Indeterminate Term:

Formula for an inmate received with a determinate sentence that subsequently received an additional consecutive indeterminate sentence.

To compute the Parole Eligibility date, add 6/7 of the determinate term to the date received. Add the indeterminate minimum term to the longer of the prior Parole Eligibility date or the additional sentence date.

To compute the Maximum Expiration date, add the indeterminate minimum term to the prior Maximum Expiration date. Add the indeterminate maximum term to the date sentenced, and whichever is longer controls.

To compute the Conditional Release date*, use the controlling Maximum Expiration date. The good time is 1/7 of the determinate term plus ⅓ of the indeterminate maximum term.
Penal Law §70.40 (1)(b)(ii) prohibits inmates from being eligible for CR before they are eligible for parole, so the CR date is slid back to the PE date and the good time is correspondingly reduced.
   52. Indeterminate with Concurrent Additional Determinate Sentence:

Formula for an inmate received with an indeterminate sentence that subsequently received an additional concurrent determinate sentence. To compute the Parole Eligibility date, add 6/7 of the determinate term to the date commenced. Add the indeterminate minimum term to the date received; whichever is longer controls. To compute the Maximum Expiration date, add the determinate term to the date commenced. Add the indeterminate maximum term to the date received, and whichever is longer controls. Compute the good time twice; compare them, and whichever is greater must be subtracted from the controlling Maximum Expiration date. The good time on the determinate term is 1/7 of the determinate term. The good time on the indeterminate term is ⅓ of the maximum term. *Penal Law 70.40 (1)(b)(ii) prohibits inmates from being eligible for CR before they are eligible for parole, so the CR date is slid back to the PE date and the good time is correspondingly reduced.

53. Indeterminate with Additional Consecutive Determinate Term:

Formula for an inmate received with an indeterminate sentence that subsequently received an additional consecutive determinate term.

To compute the Parole Eligibility date, add 6/7 of the determinate term to the later of the prior Parole Eligibility dates or the additional sentence date.

To compute the Maximum Expiration date, add the determinate term to the later of the prior Parole Eligibility dates or the additional sentence date. Compare this to the prior indeterminate maximum expiration date; whichever is longer controls.

To compute the Conditional Release* date, use the controlling Maximum Expiration date.

The good time is 1/7 of the determinate term plus ⅓ of the indeterminate maximum term.
Penal Law §70.40 (1)(b)(ii) prohibits inmates from being eligible for CR before they are eligible for parole so the CR date is pushed back to the PE date and the good time is correspondingly reduced.
   54. Determinate Consecutive MEPS (Determinate Returned Parole Violator that is Consecutive to a Prior Undischarged Sentence and there is No Delinquency Date):

Formula for a determinate returned parole violator that is consecutive to a prior un-discharged sentence, and there is no delinquency date.

The CS MEPS date is the Maximum Expiration date from the prior din. Compare the ME date and the MEPS date. When the inmate is released from DOCS custody, the later of the two dates controls.

The good time is 1/7 of the determinate term.

55. Determinate Concurrent MEPS (Determinate Returned Parole Violator that is Concurrent to a Prior Undischarged Sentence and there is No Delinquency Date):

Formula for a determinate returned parole violator that is concurrent to a prior undischarged sentence, and there is no delinquency date.

The CC MEPS date is the Maximum Expiration date from the prior din. Compare the ME date and the MEPS date. When the inmate is released from DOCS custody, the later of the two dates controls.

The good time is 1/7 of the determinate term.

56. Determinate/Indeterminate PRS Violator with a New Consecutive Indeterminate Term

N.Y. PEN. LAW §70.25:
2-a. When an indeterminate or determinate sentence of imprisonment is imposed pursuant to section 70.04, 70.06, 70.08, 70.10, subdivision three or four of section 70.70, subdivision three or four of section 70.71 or subdivision five of section 70.80 of this article, and such person is subject to an undischarged indeterminate or determinate sentence of imprisonment imposed prior to the date on which the present crime was committed, the court must impose a sentence to run consecutively with respect to such undischarged sentence.
NB Effective until Sep. 1, 2011
2-a. When an indeterminate or determinate sentence of imprisonment is imposed pursuant to section 70.04, 70.06, 70.08, 70.10, subdivision three or four of section 70.70, subdivision three or four of section 70.71 or subdivision five of section 70.80 of this article, and such person is subject to an undischarged indeterminate sentence of imprisonment imposed prior to the date on which the present crime was committed, the court must impose a sentence to run consecutively with respect to such undischarged sentence.
NB Effective Sep. 1, 2011

S 70.30 Calculation of terms of imprisonment.

1. * Indeterminate or determinate sentences. An indeterminate or determinate sentence of imprisonment commences when the prisoner is received in an institution under the jurisdiction of the state department of correctional services. Where a person is under more than one indeterminate or determinate sentence, the sentences shall be calculated as follows:
NB Effective until Sep. 1, 2013
Indeterminate sentences. An indeterminate sentence of imprisonment commences when the prisoner is received in an institution under the jurisdiction of the state department of correctional services. Where a person is under more than one indeterminate sentence, the sentences shall be calculated as follows:
NB Effective until Sep. 1, 2013
(a) If the sentences run concurrently, the time served under imprisonment on any of the sentences shall be credited against the minimum periods of all the concurrent indeterminate sentences and against the terms of all the concurrent determinate sentences. The maximum term or terms of the indeterminate sentences and the term or terms of the determinate sentences shall merge in and be satisfied by discharge of the term which has the longest unexpired time to run;
NB Effective until Sep. 1, 2013
(a) If the sentences run concurrently, the time served under imprisonment on any of the sentences shall be credited against the minimum periods of all the concurrent sentences, and the maximum terms merge in and are satisfied by discharge of the term which has the longest unexpired time to run;
NB Effective until Sep. 1, 2013
(b) If the defendant is serving two or more indeterminate sentences which run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (e) and (f) of this subdivision, where applicable;
NB Effective until Sep. 1, 2013
(b) If the sentences run consecutively, the minimum periods of imprisonment are added to arrive at an aggregate minimum period of imprisonment equal to the sum of all the minimum periods, and the maximum terms are added to arrive at an aggregate maximum term equal to the sum of all the maximum terms, provided, however, that both the aggregate maximum term and the aggregate minimum period of imprisonment shall be subject to the limitations set forth in paragraphs (c) and (d) of this subdivision, where applicable;
NB Effective until Sep. 1, 2013
(c) If the defendant is serving two or more determinate sentences of imprisonment which run consecutively, the terms of the determinate sentences are added to arrive at an aggregate maximum term of imprisonment, provided, however, that the aggregate maximum term of imprisonment shall be subject to the limitations set forth in paragraphs (e) and (f) of this subdivision, where applicable.
NB Effective until Sep. 1, 2013
(c) (i) Except as provided in subparagraph (ii) or (iii) of this paragraph, the aggregate maximum term of consecutive sentences imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Notwithstanding subparagraph (i) of this paragraph, the aggregate maximum term of consecutive sentences imposed for the conviction of two violent felony offenses committed prior to the time the person was imprisoned under any of such sentences and one of which is a class B violent felony offense, shall, if it exceeds forty years, be deemed to be forty years;

(iii) Notwithstanding subparagraphs (i) and (ii) of this paragraph, the aggregate maximum term of consecutive sentences imposed for the conviction of three or more violent felony offenses committed prior to the time the person was imprisoned under any of such sentences and one of which is a class B violent felony offense, shall, if it exceeds fifty years, be deemed to be fifty years;
NB Effective Sep. 1, 2013
(d) If the defendant is serving one or more indeterminate sentences of imprisonment and one or more determinate sentence of imprisonment which run consecutively, the minimum term or terms of the indeterminate sentence or sentences and the term or terms of the determinate sentence or sentences are added to arrive at an aggregate maximum term of imprisonment, provided, however, (i) that in no event shall the aggregate maximum so calculated be less than the term or maximum term of imprisonment of the sentence which has the longest unexpired time to run; and (ii) that the aggregate maximum term of imprisonment shall be subject to the limitations set forth in paragraphs (e) and (f) of this subdivision, where applicable.
NB Effective until Sep. 1, 2013
(d) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.
NB Effective Sep. 1, 2013
(e) (i) Except as provided in subparagraph (ii), (iii), (iv), (v), (vi) or (vii) of this paragraph, the aggregate maximum term of consecutive sentences, all of which are indeterminate sentences or all of which are determinate sentences, imposed for two or more crimes, other than two or more crimes that include a class A felony, committed prior to the time the person was imprisoned under any of such sentences shall, if it exceeds twenty years, be deemed to be twenty years, unless one of the sentences was imposed for a class B felony, in which case the aggregate maximum term shall, if it exceeds thirty years, be deemed to be thirty years. Where the aggregate maximum term of two or more indeterminate consecutive sentences is reduced by calculation made pursuant to this paragraph, the aggregate minimum period of imprisonment, if it exceeds one-half of the aggregate maximum term as so reduced, shall be deemed to be one-half of the aggregate maximum term as so reduced;

(ii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds twenty years, and none of the sentences was imposed for a class B felony, the following rules shall apply:

(A) if the aggregate maximum term of the determinate sentence or sentences exceeds twenty years, the defendant shall be deemed to be serving to a determinate sentence of twenty years.

(B) if the aggregate maximum term of the determinate sentence or sentences is less than twenty years, the defendant shall be deemed to be serving an indeterminate sentence the maximum term of which shall be deemed to be twenty years. In such instances, the minimum sentence shall be deemed to be ten years or six-sevenths of the term or aggregate maximum term of the determinate sentence or sentences, whichever is greater.

(iii) Where the aggregate maximum term of two or more consecutive sentences, one or more of which is a determinate sentence and one or more of which is an indeterminate sentence, imposed for two or more crimes, other than two or more crimes that include a class A felony, committed prior to the time the person was imprisoned under any of such sentences, exceeds thirty years, and one of the sentences was imposed for a class B felony, the following rules shall apply:

(A) if the aggregate maximum term of the determinate sentence or sentences exceeds thirty years, the defendant shall be deemed to be serving a determinate sentence of thirty years;

(B) if the aggregate maximum term of the determinate sentence or sentences is less than thirty years, the defendant shall be deemed to be serving an indeterminate sentence the maximum term of which shall be deemed to be thirty years. In such instances, the minimum sentence shall be deemed to be fifteen years or six-sevenths of the term or aggregate maximum term of the determinate sentence or sentences, whichever is greater.

(iv) Notwithstanding subparagraph (i) of this paragraph, the aggregate maximum term of consecutive sentences, all of which are indeterminate sentences or all of which are determinate sentences, imposed for the conviction of two violent felony offenses committed prior to the time the person was imprisoned under any of such sentences and one of which is a class B violent felony offense, shall, if it exceeds forty years, be deemed to be forty years

(v) Notwithstanding subparagraphs (ii) and (iii) of this paragraph, where the aggregate maximum term of two or more consecutive sentences, one or more of which is a determinate sentence and one or more of which is an indeterminate sentence, and where such sentences are imposed for the conviction of two violent felony offenses committed prior to the time the person was imprisoned under any such sentences and where one of which is a class B violent felony offense, the following rules shall apply:

(A) if the aggregate maximum term of the determinate sentence or sentences exceeds forty years, the defendant shall be deemed to be serving a determinate sentence of forty years;

(B) if the aggregate maximum term of the determinate sentence or sentences is less than forty years, the defendant shall be deemed to be serving an indeterminate sentence the maximum term of which shall be deemed to be forty years. In such instances, the minimum sentence shall be deemed to be twenty years or six-sevenths of the term or aggregate maximum term of the determinate sentence or sentences, whichever is greater.

(vi) Notwithstanding subparagraphs (i) and (iv) of this paragraph, the aggregate maximum term of consecutive sentences, all of which are indeterminate or all of which are determinate sentences, imposed for the conviction of three or more violent felony offenses committed prior to the time the person was imprisoned under any of such sentences and one of which is a class B violent felony offense, shall, if it exceeds fifty years, be deemed to be fifty years;

(vii) Notwithstanding subparagraphs (ii), (iii) and (v) of this paragraph, where the aggregate maximum term of two or more consecutive sentences, one or more of which is a determinate sentence and one or more of which is an indeterminate sentence, and where such sentences are imposed for the conviction of three or more violent felony offenses committed prior to the time the person was imprisoned under any such sentences and one of which is a class B violent felony offense, the following rules shall apply:

(A) if the aggregate maximum term of the determinate sentence or sentences exceeds fifty years, the defendant shall be deemed to be serving a determinate sentence of fifty years.

(B) if the aggregate maximum term of the determinate sentence or sentences is less than fifty years, the defendant shall be deemed to be serving an indeterminate sentence the maximum term of which shall be deemed to be fifty years. In such instances, the minimum sentence shall be deemed to be twenty-five years or six-sevenths of the term or aggregate maximum term of the determinate sentence or sentences, whichever is greater.

(viii) Notwithstanding any provision of this subdivision to the contrary where a person is serving two or more consecutive sentences, one or more of which is an indeterminate sentence and one or more of which is a determinate sentence, and if he would be eligible for a reduction provision pursuant to this subdivision if the maximum term or aggregate maximum term of the indeterminate sentence or sentences were added to the term or aggregate maximum term of the determinate sentence or sentences, the person shall be deemed to be eligible for the applicable reduction provision and the rules set forth in this subdivision shall apply.
NB Effective until Sep. 1, 2013
(f) The aggregate maximum term of consecutive sentences imposed upon a juvenile offender for two or more crimes, not including a class A felony, committed before he has reached the age of sixteen, shall, if it exceeds ten years, be deemed to be ten years. If consecutive indeterminate sentences imposed upon a juvenile offender include a sentence for the class A felony of arson in the first degree or for the class A felony of kidnapping in the first degree, then the aggregate maximum term of such sentences shall, if it exceeds fifteen years, be deemed to be fifteen years. Where the aggregate maximum term of two or more consecutive sentences is reduced by a calculation made pursuant to this paragraph, the aggregate minimum period of imprisonment, if it exceeds one-half of the aggregate maximum term as so reduced, shall be deemed to be one-half of the aggregate maximum term as so reduced.

S 70.45 Determinate sentence; post-release supervision.

1. In general. When a court imposes a determinate sentence it shall in each case state not only the term of imprisonment, but also an additional period of post-release supervision as determined pursuant to this article. Such period shall commence as provided in subdivision five of this section and a violation of any condition of supervision occurring at any time during such period of post-release supervision shall subject the defendant to a further period of imprisonment up to the balance of the remaining period of post-release supervision, not to exceed five years; provided, however, that a defendant serving a term of post-release supervision for a conviction of a felony sex offense, as defined in section 70.80 of this article, may be subject to a further period of imprisonment up to the balance of the remaining period of post-release supervision. Such maximum limits shall not preclude a longer period of further imprisonment for a violation where the defendant is subject to indeterminate and determinate sentences.

5. Calculation of service of period of post-release supervision. A period or periods of post-release supervision shall be calculated and served as follows: (a) A period of post-release supervision shall commence upon the person's release from imprisonment to supervision by the department of corrections and community supervision and shall interrupt the running of the determinate sentence or sentences of imprisonment and the indeterminate sentence or sentences of imprisonment, if any. The remaining portion of any maximum or aggregate maximum term shall then be held in abeyance until the successful completion of the period of post-release supervision or the person's return to the custody of the department of corrections and community supervision, whichever occurs first.

(b) Upon the completion of the period of post-release supervision, the running of such sentence or sentences of imprisonment shall resume and only then shall the remaining portion of any maximum or aggregate maximum term previously held in abeyance be credited with and diminished by such period of post-release supervision. The person shall then be under the jurisdiction of the department of corrections and community supervision for the remaining portion of such maximum or aggregate maximum term.

(c) When a person is subject to two or more periods of post-release supervision, such periods shall merge with and be satisfied by discharge of the period of post-release supervision having the longest unexpired time to run; provided, however, any time served upon one period of post-release supervision shall not be credited to any other period of post-release supervision except as provided in subdivision five of section 70.30 of this article.

(d) When a person is alleged to have violated a condition of post-release supervision and the department of corrections and community supervision has declared such person to be delinquent: (i) the declaration of delinquency shall interrupt the period of post-release supervision; (ii) such interruption shall continue until the person is restored to post-release supervision; (iii) if the person is restored to post-release supervision without being returned to the department of corrections and community supervision, any time spent in custody from the date of delinquency until restoration to post-release supervision shall first be credited to the maximum or aggregate maximum term of the sentence or sentences of imprisonment, but only to the extent authorized by subdivision three of section 70.40 of this article. Any time spent in custody solely pursuant to such delinquency after completion of the maximum or aggregate maximum term of the sentence or sentences of imprisonment shall be credited to the period of post-release supervision, if any; and (iv) if the person is ordered returned to the department of corrections and community supervision, the person shall be required to serve the time assessment before being re-released to post-release supervision. In the event the balance of the remaining period of post-release supervision is six months or less, such time assessment may be up to six months unless a longer period is authorized pursuant to subdivision one of this section. The time assessment shall commence upon the issuance of a determination after a final hearing that the person has violated one or more conditions of supervision. While serving such assessment, the person shall not receive any good behavior allowance pursuant to section eight hundred three of the correction law. Any time spent in custody from the date of delinquency until return to the department of corrections and community supervision shall first be credited to the maximum or aggregate maximum term of the sentence or sentences of imprisonment, but only to the extent authorized by subdivision three of section 70.40 of this article. The maximum or aggregate maximum term of the sentence or sentences of imprisonment shall run while the person is serving such time assessment in the custody of the department of corrections and community supervision. Any time spent in custody solely pursuant to such delinquency after completion of the maximum or aggregate maximum term of the sentence or sentences of imprisonment shall be credited to the period of post-release supervision, if any.

(e) Notwithstanding paragraph (d) of this subdivision, in the event a person is sentenced to one or more additional indeterminate or determinate term or terms of imprisonment prior to the completion of the period of post-release supervision, such period of post-release supervision shall be held in abeyance and the person shall be committed to the custody of the department of corrections and community supervision in accordance with the requirements of the prior and additional terms of imprisonment.

(f) When a person serving a period of post-release supervision is returned to the department of corrections and community supervision pursuant to an additional consecutive sentence of imprisonment and without a declaration of delinquency, such period of post-release supervision shall be held in abeyance while the person is in the custody of the department of corrections and community supervision. Such period of post-release supervision shall resume running upon the person's re-release.

57. Determinate/Indeterminate PRS Violator with 2 Parole/CR/Merit Releases and a New Consecutive Indeterminate Term

### Calculations:

Prior Determinate Sentence Calculations:

Time Owed on Prior Minimum:

Prior Determinate Sentence=6 Years

6/7 of Prior Determinate (Minimum)=05 Yrs 01 Months 18 Days

Jail Time Credit (Prior DIN#): −00 Yrs 05 Months 08 Days

Minimum to serve on Prior Determinate=04 Yrs 08 Months 10 Days

Date Received on Prior Sentence (Original): +Jan. 14, 2008

Grace Day: −1

Parole Eligibility Date=Sep. 23, 2012

Date Paroled/Merit Release (Original): −Sep. 25, 2009

TIME OWED ON PRIOR MINIMUM=02 Yrs 11 Months 28 Days

Time Owed on Prior Maximum:

Prior Determinate Sentence=6 Years

Jail Time Credit (Prior DIN#): −00 Yrs 05 Months 08 Days

Maximum to serve on Prior Determinate=05 Yrs 06 Months 22 Days

Date Received on Prior Sentence (Original): +Jan. 14, 2008

Grace Day: −1

Maximum Expiration Date (Original)=Aug. 5, 2013

Date Paroled/Merit Release (Original): −Sep. 25, 2009

Time Owed=03 Yrs 10 Months 10 Days

Parole Jail Time: −00 Yrs 04 Months 13 Days

(from Nov. 15, 2010 to Mar. 27, 2011)

Aggregate time Owed=03 Yrs 05 Months 27 Days

Date Received on Prior Sentence (Current): +Mar. 28, 2011

Maximum Expiration Date (Current)=Sep. 25, 2014

Date Paroled/Merit Release (Current): −Nov. 15, 2011

TIME OWED ON PRIOR MAXIMUM=02 Yrs 10 Months 10 Days

New Indeterminate Sentence Calculations:

Parole Eligibility Date Calculations:

Current Indeterminate Minimum Term: =01 Year 06 Months

Jail Time Credit (Current DIN#): −00 Years 08 Months 22 Days

Time To Serve (Minimum): =00 Years 09 Months 08 Days

TIME OWED ON PRIOR MINIMUM: +02 Yrs 11 Months 28 Days

Aggregate Minimum=03 Years 09 Months 06 Days

Date Received on New Sentence: +Jun. 3, 2013

Grace Day: −1

Parole Eligibility Date=Feb. 8, 2017

Merit Time: −00 Years 03 Months 01 Day

(⅓ of Time To Serve (Minimum))

Merit Parole Eligibility Date=Nov. 7, 2016

Maximum Expiration Date Calculations

M.E. Date on Indeterminate Maximum Sentence:

Current Indeterminate Maximum Term: =03 Years 00 Months

Jail Time Credit (Current DIN#): −00 Years 08 Months 22 Days

Time To Serve (Maximum)=02 Years 03 Months 08 Days

Date Received on New Sentence: +Jun. 3, 2013

Grace Day: −1

Maximum Expiration Date (Maximum Term)=Aug. 10, 2015

M.E. Date on Indeterminate Minimum Sentence:

Current Indeterminate Minimum Term=01 Year 06 Months

TIME OWED ON MAXIMUM: +02 Yrs 10 Months 10 Days

Aggregate Minimum=04 Yrs 04 Months 10 Days

Jail Time Credit (Current DIN#):−00 Years 08 Months 22 Days

Time to Serve (Minimum)=03 Years 07 Months 18 Days

Date Received on New Sentence: +May 3, 2013

Grace Day: −1

Maximum Expiration Date (Minimum Term)=Dec. 20, 2016

Maximum Expiration Date (Controlling)=Dec. 20, 2016

Good Time: −01 Yr 04 Months 28 Days

⅓ of 3 yrs—Max of Indeterminate

+ 1/7 of 2 yrs 2 mths 10 days—Time Owed on Prior Max

=513 Days

Conditional Release Date=Jul. 22, 2015

Note:

Since P.E Date cannot be after M.E. Date P.E. is set to M.E.

CR Date cannot be before P.E. date so ‘Good Time is adjusted and CR

Date=P.E. Date

Maximum Expiration Date (Controlling)=Dec. 20, 2016

Parole Eligibility Date=Dec. 20, 2016

Conditional Release Date=Dec. 20, 2016

Merit Release Dates:

If he gets ‘Merit Release’ then his release dates will be as follows

Maximum Expiration Date (Controlling)=Dec. 20, 2016

Parole Eligibility Date=Nov. 7, 2016

Conditional Release Date=Nov. 7, 2016

Penal Law 70.40 (1)(b)(ii) prohibits inmates from being eligible for CR before they are eligible for parole, so the CR date is slid back to the PE date and the good time is correspondingly reduced.

PRS Time Owed Calculations:

Post Release Supervision Term=03 Years 00 Months 00 Days

Date Paroled/Merit Release (Original): +Sep. 25, 2009

PRS Maximum Expiration Date (Original)=Sep. 25, 2012

Declared Delinquent (Prior Sentence): −Feb. 11, 2010

PRS Time Owed (Original Sentence)=02 Years 07 Months 14 Days

Date Paroled/Merit Release (Current): +Nov. 15, 2011

PRS Maximum Expiration Date (Current)=Jun. 29, 2014

Declared Delinquent (New Sentence): −Aug. 17, 2012

PRS Time Owed=01 Year 10 Months 12 Days

### V. Additional Embodiments and Variations

In certain embodiments, the selection of the sentence calculator module 250 may be performed in other ways than described above. For example, instead of requiring a user 110 to select the appropriate sentence calculator module 250 and manually enter the input data, the sentence calculation platform 150 may provide a feature that permits the user to select a data file (e.g., database, spreadsheet, text file, or CSV file) including the input data relating to a prison sentence and/or prisoner. The application will then parse the selected data file, analyze the parsed data, select one or more appropriate sentence calculators 250 based on the analyzed data, and provide the parsed data as inputs to the one or more selected sentence calculators 250. The output from the calculations can be provided to a user 110 in various ways. For example, the output may be provided to the user in a new file (e.g., in a new format or in a format similar to the format originally provided by the user) or appended to the original file. The output can also be provided to the user via a user interface (e.g., provided by one or more HTML files) or in the output portion 220 of a selected sentence calculator module 250.

In certain embodiments, the sentence calculation platform 150 may include automated methods for selecting one or more appropriate sentence calculator modules 250 using a database application that stores, or has access to, data associated with prisoners and/or prison sentences. Initially, the user 110 may identify a prisoner or prison sentence (e.g., using a DIN number, prisoner name, court case docket number or other identifier) which is to be the subject of the calculation. The database application may provide an input element (e.g., a “Calculate Sentence” button or drop-down menu selection) that may be selected to transfer the data associated with a prison sentence and/or prisoner to the sentence calculation platform 150. Upon activation of the input element, the program can transfer input data directly to the sentence calculation platform 150. The sentence calculation platform 150 itself may be contained within the calling program, in an object code library, in a separate application (whether local or remote), or on a network server interface (e.g., Internet, VPN or LAN). The sentence calculation platform 150 will then parse the data, select an appropriate sentence calculator module 250, execute the selected sentence calculator module 250 and display sentence output data to the user 110.

As another variation, a user 110 may enter certain identification data to enable the sentence calculator platform 150 to connect to an outside data system (e.g., database or server) to retrieve information (e.g., sentence history or rap sheet data) for an identified person or prison sentence. The retrieved data may then be utilized to populate the appropriate fields of the applicable sentence calculator module 250 or otherwise used as input thereto.

In even further embodiments, the invention may include automated methods for selecting one or more sentence calculators by allowing the user to print a file including the input data (which is typically input by the user via the input portion 210 of the sentence calculator module 250) using a virtual printer (e.g., similar to an Adobe PDF printer). The sentence calculation platform 150 (now installed as a virtual printer) will then parse the data to be printed, select an appropriate sentence calculator for processing the information contained in the printed file, execute the selected sentence calculator and display the sentence output data to the user 110. The virtual printer may operate locally on a client device 110 or may communicate data to a calculation server 140 and receive responses from the server 140.

For example, in certain embodiments, data parsing operations may be performed locally by the virtual printer on the client device 110 and the parsed data may be transmitted to the server 140 in order to perform the calculator selection and sentence calculation operations. Alternatively, the client device 110 may transmit raw data to the server 140 which may parse the data, select a calculator 155 and generate the sentence output data. The virtual printer can provide sentence output data to the user 110 in a new file or by appending the sentence output data to the original file. Output can also be provided to the user via interfaces (e.g., provided by one or more HTML files) displayed on the client device 110. This method would be particularly useful for institutions having a large investment in existing software that would otherwise be difficult to integrate with other systems (e.g., where the institution cannot easily adapt/change the source code for a program that manages the sentencing data or the organization has a large volume of sentencing data so that entry of sentencing data by hand, as in other embodiments, would be less efficient).

In addition to the outputs described above, the sentence calculation platform 150 may further provide the user 110 with additional outputs, including the name of the sentence calculator or module 250 that was selected, a description of the sentence calculator or module 250 that was selected, and a value that indicates the certainty of the calculation (e.g., a confidence value for the selected sentence calculator). Additionally, in certain embodiments, the automated methods performed by the sentence calculation platform 150 may select a plurality of sentence calculators and provide the user with sentence output data for each selected calculator along with the name, description, and a confidence value for each of the calculations performed.

In certain embodiments, the sentence calculation platform 150 may be configured to account for changes in statutes or law that may affect the accuracy of the calculations performed by the sentence calculation platform 150. For example, the sentence calculation platform 150 may include a database or listing that associates each of the sentence calculators 50 with one or more statutes that are relied upon by the sentence calculators to accurately generate the sentence output data. The sentence calculation platform 150 may query an external database or server to determine if the statutes being relied upon have been amended, repealed or overridden. If a statute or law associated with a sentence calculator has been amended, repealed or overridden, an update process can perform one or more remedial operations to ensure that inaccurate sentence output data is not provided to users 110 or to notify users that there is a risk that the sentence output data is not accurate. For example, the sentence calculation platform 150 may take any affected sentence calculators offline (or render them inactive) until the sentence calculators can be updated to account for the statutory changes or until it has been verified that the changes to the law do not affect the calculations performed by the affected sentence calculators. In certain embodiments, the affected sentence calculators may still be made available to users 110, but a notification may be provided to notify the users 110 that the sentence output data may not be accurate. The notification may be augmented to the sentence output data, transmitted in a message to the user (e.g., via an e-mail), displayed on an interface of the client device 110 (e.g., via a pop-up, overlay element or message in a web browser), displayed in the output portion 220 of the affected sentence calculators 250, or provided to users 110 by other means. In certain embodiments, users 110 may also be apprised of the changes to the statutory provision(s) and the status (e.g., offline, inactive or superseded) of each sentence calculator.

In certain embodiments, the sentence calculator modules 250 may permit a user 110 to specify one or more crimes that were allegedly committed by a prisoner (and possibly a date to account for changes in law) in the input portion 210 of a sentence calculator module 250 without requiring the user to input the dates associated with a prisoner's sentence. By specifying the applicable crimes, the sentence calculation platform 150 may then utilize this information to compute the sentence output data.

Other embodiments and variations of the present invention are also contemplated.

### VI. Exemplary Method of Operation

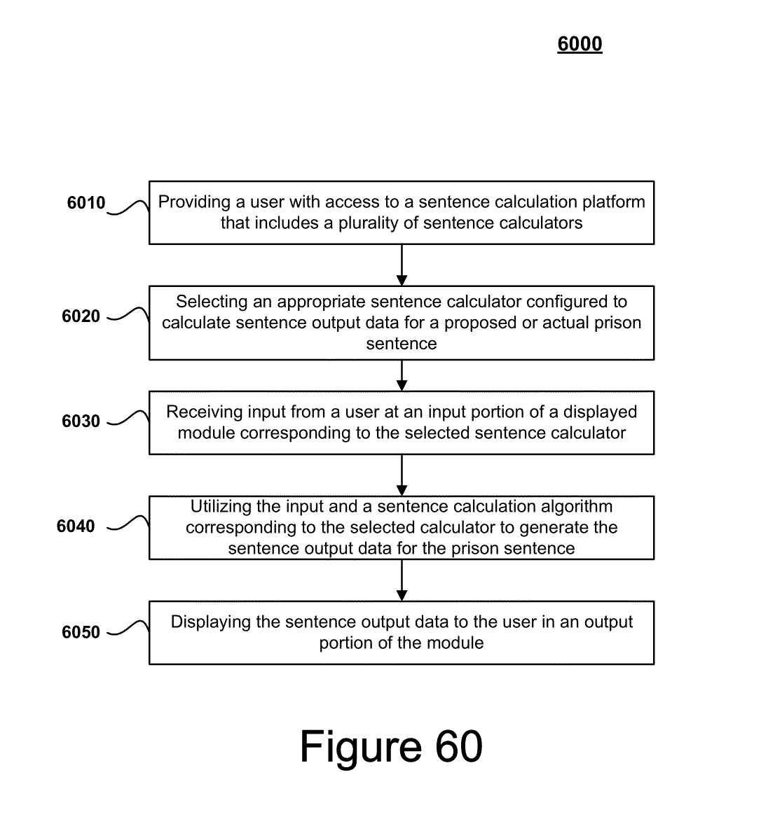

FIG. 60 is a flow chart of an exemplary method 6000 for calculating sentence output data in accordance with certain embodiments of the present invention. The method 6000 begins by providing a user with access to a sentence calculation platform 150 (step 6010). As explained above, in certain embodiments, the sentence calculation platform 150 may include a plurality of different sentence calculators that can account for various sentencing factors that may affect the computation of the sentence output data associated with a particular prison sentence (e.g., factors related to parole, concurrent sentences, consecutive sentences, escapees, or other factors). Each sentence calculator may comprise a set of instructions that pertains to a unique sentencing scenario and which calculates specific sentence output data based on a set of rules that are adapted from a jurisdiction's legal framework corresponding to the sentencing scenario.

In certain embodiments, the sentence calculation platform 150 may be web-based (e.g., provided via a Software as a Service model). In other embodiments, the sentence calculation platform 150 may be provided as a local application that executes on a client device 120 operated by the user 110. In certain embodiments, a user 110 may be granted access to the sentence calculation platform 150 in response to entering valid login credentials (e.g., username and password) via a web page or via the local application.

Once a user 110 has been provided access to the sentence calculation platform 150, the user 110 may select an appropriate sentence calculator for calculating sentence output data associated with a proposed or actual prison sentence (step 6020). The manner in which an appropriate sentence calculator is selected may vary. In certain embodiments, the sentence calculators provided by the sentence calculation platform 150 are classified into logical groupings or subsets and a user 110 may navigate a hierarchy of menus that permit the user 110 to quickly sift through the sentence calculators provided by the sentence calculation platform 150. The menu hierarchy permits the user to quickly identify the appropriate calculator that may be utilized to accurately compute the sentence output data for a prison term, while accounting for any sentencing factors that may complicate the computation of the sentence output data.

In certain embodiments, the sentence calculation platform 150 may provide an interactive wizard feature that assists a user 110 with selecting the appropriate sentence calculator. As explained above, the interactive wizard may be configured to ask the user 110 a series of questions and identify an appropriate calculator based on feedback provided by the user in response to the questions. The selection of an appropriate sentence calculator may be performed in other ways as well.

After an appropriate sentence calculator has been selected, input may be received from the user 110 at an input portion 210 of a displayed module 250 corresponding to the selected sentence calculator (step 6030). As explained above, each sentence calculator may be associated with a corresponding module 250 that includes an input portion configured to receive input from a user and an output portion configured to display the sentence output data. The input data provided to the input portion 210 of the selected sentence calculator module 250 may vary depending upon the sentencing scenario (e.g., the type of sentence and sentencing factors involved). As explained above, the input data received may include any data (e.g., numerical values or text strings) associated with the prison sentence including, but not limited to, a sentencing date, length of sentence, pre-sentence time, data related to parole, the jurisdiction associated with the prison sentence or other data associated with a prison sentence. The input data may also include data associated with a prisoner including, but not limited to, the prisoner's name, DIN number, social security number, court case number, or other data associated with the prisoner. The input data provided by the user 110 may be received by the sentence calculation platform 150 (e.g., after the data is transmitted over a network 130 to a calculation server 140 associated with the sentence calculation platform 150).

The input provided by the user 110 may be utilized in conjunction with a sentence calculation algorithm corresponding to the selected calculator to generate sentence output data for the prison term (step 6040). For example, each sentence calculator on the sentence calculation platform 150 may be associated with instructions that compute the sentence output data for a prison term in a manner which is compliant with the penal law of a jurisdiction associated with the prison sentence. The sentence calculators may utilize the input provided by the user 110 to populate the values of variables utilized by the algorithms to compute the sentence output data. As explained above, the sentence output data which is generated by the sentence calculators may include any information which is related to a prisoner's release date including, but not limited to, actual or estimated values for the release date, the total duration of a prison sentence, the amount of good time awarded to a prisoner, pre-sentence credits, aggregated jail time for consecutive sentences, parole eligibility dates, conditional release dates, the amount of time a prisoner has spent in jail as of a particular date, the remaining time on a prison sentence, data related to re-sentencing eligibility, or other types of data related to a prisoner or prison term.

The sentence output data generated by the sentence calculation platform 150 may be displayed to the user 110 in the output portion 220 of the sentence calculator module 250 (step 6050). The sentence output data that is displayed in the output portion 220 of the sentence calculator module 250 may vary depending upon the sentencing scenario associated with the module 250. In certain embodiments, the sentence output data may be transmitted to a client device 120 over a network 130 and displayed on the client device 120.

While various novel features of the invention as applied to particular embodiments thereof have been shown and described, it will be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

What is claimed is:

1. A system for performing calculations related to a proposed or actual prison sentence, the system comprising:
a processor configured to:
provide a sentence calculation platform adapted to assist a user with generating sentence output data related to a proposed or actual prison sentence, the sentence calculation platform including a plurality of sentence calculators that are configured to compute sentence output data for a variety of different sentencing scenarios, wherein each sentence calculator comprises a set of instructions pertaining to a unique sentencing scenario which, when applied to one or more numerical values, calculates specific sentence output data based on a set of rules that are adapted from a jurisdiction's legal framework corresponding to that sentencing scenario;
provide a hierarchy of navigable menus to assist the user in selecting an appropriate sentence calculator from the plurality of sentence calculators based on a particular sentencing scenario, the hierarchy of navigable menus including selectable interface elements that are each associated with a subset of the sentence calculators;
select a sentence calculator based on the user's interaction with the selectable interface elements;
transmit data for rendering a sentence calculator module on a client device associated with the user based on the selected sentence calculator, the sentence calculator module including an input portion configured to receive user input and an output portion configured to display the sentence output data;
receive user input entered in the input portion of the sentence calculator module, the user input including sentencing information comprising numerical values pertinent to the sentencing scenario associated with the selected sentence calculator;
determine the sentence output data for the proposed or actual prison sentence by applying the selected sentence calculator to the received user input; and
transmit the sentence output data for display on the client device associated with the user.

2. The system of claim 1, wherein the sentence calculation platform is provided via a web-based service which is accessible to the client device over the Internet.

3. The system of claim 1, wherein the sentence calculation platform is provided via a local application that is stored on the client device associated with the user.

4. The system of claim 1, wherein the sentence output data includes actual or predicted values that indicate one or more of the following: a release date, the duration of the prison sentence, or an amount of good time credit.

5. The system of claim 1, wherein the user input is utilized to populate values of variables utilized in procedures executed as part of the set of instructions associated with the selected sentence calculator to determine the sentence output data.

6. The system of claim 1, wherein the plurality of sentence calculators include sentence calculators that are configured compute the sentence output data for definite sentences, determinate sentences and indeterminate sentences.

7. The system of claim 6, wherein the plurality of sentence calculators include sentence calculators that are configured to account for a plurality of sentencing factors that affect the calculation of the sentence output data, including sentencing factors associated with:
parole;
an escapee or absconder;
a concurrent sentence;
a consecutive sentence;
an out-of-state sentence; and
post-release supervision.

8. The system of claim 1, wherein processor is further configured to communicate with a remote server over a network and the remote server comprises a database that includes sentencing information related to the proposed or actual prison sentence.

9. The system of claim 8, wherein the remote server is associated with a correctional facility or judicial facility.

10. The system of claim 8, wherein the processor is further configured to query the database on the remote server for sentencing information related to the proposed or actual prison sentence.

11. The system of claim 10, wherein the user enters identification data to identify the sentencing information related to the proposed or actual prison sentence.

12. The system of claim 11, wherein the processor is further configured to utilize the sentencing information to populate the input portion of the sentence calculator module.

13. The system of claim 1, wherein the processor is further configured to transmit a confidence value for display on the client device relating to sentence output data.

14. The system of claim 1, wherein the processor is further configured to detect changes in statutes or laws that may affect calculations performed by the sentence calculation platform.

15. The system of claim 14, wherein the processor is further configured to implement one or more remedial operations in response to detecting a change in an relevant statute or law.

16. The system of claim 16, wherein the one or more remedial operations comprise at least one of:
prohibiting access to one or more sentence calculator that may be affected by the detected change; and
displaying a notification that provides a warning regarding the detected change.

17. The system of claim 1, wherein the processor is further configured to transmit data that identifies laws, statutes or other guidelines that provided a basis for generating the sentence output data.

18. The system of claim 1, wherein the sentence calculator includes instructions for computing sentence output data for a sentencing scenario pertaining to a consecutive indeterminate term for a post-release supervision violator who was originally assigned a determinate sentence and who was released twice based on parole, conditional release or merit.
